(19) United States
(12) Patent Application Publication
(10) Pub. No.: US 2020/0406806 A1
(43) Pub. Date: Dec. 31, 2020

(54) Cargo Container and Lift Frame Assemblies with Movable Support Legs

(71) Applicant: Demountable Concepts, Inc., Glassboro, NJ (US)

(72) Inventors: Rustin Arthur Cassway, Cherry Hill, NJ (US); Albert Stephen Perry, Mullica Hill, NJ (US); David John Fisher, Berlin, NJ (US)

(73) Assignee: Demountable Concepts, Inc.

(21) Appl. No.: 16/917,790

(22) Filed: Jun. 30, 2020

Related U.S. Application Data
(60) Provisional application No. 62/987,273, filed on Mar. 9, 2020.
(60) Provisional application No. 62/875,927, filed on Jul. 18, 2019.
(60) Provisional application No. 62/869,010, filed on Jun. 30, 2019.

(51) Int. Cl. B60P 1/44; B60P 1/02; B60P 1/60; B60S 9/04

(52) U.S. Cl. CPC B60P 1/4471; B60P 1/02; B60S 9/04; B60P 1/60; B60P 1/445

(57) ABSTRACT

A lift frame assembly for a vehicle having an air suspension system is described herein which includes a lift frame assembly with a top frame body having a locking mechanism, a lift mechanism with an inflatable air bag operable with respect to the frame body and a source of compressed air in fluid communication with the inflatable air bag; and an air suspension system comprising a height adjustment valve for raising and lowering a frame height in communication with the source of compressed air, wherein the height adjustment valve operates in communication with an air suspension height control valve, and the height adjustment valve is operable to raise and lower the height of the frame by inflating or deflating at least a first pair of air springs positioned on a portion of the lift frame opposite the lift mechanism. The lift frame assembly may be used in conjunction with a cargo container assembly herein having a cargo base frame incorporating securable longitudinally pivotable support legs or lockable extendable and retractable support legs to provide a vehicle cargo container and lift frame assembly.

### CROSS-REFERENCE TO RELATED APPLICATIONS

This U.S. Non-Provisional patent application claims the benefit under 35 U.S.C. § 119(e) of U.S. Provisional Patent Application No. 62/987,273, filed Mar. 9, 2020, U.S. Provisional Patent Application No. 62/875,927, filed Jul. 18, 2019, and U.S. Provisional Patent Application No. 62/869,010, filed Jun. 30, 2020, each of which is entitled, “Lift Frame Assembly for Vehicle with Air Suspension, Cargo Container Assembly, Lift Frame and Cargo Container Assembly, and Methods of Using Same,” the entire disclosures of which are incorporated herein by reference.

### BACKGROUND OF THE INVENTION

### Field of the Invention

The invention relates to the field of vehicle frames used for supporting removable loads such as a cargo body on a vehicle, and particularly related to an improvement to frame lift devices for assisting in the lifting function to protect cargo and a cargo body in use, and further to providing a modified design for stowable lift legs for the same.

### Description of Related Art

Vehicles are known in the art which include, e.g., tractor trailer trucks used for hauling cargo. Such vehicles may have detachable semitrailers that include cargo loaded bodies such as containers or boxes, wherein the semitrailers have a wheelbase. In addition, or alternatively, such vehicles may include trailer frames to support a cargo body, such as a container, box or other load. In a tractor trailer, the semitrailer is typically attached via a fifth wheel coupling. For detachable cargo bodies, unloading and reloading can be time-consuming. This can be particularly an issue also when the tractor trailer is dropping off a container and will do the next delivery using a different cargo body that has to be loaded on the trailer chassis frame. Lift mechanisms have been developed in the art to make such cargo loading and unloading easier.

U.S. Pat. No. 3,752,502, for example, teaches addition of two pallets with lifting devices placed near two fifth wheel coupling assemblies on a pole trailer. Legs are extended beneath the pole trailer for unloading, and the lifting device near each fifth wheel coupling is raised to engage the pallet. The lifting devices are each an inflatable air bag attached to two metal plates mounted to the bottom of the fifth wheel coupling assembly and to the trailer frame in a box-like structure formed using hinge plates. The bags are inflated and deflated independently to assist in lifting. Braking cylinders are used to lock the plates which are generally flat.

U.S. Pat. No. 9,663,013 discloses a specialty frame having a frame body using an inflatable air bag as a lifting mechanism mounted on a mounting plate and including a set of guides.

Chinese Utility Model 202518146 U discloses an airlift inflation balloon and a rotary bearing wherein the entire trailer is lifted from a parked vehicle using only a central lift. A rotary, revolving bearing and a carrier plate operate on the air lift.

A dump truck lift for dumping a load by tilting is shown in Chinese Utility Model 87 2 14886 U, wherein a pneumatic transmission uses waste gas from the vehicle engine to power a lift device. The carriage bottom of the dumping portion of the truck is thrust upward by an air bag over its full length to improve stress on the bottom beam of the vehicle carriage and reduce deadweight of the vehicle.

Great British Patent Publication No. GB 2 355 247 A teaches a tipping trailer that tilts relative to the chassis by an inflating air bag, as with the above-noted Chinese Utility Model, it is powered by vehicle waste gas. The box of the trailer is tilted and the flap for dumping contents dumps off the back of the truck.

Applicant provides chassis lifts which incorporate hydraulic lifts and locking hooks into a chassis frame. Such a device can be used with vans, curtain-sided, refrigerated, flatbed and container trucks. In use, a driver with a full load, sets his or her parking brake, and turns on a safety cut switch, and exits the cab of the truck. The electrical connections are unplugged, and a locking lever is then used to unlock the body (i.e., to release the locking hooks). The chassis lift is then activated and raises the cargo body higher than the base of the chassis. Stowable legs are incorporated in the base of the cargo container which can be slid into and out of a recess in the base of the cargo container that extends transversely inward from the exterior of the cargo container base to provide a storage area. The driver pulls the legs directly transversely outwardly from the cargo container base, and when fully extended, such legs are hinged to be directed downward toward the ground to provide a support stand. The legs are adjusted to compensate for terrain and locked into place. The chassis lift is then lowered, and the truck cab pulls away leaving the cargo body standing independently on four such stowable legs. The same procedure can be reversed to re-load the same or a different cargo container or box on the chassis for a second load. Such a device is made and sold by Demountable Concepts Inc., of Glassboro, N.J.

While such support legs are known in the United States, other support legs are known and used, including pivotable legs that are employed in Europe to meet standards such as DIN EN 284 (2007) which describes approved support legs for such interchangeable cargo containers that may freely stand upon removal of the tractor trailer (i.e., swap bodies). Such legs are available on swap body cargo containers from Jost® World of Jost, Germany. Such legs have a transverse support extension and bearing which mount to the cargo base, but pivot upwardly and downwardly in a longitudinal direction along the outside of a cargo container below its base, and lock both through a spring bolt lock beneath the cargo container (with an operable handle) and an exterior lock visible from outside the cargo container.

Airbag chassis lift systems of the prior art while possibly useful when tilting is desired, are difficult to control in a stable manner when lifting a cargo container or box off of a chassis. Stability and air control as well as pressurization control in heavier loads have presented issues. While other chassis lifts are known, weight distribution can also create unnecessary wear on lift mechanisms.

Applicant's co-pending U.S. Non-Provisional patent application Ser. No. 16/045,697, is directed to a system for lifting the front and/or rear of a cargo container and presents an improvement over applicant's prior chassis lift systems by incorporating an airbag lift system including an airbag in a front and/or rear of a lift frame, each on lift frame platforms having lift surfaces, in which the lift air bag(s) can be simultaneously or alternatively inflated and deflated to assist in lifting a cargo box off of applicant's locking base frame that includes locking hooks, and including transversely extending stowable legs for use within a cargo container and lift frame assembly which legs slide transversely into and out of a cargo container base.

While such improvements existing there remains a need in the art for adapting the lift frame assembly and/or a preferred associated cargo container assembly to accommodate varied support legs, and to include variations and improvements to chassis or frame lift mechanisms that work in existing tractor trailer systems while still providing stable weight distribution and lifting while demounting a cargo container or box from a semitrailer or similar vehicle that does not put undue stress on the chassis, is stable and easy to use, economizes the area needed for unloading and economically allows for quick demounting and reloading of a semitrailer in delivery and transport.

### BRIEF SUMMARY OF THE INVENTION

The invention includes a unique lift frame assembly, a unique cargo container base frame including a pivot leg recess, and a vehicle lift frame and cargo container assembly, as well as methods for loading and unloading a cargo container using such features.

In one embodiment, the invention includes a lift frame assembly for a vehicle having an air suspension, comprising: a frame body on a top portion of a frame, the frame body extending from a first end to a second end; a lift mechanism moveable with respect to the first end of the frame body, the lift mechanism comprising: a lift body having a first end and a second end, a lifting surface on the first end of the lift body and the second end of the lift body being positioned so as to be movable with respect to the first end of the frame body, wherein the lifting surface is positioned to engage an underside of a cargo container when placed on an upper side of the frame body; an inflatable air bag having an upper side and a lower side and mounted on the lower side to a platform positioned on the frame beneath the lift body, wherein the inflatable air bag is connected on the upper side thereof to a mounting surface attached to the lift body; a source of compressed air in fluid communication with the inflatable air bag; and an air suspension system comprising a height adjustment valve for raising and lowering a frame height in communication with the source of compressed air, wherein the height adjustment valve operates in communication with an air suspension height control valve, and wherein the height adjustment valve is operable to raise and lower the height of the frame by inflating or deflating at least a first pair of air springs, wherein each air spring in the first pair of air springs is spaced apart transversely and the first pair of air springs is positioned on a portion of the lift frame opposite the lift mechanism.

In embodiments of the lift frame assembly, the lift body may comprise at least two extending lift arms, each pivotably mounted on the second end of the lift body to the first end of the frame body. The lift frame may have a lifting surface attached to the first end of the lift body and can be connected to at least two of the extending lift arms. The lifting surface may be preferably located on mounting flanges rotatably positioned on a bar extending between two of the at least two extending lift arms, which two extending lift arms may be located on outermost sides of the lift body.

The lift frame may comprise a longitudinally extending base frame positioned beneath and supporting a lower side of the frame body. The frame body also preferably includes a locking mechanism. In one embodiment, such a locking mechanism may include a plurality of locking hooks rotatably operable on at least one transversely extending beam interconnected by a longitudinally extending beam, wherein the hooks are actuated by a locking lever positioned on the frame body.

The frame may also comprise a longitudinally extending base frame positioned beneath and supporting a lower side of the frame body, wherein a vehicle-side end of the base frame comprises a loading stop for a cargo container when loaded on the frame and a rear end of the base frame may also be configured for seating a cargo container when loaded on the frame.

In one embodiment, the lift mechanism is positioned on a front portion of the frame and the at least one first pair of air springs is located so as to be operable for raising and lowering a height of the frame at least on a rear portion of the frame.

The source of compressed air may comprise a compressor, an electronic control panel for operating the compressor, a pressure gauge, at least one conduit for allowing compressed air to be fed into the lower side of the inflatable air bag, and preferably at least one other conduit for allowing compressed air to be fed into the height adjustment valve for raising or lowering the first pair of air springs or into the height control valve for controlling the air suspension system when in a driving mode. Such conduits may be independent of one another or connecting and valve operated for separate and independent use.

In preferred embodiments there are at least two pair of air springs and the height adjustment valve is capable of adjusting the first pair of air springs independently of a second pair of air springs. The height adjustment valve preferably also has a stop position and a drive position, wherein in the stop position, the height control valve is isolated and the frame height may be adjusted upwardly or downwardly by manually turning a valve lever, and wherein in the drive position, a drive height may be maintained by the height control valve.

In one embodiment, the lift mechanism may be positioned on the rear of the frame and the at least one first pair of air springs may be located so as to be operable for raising and lowering a height of the frame on a front portion of the frame.

The invention also includes a vehicle cargo container and lift frame assembly, comprising: a lift frame assembly comprising a frame body on a top portion of a frame, the frame body extending from a first end to a second end; a lift mechanism moveable with respect to the first end of the frame body, the lift mechanism comprising: a lift body having a first end and a second end, a lifting surface on the first end of the lift body and the second end of the lift body being positioned so as to be movable with respect to the first end of the frame body, wherein the lifting surface is positioned to engage an underside of a base frame of a cargo container when placed on an upper side of the frame body; an inflatable air bag having an upper side and a lower side and mounted on the lower side to a platform positioned on the frame beneath the lift body, wherein the inflatable air bag is connected on the upper side thereof to a mounting surface attached to the lift body; a source of compressed air in fluid communication with the inflatable air bag; and a cargo container assembly having a container body and a container base frame, wherein the container body is positioned on top of the container base frame and the container base frame is configured to be removably seated on the lift frame assembly, and the cargo container base frame comprises: at least one longitudinally extending rail and a series of spaced-apart cross-members, wherein a portion of the cross-members are spaced apart in a manner capable of accommodating and being connected to a plurality of leg mounting plates, wherein a pair of the leg mounting plates are situated on opposite sides of the container base frame in a front portion of the container base frame and a second pair of leg mounting plates are situated on opposite sides of the container base frame in a rear portion of the container base frame, wherein the container base frame is configured to define a plurality of exterior facing and longitudinally extending recessed areas under the container body and above the lift frame assembly; and a plurality of support legs, each pivotally attached to a mounting plate on the container base frame and able to longitudinally pivot from a first standing position in which each of the plurality of support legs extends downwardly between the container base frame to a support surface to a second stored position in which each of the plurality of support legs is positioned into one of the longitudinally extending recessed areas under the container body.

The lift body may comprise at least two extending lift arms, each pivotably mounted on the second end of the lift body to the first end of the frame body. The lifting surface may be attached to the first end of the lift body and may also be connected to at least two of the extending lift arms. The lifting surface in one embodiment is located on mounting flanges rotatably positioned on a bar extending between two of the at least two extending lift arms, which two extending lift arms are located on outermost sides of the lift body. The frame of the lift frame assembly may comprise a longitudinally extending base frame positioned beneath and supporting a lower side of the frame body.

The frame body preferably includes a locking mechanism. Such a locking mechanism may include a plurality of locking hooks rotatably operable on at least one transversely extending beam interconnected by a longitudinally extending beam, wherein the hooks are actuated by a locking lever positioned on the frame body.

The assembly may further comprise a second lift mechanism moveable on an end of the frame body opposite the first lift mechanism. The source of compressed air may comprise a compressor, an electronic control panel for operating the compressor, a pressure gauge and conduit for allowing compressed air to be fed into the lower side of the inflatable air bag.

In one embodiment of the assembly, the assembly may be used with a vehicle having a preferred air suspension system that comprises a height adjustment valve for raising and lowering a height of the longitudinally extending base frame, wherein the height adjustment valve is in communication with the source of compressed air and operates in communication with an air suspension height control valve, and wherein the height adjustment valve is operable to raise and lower the height of the longitudinally extending base frame by inflating or deflating at least a first pair of air springs, wherein each air spring in the first pair of air springs is spaced apart transversely and the first pair of air springs is positioned on a portion of the lift frame opposite the lift mechanism.

In one embodiment having an air suspension system, the lift mechanism may be on a front portion of the frame of the lift frame assembly and the at least one first pair of air springs may be located so as to be operable for raising and lowering a height of the frame on a rear portion of the frame of the lift frame assembly. In such an embodiment, the source of compressed air may further comprise at least one conduit for allowing compressed air to be fed into the lower side of the inflatable air bag, and at least one other conduit for allowing compressed air to be fed into the height adjustment valve for raising or lowering the first pair of air springs or into the height control valve for controlling the air suspension system when in a driving mode. In one embodiment, at least two pair of air springs may be used, and the height adjustment valve may be capable of adjusting the first pair of air springs independently of a second pair of air springs. The height adjustment valve may also preferably have a stop position and a drive position, wherein in the stop position, the height control valve is isolated and the frame height may be adjusted upwardly or downwardly by manually turning a valve lever, and wherein in the drive position, a drive height is maintained by the height control valve.

In another such embodiment, the lift mechanism may be on the rear of the frame and the at least one first pair of air springs may be located so as to be operable for raising and lowering a height of the frame on a front portion of the frame.

Each of the plurality of support legs may be made so as to be horizontally adjustable and comprise an extending arm on one an end thereof that extends within the container base frame and below the mounting plate to facilitate pivotal movement, in which case such extending end may be positioned within a support bearing. Each of such support bearings preferably further comprises a locking spring bolt.

When the support legs are in the stored position, the assembly may further comprise at least one safety latch moveable on a latch support plate secured to a side of the cargo base frame and located so as to be moveable from an open position for removing one of the support legs from the second stored position to a closed position for securing the support leg in the second stored position. Preferably, there is a safety latch for each of the plurality of support legs.

Each of the plurality of support legs may comprise at least one handle on an exterior facing surface to assist in horizontally adjusting the support legs and/or pivotally lifting the support legs. In one embodiment, there are three handles on each of the plurality of support legs, two of which may be on an exterior facing surface to assist in horizontally adjusting the support legs and/or pivotally lifting the support legs and one of which may be located on a side of a moveable strut secured by an outer bearing to an outer bearing bracket so that the handle is positioned near the outer bearing bracket. The two handles on the exterior facing surface of each of the plurality of support legs may have one handle positioned on the mounting end of the support leg and another handle positioned on the support base of the support leg.

Each of the plurality of support legs may have a moveable strut secured by an outer bearing to an outer bearing bracket, wherein each of the outer bearing brackets is mounted on one of the mounting plates. Each of the struts may have a handle on a mounting end thereof to assist in moving the strut.

In a further embodiment, each of the plurality of support legs may have a mounting end, an extending arm extending from the mounting end of the support leg, a support base, and a moveable strut, wherein each of the plurality of support legs may comprise at least three handles positioned respectively on an exterior-facing surface of the support leg proximate to the mounting end of the support leg, on an exterior-facing surface proximate to and above the support base and proximate to a mounting end of the strut. In a preferred embodiment, each of the plurality of support legs may further comprise four handles on an exterior facing surface to assist in horizontally adjusting the support legs and/or pivotally lifting the support legs. Three of the handles on each of the plurality of support legs in such an embodiment may be positioned on an exterior facing surface to assist in horizontally adjusting the support legs and/or pivotally lifting the support legs and one of which is located on a side of a moveable strut secured by an outer bearing to an outer bearing bracket so that the handle is positioned near the outer bearing bracket. The three handles on the exterior facing surface of each of the plurality of support legs may have one handle positioned on the mounting end of the support leg and two handles positioned in a longitudinally aligned manner proximate to one another and so that the lowermost handle in the extended position is on the support base of the support leg above the support base.

Each of the plurality of support legs may have a moveable strut secured by an outer bearing to an outer bearing bracket, wherein each of the outer bearing brackets is mounted on one of the mounting plates, and each of the struts may further have a handle on a mounting end thereof to assist in moving the strut. The outer bearing may comprise a bearing plate and a bearing shaft having a tapered bearing shaft head. The outer bearing may further comprise a locking mechanism to secure placement of the shaft head in the plate. The shaft head may be configured to engage a mating feature on the mounting end of the strut. The strut may have an end plate on the mounting end of the strut that defines an opening configured to receive a mating feature of a shaft head on a bearing shaft of the outer bearing to flexibly secure the strut to the outer bearing. The assembly may further comprise a stop plate configured to provide support to the outer bearing and outer bearing bracket.

The assembly may further comprise a lock warning light for placement in a cab of a truck.

The invention further includes a vehicle cargo container assembly capable of demountable installation on a tractor trailer frame, comprising: a cargo container having a container body and a container base frame, wherein the container body is positioned on top of the container base frame and the container base frame is configured to be removably seated on a frame of a tractor trailer, wherein the cargo container base frame comprises: at least one longitudinally extending rail and a series of spaced-apart cross-members, wherein a portion of the cross-members are spaced apart in a manner capable of accommodating and being connected to a plurality of leg mounting plates, wherein a pair of the leg mounting plates are situated on opposite sides of the container base frame in a front portion of the container base frame and a second pair of leg mounting plates are situated on opposite sides of the container base frame in a rear portion of the container base frame, wherein the container base frame is configured to define a plurality of exterior facing and longitudinally extending recessed areas under the container body and above the lift frame assembly; and a plurality of support legs, each pivotally attached to a mounting plate on the container base frame and able to longitudinally pivot from a first standing position, wherein each of the plurality of support legs extends downwardly between the container base frame to a support surface, to a second stored position, wherein each of the plurality of support legs is positioned into one of the longitudinally extending recessed areas under the container body.

In this embodiment, each of the plurality of support legs may be horizontally adjustable and comprise an extending arm on one end thereof that extends within the container base frame and mounting plate to facilitate pivotal movement and is positioned within a support bearing. Each of the support bearings may further comprise a locking spring bolt. The extending arms may be a telescoping arm. Each of the plurality of support legs may be vertically adjustable at an end opposite the pivoting end and lockable at an adjusted height. In the stored position, the assembly may further comprise at least one safety latch moveable on a latch support plate secured to a side of the cargo base frame and located so as to be moveable from an open position for removing one of the support legs from the second stored position to a closed position for securing the support leg in the second stored position. There may be a safety latch for each of the plurality of support legs. The assembly may further comprise leg support plates, each located and secured to the cargo base frame so as to support a portion of one of the plurality of support legs in the second stored position.

Each of the plurality of support legs may further have a moveable strut secured by an outer bearing to an outer bearing bracket, wherein each of the outer bearing brackets is mounted on one of the mounting plates. Each of the struts may have a handle on a mounting end thereof to assist in moving the strut.

In a further embodiment, each of the plurality of support legs may have a mounting end, an extending arm extending from the mounting end of the support leg, a support base, and a moveable strut, and wherein each of the plurality of support legs comprises at least three handles positioned respectively on an exterior-facing surface of the support leg proximate to the mounting end of the support leg, on an exterior-facing surface proximate to and above the support base and proximate to a mounting end of the strut. Each of the plurality of support legs may preferably comprise four handles on an exterior facing surface to assist in horizontally adjusting the support legs and/or pivotally lifting the support legs. In such an embodiment, three of the handles on each of the plurality of support legs are positioned on an exterior facing surface to assist in horizontally adjusting the support legs and/or pivotally lifting the support legs and one of which is located on a side of a moveable strut secured by an outer bearing to an outer bearing bracket so that the handle is positioned near the outer bearing bracket. The three handles on the exterior facing surface of each of the plurality of support legs may have one handle positioned on the mounting end of the support leg and two handles positioned in a longitudinally aligned manner proximate to one another and so that the lowermost handle in the extended position is on the support base of the support leg above the support base.

In a further embodiment, each of the plurality of support legs may have a moveable strut secured by an outer bearing to an outer bearing bracket, wherein each of the outer bearing brackets is mounted on one of the mounting plates, and each of the struts has a handle on a mounting end thereof to assist in moving the strut. The outer bearing may comprise a bearing plate and a bearing shaft having a tapered bearing shaft head. The outer bearing may further comprise a locking mechanism to secure placement of the shaft head in the plate. The shaft head may be configured to engage a mating feature on the mounting end of the strut. The strut may have an end plate on the mounting end of the strut that defines an opening configured to receive a mating feature of a shaft head on a bearing shaft of the outer bearing to flexibly secure the strut to the outer bearing. A stop plate configured to provide support to the outer bearing and outer bearing bracket may also be provided to the assembly.

The invention also includes a container base frame capable of supporting a container for demountable installation on a tractor trailer frame, comprising at least one longitudinally extending rail and a series of spaced-apart cross-members, wherein a portion of the cross-members are spaced apart in a manner capable of accommodating and being connected to a plurality of leg mounting plates, wherein a pair of the leg mounting plates are situated on opposite sides of the container base frame in a front portion of the container base frame and a second pair of leg mounting plates are situated on opposite sides of the container base frame in a rear portion of the container base frame, wherein the container base frame is configured so that when situated under a container and the container is on a trailer frame, the container base frame defines a plurality of exterior facing and longitudinally extending recessed areas under the container and above the trailer frame; and a plurality of support legs, each pivotally attached to a mounting plate on the container base frame and able to longitudinally pivot from a first standing position, wherein each of the plurality of support legs extends downwardly between the container base frame to a support surface, to a second stored position, wherein each of the plurality of support legs is positioned into one of the longitudinally extending recessed areas.

Also included herein is a method of loading a cargo container on a lift frame of a vehicle to create a vehicle cargo container and lift frame assembly attached to a vehicle, comprising: (a) attaching a lift frame to a rear of a vehicle having an air lift suspension, wherein the lift frame comprises a frame body on a top portion of a frame, the frame body extending from a first end to a second end; a lift mechanism moveable with respect to the first end of the frame body, the lift mechanism comprising: a lift body having a first end and a second end, a lifting surface on the first end of the lift body and the second end of the lift body being positioned so as to be movable with respect to the first end of the frame body, wherein the lifting surface is positioned to engage an underside of the cargo container when placed on an upper side of the frame body; and an inflatable air bag having an upper side and a lower side and mounted on the lower side to a platform positioned on the frame beneath the lift body, wherein the inflatable air bag is connected on the upper side thereof to a mounting surface attached to the lift body; and a source of compressed air in fluid communication with the inflatable air bag; (b) providing an air suspension system comprising a height adjustment valve for raising and lowering a frame height in communication with the source of compressed air, wherein the height adjustment valve operates in communication with an air suspension height control valve, and wherein the height adjustment valve is operable to raise and lower the height of the frame by inflating or deflating at least a first pair of air springs, wherein each air spring in the first pair of air springs is spaced apart transversely and the first pair of air springs is positioned on a portion of the lift frame opposite the lift mechanism; (c) backing the vehicle and the attached lift frame under a cargo container, wherein the cargo container is supported on a plurality of support legs in an extended position, and the cargo container has a first end and a second end; (d) inflating the inflatable air bag using the source of compressed air to lift the first end of the cargo container such that an underside of the cargo container contacts the lifting surface; (e) moving to a stored position at least two of the support legs positioned below the first end of the cargo container; (f) deflating the inflatable air bag using the source of compressed air; (g) operating the height adjustment valve to raise the height of the frame at least on a second end of the cargo container such that the cargo container is supported on the raised frame; (h) moving to a stored position at least two of the support legs positioned below the second end of the cargo container; (i) operating the height adjustment valve to lower the frame; and (j) locking the cargo container to the frame body.

In this method the cargo container may comprise a container base frame having longitudinally extending recesses therein, and moving the support legs to the stored position comprises lifting the support legs and longitudinally pivoting them in the recesses in the container base frame of the cargo container. The support legs may be lifted by grabbing at least one handle on the support legs. The inflatable air bag may be deflated in step (f) and the frame height may be lowered in step (i) simultaneously. The inflatable air bag may be inflated in step (d) and the frame height may be raised in step (g) simultaneously. Steps (e) and (h) may be carried out at the same time when the inflatable air bag is inflated in step (d) and the frame height is raised in step (g), and prior to steps (f) and (i).

Also within the disclosure is a method of unloading a cargo container from a lift frame of a vehicle cargo container and lift frame assembly so as to detach the vehicle cargo container from the lift frame, comprising: (a) unlocking the cargo container from a frame body of the lift frame, the frame body positioned on a top portion of a frame, wherein the frame body extends from a first end to a second end, and the cargo container has a first end and a second end; (b) inflating an inflatable air bag using a source of compressed air in fluid communication with the inflatable air bag to lift the first end of the cargo container off the frame, wherein the lift frame comprises the frame and the frame body; a lift mechanism moveable with respect to the first end of the frame body, the lift mechanism comprising: a lift body having a first end and a second end, a lifting surface on the first end of the lift body and the second end of the lift body being positioned so as to be movable with respect to the first end of the frame body, wherein the lifting surface is positioned to engage an underside of the cargo container positioned on an upper side of the frame body and wherein when the first end of the cargo container is lifted it contacts the lifting surface; and the inflatable air bag having an upper side and a lower side and mounted on the lower side to a platform positioned on the frame beneath the lift body, wherein the inflatable air bag is connected on the upper side thereof to a mounting surface attached to the lift body; (c) moving at least two support legs positioned in a first end portion of the cargo container base frame from a stored position into a support position; (d) deflating the inflatable air bag; (e) providing an air suspension system comprising a height adjustment valve for raising and lowering a frame height using the source of compressed air when the height adjustment valve is in a stop position, wherein the height adjustment valve is operable to raise and lower the height of the frame by inflating or deflating at least a first pair of air springs, wherein each air spring in the first pair of air springs is spaced apart transversely and the first pair of air springs is positioned on a portion of the lift frame opposite the lift mechanism; (f) operating the height adjustment valve to raise the height of the frame at least on a second end of the cargo container such that the cargo container is supported on the raised frame; (g) moving at least two support legs positioned in a second end portion of the cargo container base frame from a stored position into a support position; (h) operating the height adjustment valve to lower the height of the frame; (i) placing the height adjustment valve in a drive position; and (i) driving the vehicle attached to the frame away from the cargo container in the support position.

In this method. the inflatable air bag may be inflated in step (b) and the height adjustment valve may be operated to raise the height of the frame in step (f) simultaneously. The inflatable air bag may be deflated in step (d) and the height adjustment valve may be lowered in step (h) simultaneously. Steps (c) and (g) may be carried out simultaneously when the inflatable air bag is inflated in step (b) and the frame height is raised in step (f), and prior to steps (d) and (h). The support legs in steps (c) and/or (g) may be moved to the support position by longitudinally pivoting the support legs from respective recesses defined between the cargo container and the cargo container base frame toward the support surface. The support legs may be moved by grabbing at least one handle on the support legs.

Also within the invention is a pivoting support leg for a cargo container frame capable of supporting a free-standing cargo container, comprising: a longitudinally extending support leg extending from a mounting end to a support base and having an extending arm extending generally vertically from the mounting end thereof and configured for pivotal mounting to a mounting plate on a cargo container base frame, wherein the longitudinally extending support leg has an exterior facing surface; at least one handle configured for grabbing by a user mounted on the exterior-facing surface of the support leg. The support leg may further comprise a moveable strut for securing to a mounting plate on a cargo container base frame and a handle on a mounting end of the moveable strut. The first handle may be positioned proximate the mounting end of the support leg and a second handle may be positioned above and proximate the support base. The support leg may further comprise a moveable strut for securing to a mounting plate on a cargo container base frame and a handle on a mounting end of the moveable strut and wherein a first handle is positioned proximate the mounting end of the support leg and a second handle is positioned above and proximate the support base. There may be three handles on the exterior facing surface of each of the plurality of support legs, wherein one handle is positioned on the mounting end of the support leg and two handles are positioned in a longitudinally aligned manner proximate to one another, so that the lowermost handle in the extended position may be on the support base of the support leg above the support base.

Each of the plurality of support legs may have a moveable strut secured by an outer bearing to an outer bearing bracket, wherein each of the outer bearing brackets is mounted on one of the mounting plates, and each of the struts has a handle on a mounting end thereof to assist in moving the strut. The outer bearing may comprise a bearing plate and a bearing shaft having a tapered bearing shaft head. The pivoting support leg may further comprise a locking mechanism to secure placement of the shaft head in the plate. The shaft head may be configured to engage a mating feature on the mounting end of the strut. The strut may have an end plate on the mounting end of the strut that defines an opening configured to receive a mating feature of a shaft head on a bearing shaft of the outer bearing to flexibly secure the strut to the outer bearing. The support leg may further comprise a stop plate configured to provide support to the outer bearing and outer bearing bracket.

In yet a further embodiment, the invention herein includes a vehicle cargo container and lift frame assembly, comprising: a lift frame assembly comprising a frame body on a top portion of a frame, the frame body extending from a first end to a second end; a lift mechanism moveable with respect to the first end of the frame body, the lift mechanism comprising: a lift body having a first end and a second end, a lifting surface on the first end of the lift body and the second end of the lift body being positioned so as to be movable with respect to the first end of the frame body, wherein the lifting surface is positioned to engage an underside of a base frame of a cargo container when placed on an upper side of the frame body; an inflatable air bag having an upper side and a lower side and mounted on the lower side to a platform positioned on the frame beneath the lift body, wherein the inflatable air bag is connected on the upper side thereof to a mounting surface attached to the lift body; a source of compressed air in fluid communication with the inflatable air bag; and a cargo container assembly having a container body and a container base frame, wherein the container body is positioned on top of the container base frame and the container base frame is configured to be removably seated on the lift frame assembly, and the cargo container base frame comprises: at least one longitudinally extending rail and a series of spaced-apart cross-members, wherein a portion of the cross-members are spaced apart in a manner capable of accommodating and being connected to a plurality of leg mounting plates, wherein a pair of the leg mounting plates are situated on opposite sides of the container base frame in a front portion of the container base frame and a second pair of leg mounting plates are situated on opposite sides of the container base frame in a rear portion of the container base frame; and a plurality of support legs, each attached to one of the leg mounting plates on the container base frame, each of the support legs having an upper mounting portion and a lower base portion, wherein the base portion is releasably moveable within the upper mounting portion so that the support legs are vertically retractable from a first free-standing position, in which each of the plurality of support legs extends downwardly between the container base frame to a support surface, to a second travel position in which each of the lower base portions of the plurality of support legs is positioned within each of the upper mounting portions so that the support legs are elevated from the support surface.

As with prior embodiments, the lift body may comprise at least two extending lift arms, each pivotably mounted on the second end of the lift body to the first end of the frame body. The lifting surface may be attached to the first end of the lift body and is connected to at least two of the extending lift arms. The lifting surface may be located on mounting flanges rotatably positioned on a bar extending between two of the at least two extending lift arms, which two extending lift arms are located on outermost sides of the lift body. The frame of the lift frame assembly may comprise a longitudinally extending base frame positioned beneath and supporting a lower side of the frame body. The frame body may include a locking mechanism, that may include a plurality of locking hooks rotatably operable on at least one transversely extending beam interconnected by a longitudinally extending beam, wherein the hooks are actuated by a locking lever positioned on the frame body. A second lift mechanism moveable on an end of the frame body opposite the first lift mechanism may be incorporated.

The source of compressed air preferably comprises a compressor, an electronic control panel for operating the compressor, a pressure gauge and conduit for allowing compressed air to be fed into the lower side of the inflatable air bag.

The assembly may comprise an air suspension system comprising a height adjustment valve for raising and lowering a height of the longitudinally extending base frame, wherein the height adjustment valve is in communication with the source of compressed air and operates in communication with an air suspension height control valve, and wherein the height adjustment valve is operable to raise and lower the height of the longitudinally extending base frame by inflating or deflating at least a first pair of air springs, wherein each air spring in the first pair of air springs is spaced apart transversely and the first pair of air springs is positioned on a portion of the lift frame opposite the lift mechanism.

The lift mechanism may be on the front portion of the frame of the lift frame assembly and the at least one first pair of air springs located so as to be operable for raising and lowering a height of the frame on a rear portion of the frame of the lift frame assembly.

The source of compressed air may further comprise at least one conduit for allowing compressed air to be fed into the lower side of the inflatable air bag, and at least one other conduit for allowing compressed air to be fed into the height adjustment valve for raising or lowering the first pair of air springs or into the height control valve for controlling the air suspension system when in a driving mode. There may be at least two pair of air springs and the height adjustment valve may be capable of adjusting the first pair of air springs independently of a second pair of air springs. The height adjustment valve preferably has a stop position and a drive position, wherein in the stop position, the height control valve is isolated and the frame height may be adjusted upwardly or downwardly by manually turning a valve lever, and wherein in the drive position, a drive height is maintained by the height control valve. The lift mechanism may be on the rear of the frame and the at least one first pair of air springs located so as to be operable for raising and lowering a height of the frame on a front portion of the frame.

The vehicle cargo container and lift frame assembly support legs may be horizontally extendible and retractable, and further comprise an extending arm on one end thereof that extends within the container base frame and below the mounting plate to facilitate horizontal extension and retraction and is positioned within a support bearing. The support bearing may further comprise a locking spring bolt. In the travel and free-standing positions, the assembly may further comprise at least one locking mechanism to releasably lock the upper mounting portion of the leg to the lower base portion of the leg.

The support legs may be fixed in position at an upper mounting end thereof, and the support legs further comprise at least one extending support arm for supporting the cargo container base frame.

In a preferred embodiment, there are at least two of the support legs that are fixed in position at an upper mounting end thereof, each having at least one extending support arm for supporting the cargo container base frame, and being positioned in the rear portion of the cargo container base frame and there are at least two other of the support legs that are positioned on a front portion of the cargo container base frame which are horizontally extendible and retractable, wherein the at least two other support legs on the front portion of the cargo container base frame further comprise an extending arm on one end of the upper mounting portion thereof that extends within the container base frame and below the mounting plate to facilitate horizontal extension and retraction and that are positioned within a lockable support bearing.

One or more of the plurality of support legs may comprises at least one handle to assist in horizontally or vertically moving the upper mounting portion or lower base portion of the support legs. The assembly may further comprise a lock warning light for placement in a cab of a truck.

The invention further includes a vehicle cargo container assembly capable of demountable installation on a tractor trailer frame, comprising: a cargo container having a container body and a container base frame, wherein the container body is positioned on top of the container base frame and the container base frame is configured to be removably seated on a frame of a tractor trailer, wherein the cargo container base frame comprises: at least one longitudinally extending rail and a series of spaced-apart cross-members, wherein a portion of the cross-members are spaced apart in a manner capable of accommodating and being connected to a plurality of leg mounting plates, wherein a pair of the leg mounting plates are situated on opposite sides of the container base frame in a front portion of the container base frame and a second pair of leg mounting plates are situated on opposite sides of the container base frame in a rear portion of the container base frame; and a plurality of support legs, each attached to one of the leg mounting plates on the container base frame, each of the support legs having an upper mounting portion and a lower base portion, wherein the base portion is releasably moveable within the upper mounting portion so that the support legs are vertically retractable from a first free-standing position, in which each of the plurality of support legs extends downwardly between the container base frame to a support surface, to a second travel position in which each of the lower base portions of the plurality of support legs is positioned within each of the upper mounting portions so that the support legs are elevated from the support surface.

In this embodiment the support legs may be horizontally extendible and retractable, and further comprise an extending arm on one end thereof that extends within the container base frame and below the mounting plate to facilitate horizontal extension and retraction and is positioned within a support bearing. The support bearings may further comprise a locking spring bolt.

In the travel and free-standing positions, the assembly may further comprise at least one locking mechanism to releasably lock the upper mounting portion of the leg to the lower base portion of the leg. The support legs may be fixed in position at an upper mounting end thereof, and the support legs further comprise at least one extending support arm for supporting the cargo container base frame. In one embodiment, there are at least two of the support legs that are fixed in position at an upper mounting end thereof, each having at least one extending support arm for supporting the cargo container base frame, and being positioned in the rear portion of the cargo container base frame and there are at least two other of the support legs that are positioned on a front portion of the cargo container base frame which are horizontally extendible and retractable, wherein the at least two other support legs on the front portion of the cargo container base frame may further comprise an extending arm on one end of the upper mounting portion thereof that extends within the container base frame and below the mounting plate to facilitate horizontal extension and retraction and that are positioned within a lockable support bearing.

One or more of the plurality of support legs may comprise at least one handle to assist in horizontally or vertically moving the upper mounting portion or lower base portion of the support legs.

The invention further includes a container base frame capable of supporting a container for demountable installation on a tractor trailer frame, comprising at least one longitudinally extending rail and a series of spaced-apart cross-members, wherein a portion of the cross-members are spaced apart in a manner capable of accommodating and being connected to a plurality of leg mounting plates, wherein a pair of the leg mounting plates are situated on opposite sides of the container base frame in a front portion of the container base frame and a second pair of leg mounting plates are situated on opposite sides of the container base frame in a rear portion of the container base frame, wherein the container base frame is configured so that when situated under a container and the container is on a trailer frame; and a plurality of support legs, each attached to one of the leg mounting plates on the container base frame, each of the support legs having an upper mounting portion and a lower base portion, wherein the base portion is releasably moveable within the upper mounting portion so that the support legs are vertically retractable from a first free-standing position, in which each of the plurality of support legs extends downwardly between the container base frame to a support surface, to a second travel position in which each of the lower base portions of the plurality of support legs is positioned within each of the upper mounting portions so that the support legs are elevated from the support surface.

Also within the invention is a support leg for use with a cargo container frame capable of supporting a free-standing cargo container, comprising: a longitudinally extending support leg having an upper mounting portion and a lower base portion, wherein the base portion is releasably movable within the upper mounting portion so that when the support legs are installed on a cargo container frame, they extend downwardly from a mounting end of the upper mounting portion to a support surface in a free-standing position, and are vertically retractable to a second travel position in which the lower base portion of the support leg is positioned within the upper mounting portion so that the support leg is elevated above the support surface.

In a preferred embodiment, the support leg may be also horizontally extendible and retractable, and further comprise an extending arm on one end thereof for use in securing the support leg to a container base frame. The extending arm may be configured to be positioned within a support bearing for mounting the support leg to a cargo container base frame. The support bearing may comprise a locking spring bolt. In the travel and free-standing positions, the support leg may further comprise at least one locking mechanism to releasably lock the upper mounting portion of the support leg to the lower base portion of the support leg. When installed on a cargo container base frame, there may be four such support legs, at least two of the four support legs may be fixed in position at an upper mounting end thereof, each having at least one extending support arm, and be configured for being positioned in a rear portion of a cargo container base frame, and there may be at least two other of the four support legs that are further extendible and retractable horizontally and which may be configured to be positioned on a front portion of a cargo container base frame, wherein the at least two other support legs may further comprise an extending arm on one end of the upper mounting portion thereof that is configured to be extendible to facilitate horizontal extension and retraction when positioned within a lockable support bearing. The support leg may also comprise at least one handle to assist in horizontally or vertically moving the upper mounting portion or lower base portion of the support leg.

The invention also includes a method of loading a cargo container on a lift frame of a vehicle to create a vehicle cargo container and lift frame assembly attached to a vehicle, comprising: (a) attaching a lift frame to a rear of a vehicle having an air lift suspension, wherein the lift frame comprises a frame body on a top portion of a frame, the frame body extending from a first end to a second end; a lift mechanism moveable with respect to the first end of the frame body, the lift mechanism comprising: a lift body having a first end and a second end, a lifting surface on the first end of the lift body and the second end of the lift body being positioned so as to be movable with respect to the first end of the frame body, wherein the lifting surface is positioned to engage an underside of the cargo container when placed on an upper side of the frame body; and an inflatable air bag having an upper side and a lower side and mounted on the lower side to a platform positioned on the frame beneath the lift body, wherein the inflatable air bag is connected on the upper side thereof to a mounting surface attached to the lift body; and a source of compressed air in fluid communication with the inflatable air bag; (b) providing an air suspension system comprising a height adjustment valve for raising and lowering a frame height in communication with the source of compressed air, wherein the height adjustment valve operates in communication with an air suspension height control valve, and wherein the height adjustment valve is operable to raise and lower the height of the frame by inflating or deflating at least a first pair of air springs, wherein each air spring in the first pair of air springs is spaced apart transversely and the first pair of air springs is positioned on a portion of the lift frame opposite the lift mechanism; (c) backing the vehicle and the attached lift frame under a cargo container, wherein the cargo container is supported on a plurality of support legs in an extended free-standing position, and the cargo container has a first end and a second end; (d) inflating the inflatable air bag using the source of compressed air to lift the first end of the cargo container such that an underside of the cargo container contacts the lifting surface; (e) moving to a retracted travel position at least two of the support legs positioned below the first end of the cargo container; (f) deflating the inflatable air bag using the source of compressed air; (g) operating the height adjustment valve to raise the height of the frame at least on a second end of the cargo container such that the cargo container is supported on the raised frame; (h) moving to a retracted travel position at least two of the support legs positioned below the second end of the cargo container; (i) operating the height adjustment valve to lower the frame; and ( ) locking the cargo container to the frame body.

In this method, the support legs may be retracted by vertically moving the lower base portion within the upper mounting portion and locking the retracted support legs in the retracted position using a locking mechanism. The inflatable air bag may be deflated in step (f) and the frame height may be lowered in step (i) simultaneously. The inflatable air bag may be inflated in step (d) and the frame height may be raised in step (g) simultaneously. Steps (e) and (h) may be carried out at the same time when the inflatable air bag is inflated in step (d) and the frame height is raised in step (g), and prior to steps (f) and (i).

The invention also includes a method of unloading a cargo container from a lift frame of a vehicle cargo container and lift frame assembly so as to detach the vehicle cargo container from the lift frame, comprising: (a) unlocking the cargo container from a frame body of the lift frame, the frame body positioned on a top portion of a frame, wherein the frame body extends from a first end to a second end, and the cargo container has a first end and a second end; (b) inflating an inflatable air bag using a source of compressed air in fluid communication with the inflatable air bag to lift the first end of the cargo container off the frame, wherein the lift frame comprises the frame and the frame body; a lift mechanism moveable with respect to the first end of the frame body, the lift mechanism comprising: a lift body having a first end and a second end, a lifting surface on the first end of the lift body and the second end of the lift body being positioned so as to be movable with respect to the first end of the frame body, wherein the lifting surface is positioned to engage an underside of the cargo container positioned on an upper side of the frame body and wherein when the first end of the cargo container is lifted it contacts the lifting surface; and the inflatable air bag having an upper side and a lower side and mounted on the lower side to a platform positioned on the frame beneath the lift body, wherein the inflatable air bag is connected on the upper side thereof to a mounting surface attached to the lift body; (c) moving at least two support legs positioned on a first end portion of the cargo container base frame from a first retracted travel position into an extended free-standing position; (d) deflating the inflatable air bag; (e) providing an air suspension system comprising a height adjustment valve for raising and lowering a frame height using the source of compressed air when the height adjustment valve is in a stop position, wherein the height adjustment valve is operable to raise and lower the height of the frame by inflating or deflating at least a first pair of air springs, wherein each air spring in the first pair of air springs is spaced apart transversely and the first pair of air springs is positioned on a portion of the lift frame opposite the lift mechanism; (f) operating the height adjustment valve to raise the height of the frame at least on a second end of the cargo container such that the cargo container is supported on the raised frame; (g) moving at least two support legs positioned on a second end portion of the cargo container base frame from a first retracted travel position into a second free-standing position; (h) operating the height adjustment valve to lower the height of the frame; (i) placing the height adjustment valve in a drive position; and (i) driving the vehicle attached to the frame away from the cargo container in the support position.

In the method, the inflatable air bag may be inflated in step (b) and the height adjustment valve may be operated to raise the height of the frame in step (f) simultaneously. The inflatable air bag may be deflated in step (d) and the height adjustment valve may be lowered in step (h) simultaneously. Steps (c) and (g) may be carried out simultaneously when the inflatable air bag is inflated in step (b) and the frame height is raised in step (f), and prior to steps (d) and (h). The support legs in steps (c) and/or (g) may be moved to the second free-standing position by unlocking the lower base portion of the support legs from upper mounting portion of the support legs and extending the lower base portion from within the upper mounting portion toward the support surface, then relocking the lower base portion and the upper mounting portion of the support legs. The support legs may be extended by grabbing at least one handle on the support legs.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a front perspective view of a lift frame for a vehicle having an air suspension according to one embodiment of the present invention;

FIG. 2 is an enlarged view of a portion of the lift frame of FIG. 1 showing a lift mechanism including an inflatable air bag;

FIG. 3 is a side elevational view of the lift frame of FIG. 1;

FIG. 4 is an enlarged view of a portion of the lift frame as shown in FIG. 3 showing a side elevational view of a lift mechanism;

FIG. 5 is a perspective view of the lift frame of FIG. 1 with a lift mechanism in a lift position;

FIG. 6 is an enlarged view of a portion of the lift frame as shown in FIG. 5;

FIG. 7 is a bottom perspective view of a bottom portion of a frame body from the lift frame of FIG. 1;

FIG. 8 is an enlarged view of a portion of the frame body as shown in FIG. 7 illustrating the inflatable air bag platform for the lift mechanism air bag;

FIG. 9 is a side elevational view of the lift frame of FIG. 1 attached to a vehicle shown as a truck in one embodiment and having a lift mechanism in the lift position;

FIG. 10 is an enlarged view of the lift controls and handle for operating a locking mechanism on the frame body of FIG. 9;

FIG. 11 is a side elevational view of a vehicle having a lift frame assembly and a vehicle cargo container assembly capable of demountable installation on the frame prior to loading the cargo container assembly on the vehicle frame to form a vehicle cargo container and lift frame assembly according to preferred embodiments of such assemblies as described herein wherein the cargo container is supported by four support legs and is free standing;

FIG. 12 is side elevational view of the lift frame assembly and cargo container assembly shown in FIG. 11 with the lift frame assembly positioned under the cargo container assembly for loading the cargo container on the lift frame assembly, the lift frame is in an unlocked position, the rear suspension of the vehicle frame in a lowered position and the support legs of the cargo container assembly are in a storage position;

FIG. 13 is a side elevational view of the lift frame assembly and cargo container assembly as shown in FIG. 11 still in an unlocked position with the air suspension engaged to raise a height of the frame in the rear of the frame;

FIG. 14 is a side elevational view of the lift frame assembly and cargo container as shown in FIG. 11, still in an unlocked position, with a pair of pivotal support legs on the cargo container assembly in the rear of the assembly have been pivoted longitudinally upward into a stored position and a safety latch applied to secure the support legs in associated recesses in the cargo container base frame and the air suspension engaged to lower the frame height;

FIG. 15 is a side elevational view of the lift frame assembly and cargo container assembly as shown in FIG. 11, still in an unlocked position, with lift mechanism of an embodiment herein at the front of the lift frame assembly inflated to raise a front portion of the cargo container;

FIG. 16 is a side elevational view of the lift frame assembly and cargo container assembly as shown in FIG. 11, still in an unlocked position, with the lift mechanism inflated, and wherein a second pair of pivotal support legs on the cargo container assembly in the front of the assembly have been pivoted longitudinally upward into a stored position and a safety latch applied to secure the support legs in associated recesses in the cargo container base frame;

FIG. 17 is a side elevational view of the lift frame assembly and cargo container assembly as shown in FIG. 11, still in an unlocked position and having the lift mechanism lowered, the air suspension placed in a drive position, and all support legs in a stored position;

FIG. 18 is a side elevational view of a completed vehicle cargo container and lift frame assembly attached to a vehicle for driving the cargo container on the lift frame assembly, wherein the locking mechanism is now engaged;

FIG. 19 is a bottom perspective view of the vehicle cargo container and lift frame assembly of FIG. 18;

FIG. 20 is a bottom elevational view of the assembly of FIG. 19;

FIG. 21 is a top perspective view of a cargo container base frame for a cargo container according to an embodiment herein with support legs in a standing position;

FIG. 22 is a bottom perspective view of the cargo container base frame of FIG. 21;

FIG. 23 is a top elevational view of the cargo container base frame of FIG. 21;

FIG. 24 is a side elevational view of the cargo container base frame of FIG. 21;

FIG. 25 is a bottom perspective view of the cargo container base frame of FIG. 21;

FIG. 26 is a top perspective view of a portion of the cargo container base frame of FIG. 21 with a pair of support legs moved into a standing positioned, but not fully installed;

FIG. 27 is a top perspective view of a portion of the cargo container base frame of FIG. 21 with the pair of support legs fully installed in a standing position with support leg struts attached to outer bearings fastened to an outer bearing bracket;

FIG. 28 is a bottom perspective view of the portion of the cargo container base frame of FIG. 27 showing the attached struts as well as respective support bearings in a latched position receiving a telescoping portion of an extending arm of each of the support legs;

FIG. 29 is a front elevational view of the portion of the cargo contain base frame of FIG. 21 with the support legs in the standing position and fully installed;

FIG. 30A is an enlarged view of a support leg as used in the cargo container base frame of FIG. 21 in an uninstalled standing position;

FIG. 30B is a side elevational view of the support leg of FIG. 30A;

FIG. 31A is an outer bearing for use in securing the strut of the support leg of FIG. 30A to a support mounting bracket;

FIG. 31B is a side elevational view of the outer bearing of FIG. 31A;

FIG. 32A is a front elevational view of a safety latch for securing a support leg as in FIG. 30A in a stored position within a recess of the cargo container base frame;

FIG. 32B is a side elevational view of the latch of FIG. 32A;

FIG. 33A is a side elevational view of a support bearing for securing an extending arm of the support leg of FIG. 30A;

FIG. 33B is an end elevational view of the support bearing of FIG. 33A;

FIG. 34A is a front elevational view of an outer bearing bracket for supporting the outer bearing of FIG. 31A;

FIG. 34B is a side elevational view of the outer bearing bracket of FIG. 34A;

FIG. 35A is a front elevational view of a leg support for helping to support and secure a support leg in the stored position;

FIG. 35B is a side elevational view of the leg support of FIG. 35A;

FIG. 36A is a front elevational view of a leg support plate for mounting the leg support of FIG. 35A;

FIG. 36B is a side elevational view of the leg support plate of FIG. 36A;

FIG. 37 is a mounting plate for mounting the safety latch of FIG. 32A on the cargo container base frame;

FIG. 38 is a front elevational view of a leg mounting plate for positioning on a bottom surface of the cargo container base frame in a rear position for attaching the pivotable support legs, support bearing and outer bearing bracket;

FIG. 39 is a front elevational view of a leg mounting plate for positioning on a bottom surface of the cargo container base frame in a front position for attaching the pivotable support legs, support bearing and outer bearing bracket;

FIG. 40 is a schematic representation of the air supply system for supplying air to the inflatable air bag in a lift mechanism in an embodiment of a vehicle lift frame assembly according to the embodiment of FIG. 1;

FIG. 41 is a representation of the air supply system of FIG. 40;

FIG. 42 is a schematic representation of the air supply system for supplying air to the air suspension height adjustment valve and height control valve in the lift frame assembly according to the embodiment of FIG. 1;

FIG. 42A is an enlarged view of a height control valve for an exemplary air suspension system for use in a preferred embodiment the lift frame assembly herein;

FIG. 42B is an enlarged view of a height adjustment valve for an exemplary air suspension system for use in a preferred embodiment of the lift frame assembly herein;

FIG. 43 is a view of an example of a warning light for use with a vehicle;

FIG. 44 is a front perspective view of an alternative support leg for use in various embodiments herein;

FIG. 44A is a top view of the support leg of FIG. 44 with an extended strut;

FIG. 44B is a front elevational view of the support leg of FIG. 44A;

FIG. 44C is a right-side elevational view of the support leg of FIG. 44A;

FIG. 44D is a rear elevational view of the support leg of FIG. 44 with the strut compressed against the side of the support leg;

FIG. 44E is a left side elevational view of the support leg of FIG. 44D;

FIG. 44F is a front elevation view of the support leg of FIG. 44D;

FIG. 45A is a side elevational view of a handle assembly for use in the support leg of FIG. 44-44F;

FIG. 45B is a rear elevational view of the handle in the handle assembly of FIG. 45A;

FIG. 46A is a front elevational view (if viewed from an installation on a front of a cargo frame herein) of an alternative embodiment of a support leg configured to be positioned on a front portion of a cargo frame herein with its strut extended;

FIG. 46B is a side elevational view of a support leg according to the embodiment shown in FIG. 46A configured for use on a rear portion of a cargo frame herein with its strut in an extended position;

FIG. 47 is a front perspective view of an alternative outer bearing for use with, for example, the embodiment of the support legs shown in FIGS. 46A and 46B;

FIG. 47A is a side elevational view of the outer bearing of FIG. 47;

FIG. 47B is a front elevational view of the outer bearing of FIG. 47;

FIG. 47C is a side elevational view on the side opposite that shown in FIG. 47A of the outer bearing of FIG. 47;

FIG. 48 is an exploded rear perspective view of a rear portion of a cargo container base frame according to the invention for integrating the embodiment of the support legs shown in FIGS. 46A and 46B and also including the alternative outer bearing of FIG. 47-47C;

FIG. 49 is a front elevational view of a support leg of FIG. 46A in a stowed position and mounted below a cargo container base frame on a side thereof and including the modified outer bearing of FIGS. 47-47C;

FIG. 49A is a front elevational view of a support leg of FIG. 46B in a stowed position and mounted below a cargo container;

FIG. 50 is a side elevational view of a further embodiment of a vehicle and cargo container assembly herein including an alternative embodiment of support legs in the front and rear of the assembly in an extended position allowing the support legs to contact the ground for independently supporting the cargo container assembly including its base frame while stationary;

FIG. 50A is a side elevational view of the assembly of FIG. 50 with the support legs retracted to allow the vehicle and cargo container in locked position to travel;

FIG. 50B is a front elevational view of the vehicle and cargo container assembly of FIG. 50;

FIG. 50C is a front elevational view of the vehicle and cargo container assembly of FIG. 50A;

FIG. 50D is a bottom elevational view of the vehicle and cargo container assembly of FIG. 50;

FIG. 51 is a side elevational view of the cargo container base frame portion of the embodiment of the frame of FIG. 50 with front and rear support legs in the extended position;

FIG. 51A is a perspective view of an enlarged portion of the bottom of a front leg of FIG. 51;

FIG. 51B is a perspective view of an enlarged portion of the bottom of the rear leg of FIG. 51;

FIG. 51C is a side elevational view of the cargo container base frame shown in FIG. 51 with the front and rear support legs in a closed and elevated position;

FIG. 51D is an enlarged view of the elevated rear leg of FIG. 51C with a portion of the leg broken away to show the internal spring, spring hook and interaction of the spring bolt and safety pin assembly;

FIG. 52 is an exploded perspective view of the rear portion of the cargo container base frame of FIG. 51 showing the rear support legs;

FIG. 52A is a back elevational view of the rear portion of the cargo container base frame with legs of FIG. 52 in assembled form and with the legs in the extended position;

FIG. 52B is the back elevational view of FIG. 52 in assembled form with the legs in the closed and elevated position and with a longitudinal cross-sectional view taken through the support legs to show the internal springs thereof,

FIG. 53 is an exploded perspective view of an upper portion of a rear support leg of the assembly of FIG. 50;

FIG. 53A is an exploded perspective view of a bottom portion of a rear support leg of the assembly of FIG. 50;

FIG. 53B is a top elevational view of the foot pad and spring hook elements of the bottom portion of the rear support leg of FIG. 53A;

FIG. 53C is a top elevational view of the assembled bottom portion of the rear support leg of FIG. 53A;

FIG. 54 is a front elevational view of an assembled rear leg as it would be positioned on a side of a cargo container base frame in the extended position;

FIG. 54A is a front elevational view of the assembled rear leg of FIG. 54 in the closed and elevated position;

FIG. 55 is an exploded perspective view of a front portion of the cargo container base frame of FIG. 51 showing the front support legs;

FIG. 55A is a front elevational view of the cargo base frame assembly which is positioned at a front end nearest a vehicle in use showing a side elevational view of the front support legs of FIG. 55 and having a longitudinal cross-sectional view of the legs to show internal parts, wherein the support legs are in the longitudinally extended position and also transversely extended from the frame;

FIG. 55B is a front elevational view of the cargo base frame as shown in FIG. 55A in the longitudinally closed and elevated and transversely retracted position;

FIG. 56 is an exploded perspective view of an upper portion of a front support leg as shown in FIG. 50;

FIG. 56A is a front elevational assembled view of the upper portion of the front support leg of FIG. 56;

FIG. 56B is a side elevational assembled view of the upper portion of the front support leg of FIG. 56;

FIG. 56C is a top elevational assembled view of the upper portion of the front support leg of FIG. 56;

FIG. 57 is a front elevational longitudinal cross-sectional view of the top and bottom portions of the front support leg of FIG. 55 in a longitudinally extended position;

FIG. 57A is a front elevational longitudinal cross-sectional view of the top and bottom portions of the front support leg of FIG. 57 in a retracted and closed position;

FIG. 58 is an exploded perspective view of lock bearing for use with the front support leg of FIG. 50;

FIG. 58A is an assembled top elevational view of the lock bearing of FIG. 58;

FIG. 58B is a rear side elevational view of the lock bearing of FIG. 58A;

FIG. 58C is a rear elevational view of the lock bearing of FIG. 58A; and

FIG. 58D is a front side elevational view of the lock bearing of FIG. 58A.

### DETAILED DESCRIPTION OF THE INVENTION

The invention herein provides a lift frame which may be used with various vehicles that include an air suspension, a cargo container assembly as well as a vehicle cargo container and lift frame assembly. The lift frame may receive a cargo load of varying types including those included in standard cargo containers such as standard-sized container boxes, specialty cargo containers or boxes, direct cargo intended to sit on a frame, base or trailer thereof, another vehicle or another trailer being towed behind a first trailer (double trailer), or other types of semitrailer loads, as well as twin trailers (which may be configured to have a twin lift frame or to have one of the trailers include a lift frame as described herein). As used herein, and as will be understood by one skilled in the art reading this disclosure, a “cargo container,” may include any of the above which may benefit from a lift frame as described herein to support and assist loading and unloading cargo from a trailer frame, wherein the cargo container is intended to or could benefit from being detached from a trailer frame. For purposes of illustrating the invention herein, a cargo container is shown as the preferred cargo container assembly of the present invention including its unique base frame.

As used herein, words such as “upper” and “lower,” “inner” and “outer,” “top” and “bottom,” “raise” and “lower,” “upperside” and “underside,” and words of similar import are intended to assist one of skill in the art in reading the disclosure and understanding the invention with reference to the drawings and are not generally intended to be limiting to the scope of the invention.

Further, in the Summary hereof reference is made to “first” and “second” ends and sides of various components such as the frame body, lift mechanism, cargo container and other corresponding parts. It should be understood by one skilled in the art based on this disclosure that such “first” and “second” parts are intended to be consistent with each other in terms of position and to be distinct from one another but to be interpreted, unless otherwise specified, to refer to both a front to rear or rear to front configuration of the lift frame assembly and/or the cargo container assembly in order to cover variations in embodiments within the scope of the invention. That is, the “first end” may be used to indicate the vehicle-side or the rear-side (side away from the vehicle-side) of the frame body, lift mechanism, cargo container or other corresponding parts. When the “first end” is viewed as one of these sides, the “second end” would be the opposite end of the first end. Use of “front” and “rear” is intended to refer to a vehicle-facing side of the lift frame assembly or cargo container assembly and an opposite end thereof, respectively.

Thus, the embodiments described in the Summary may be interpreted such that the lift frame assembly may be operated using any cargo container with the lift frame assembly and/or may be operated using the cargo container assembly in the inventive embodiment herein. Likewise, the cargo container assembly of the invention herein may be used with any lift frame as are known in the art (including that described in Applicant's co-pending U.S. Non-Provisional patent application Ser. No. 16/045,697) and/or other swap body designs. In one preferred embodiment, the lift frame assembly of the invention herein is used together with the cargo container assembly of the invention herein. Such embodiment is described herein for illustrative purposes only, but should not be intended to be limited to the use of the two inventions together.

For convenience and to thoroughly explain the invention hereof, the following description will be set forth with respect to an embodiment having two lifting devices, a lift mechanism including an inflatable air bag and an independent lift device derived from use of the vehicle air suspension used in conjunction with the inflatable air bag lift mechanism. In the preferred embodiment of the lift frame assembly and methods herein, the inflatable air bag is positioned on the front (vehicle end) of the lift frame assembly and the vehicle frame air suspension is used on the opposite end of the lift frame assembly, however, it should be understood that these two lift devices could be reversed and the inflatable air bag lift mechanism positioned on the rear of the lift frame assembly and the vehicle suspension could be used to lift the frame in the front side of the lift frame assembly. The operation of the lift frame will be described for the purposes of convenience with the inflatable air bag in the front position of the lift frame assembly and the steps of using the methods herein may include steps that are done sequentially, however, some of the steps may further be omitted or the performed simultaneously or in an opposite manner to that described without departing from the spirit and scope of the invention herein.

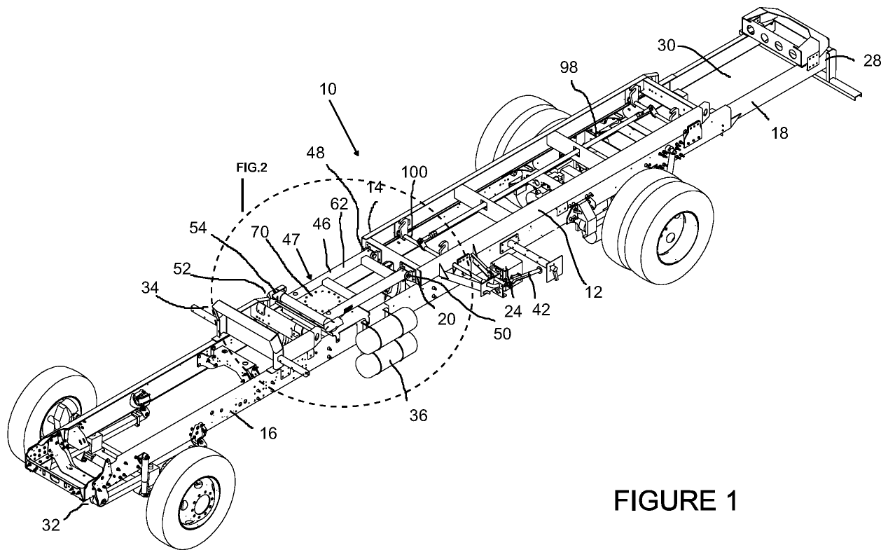

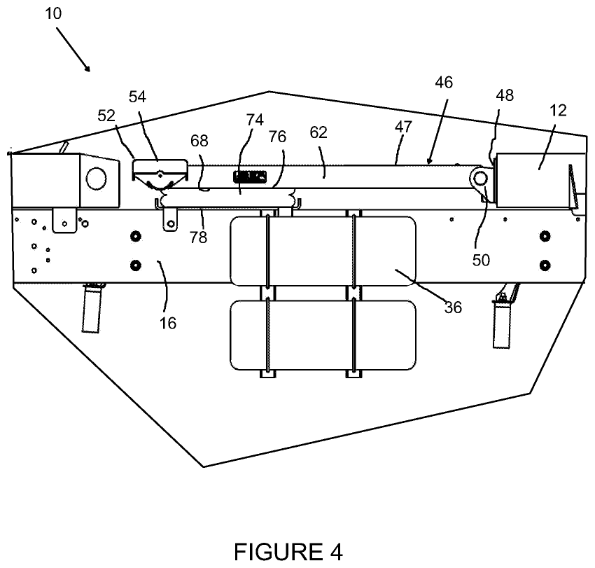

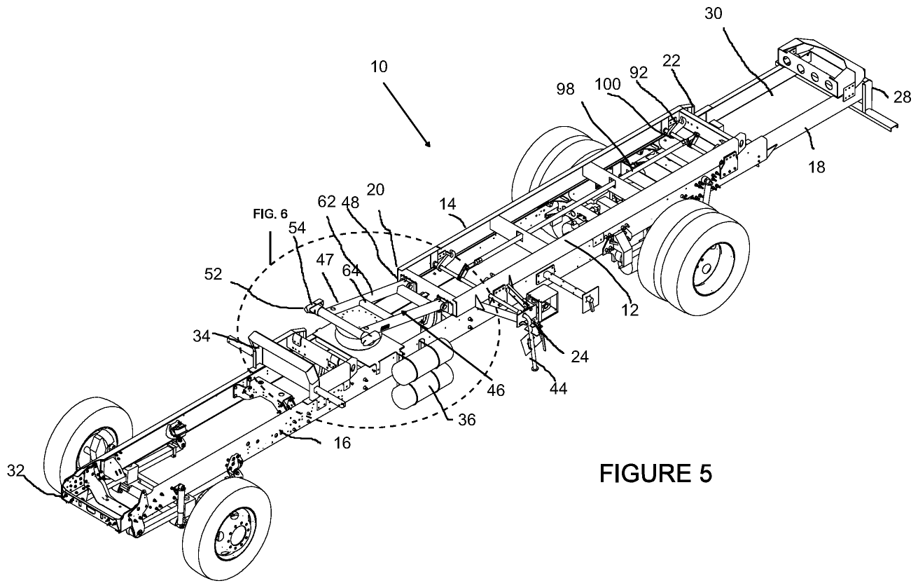

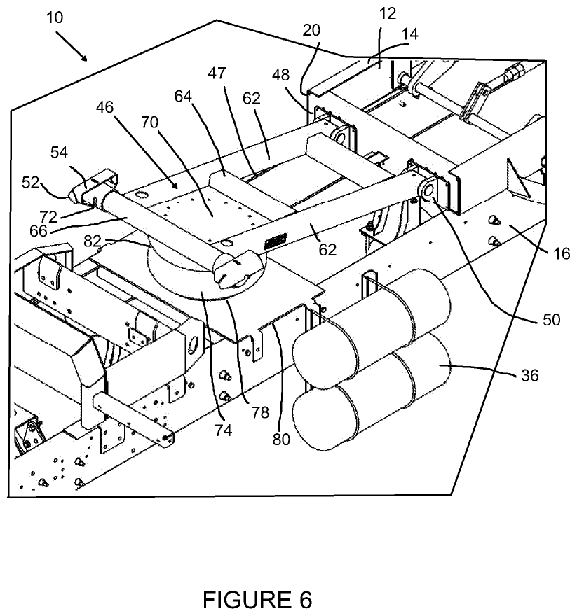

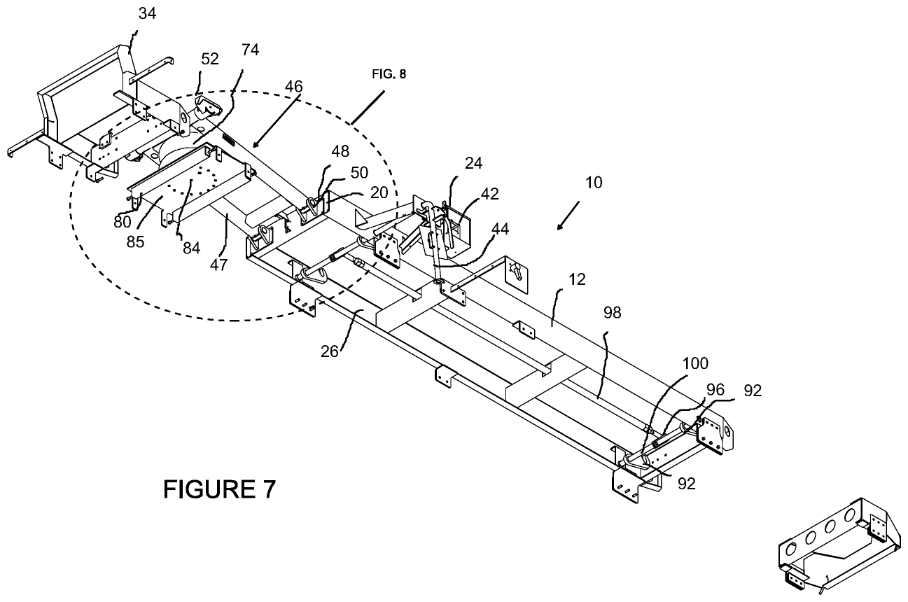

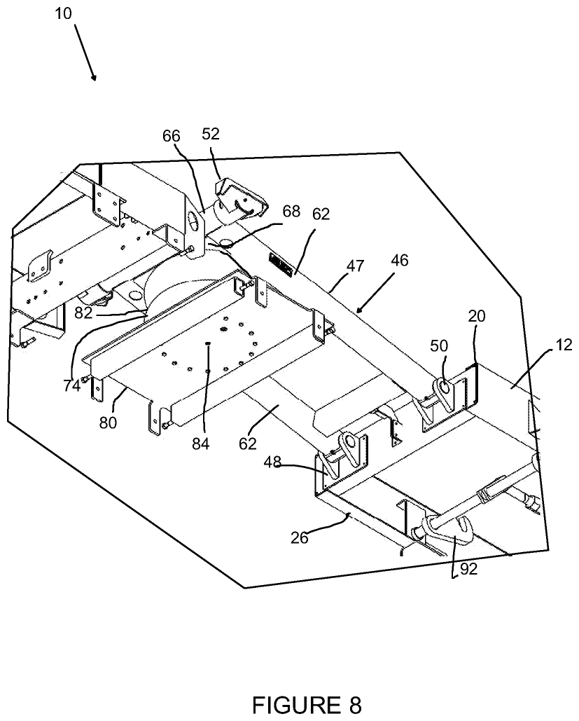

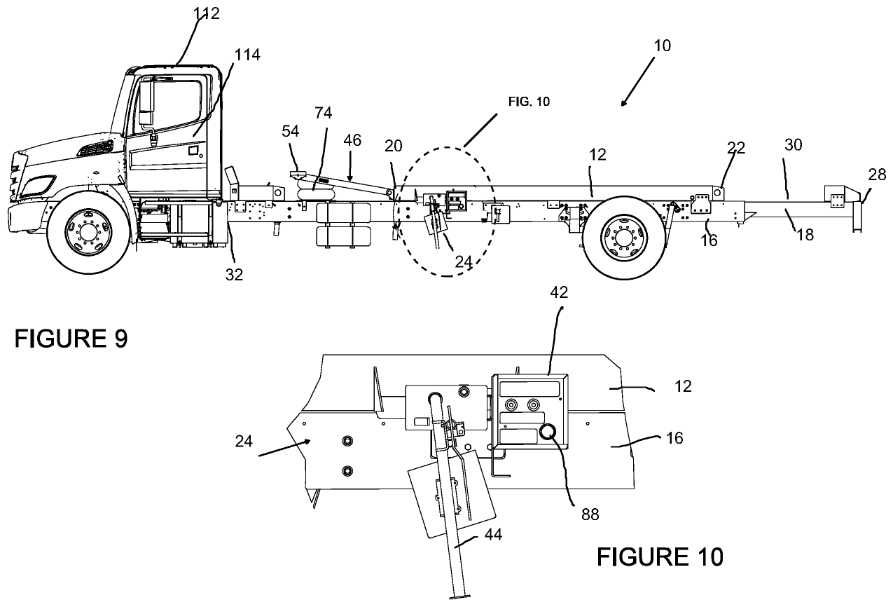

According to one embodiment, herein, a lift frame is described for use in supporting a cargo container. The lift frame will be described initially with reference to FIGS. 1-19. FIG. 1 shows a perspective view of a lift frame, generally referred to herein as lift frame 10. The lift frame 10 includes a frame body 12 situated on a top portion 14 of a frame 16. The frame 16 also includes a base frame 18 below the frame body 12 of the lift frame 10. The frame body 12 extends between a vehicle side end 20 to a rearward end 22 (which could be viewed as a first and a second end, or a second and first ends, respectively). The frame body 12 is shown as having a rectangular configuration having steel beam sides and enclosing a preferred optional locking mechanism 24 described further below.

The base frame 18 provides the trailer base of the lift frame 10 and lies beneath and supports both the lower side 26 of the frame body 12 and the lift mechanism. The base frame 18 extends longitudinally (as preferably does the frame body) and has at a rear end 28 of the base frame 18 a section 30 that is configured to seat a cargo container when loaded on the frame 16. A vehicle-side end 32 of the base frame 18 is configured to have various typical and conventional connecting components as are known in the art to connect a trailer or semitrailer in particular to a vehicle for towing (for example to connect to a fifth wheel coupling). The vehicle-side end 32 may also include a loading stop 34 element for receiving a cargo container when loaded and/or otherwise positioned on the frame 16.

The base frame 18 may also support various control elements 40 in a control box 42, air supply units 36, an optional compressor and any other desired or associated electronic components (electrical truck connections and the like). The compressor may be located in various areas and typically is connectable from a position on the frame or more typically is wired and connected through conduit into an existing vehicle cab compressor used for air conditioning, air brakes and the like. The frame body 12 may include a mount for the controls 40 for the lift mechanism for inflating and deflating such mechanism. It may also include a locking lever 44 (or a similar device) for use with a locking mechanism as described below.

The lift frame 10 includes at least one lift mechanism 46. As described in applicant's co-pending application Ser. No. 16/045,697, two lift mechanisms may be used on opposite sides of the lift body 12. A second lift mechanism may be provided as an alternative lift mechanism or a supplemental lift mechanism to the vehicle suspension. In an embodiment as described herein, the invention is illustrated using a front-end lift mechanism. Each lift mechanism 46 includes preferably identical parts, although if desired, it will be understood by one skilled in the art based on this disclosure that the designs may be varied for individual preferences such as to take account in variations in load or the shape and/or size of the load provided by the cargo container. For the purpose of describing a preferred embodiment shown in the drawings, there is one lift mechanisms 46 positioned near the vehicle-side end 32 of the base frame 16. The lift mechanism is moveably mounted on a first end of the frame body and extends outwardly from the frame body to a free support end. The lift mechanism lifts in an upward direction on its free support end while its base frame end remains moveably mounted to the frame body.

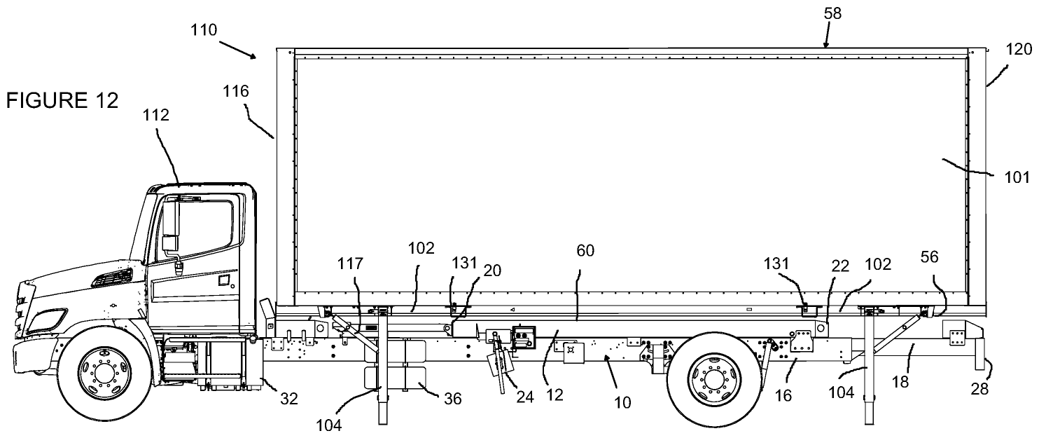

With reference to FIGS. 1-8, the lift mechanism is described with reference to a vehicle-side lift mechanism 46. The lift mechanism 46 has a lift body 47 which extends from a frame body end 48 where it is moveably mounted. As shown herein, the lift body 47 is mounted using a reinforced pin-mounted hinge 50 allowing it to move upwardly from the frame so as to be moveable with respect to a vehicle-side end 20 of the frame body 12. While two pin-mounted hinges 50 are shown, other devices allowing for movement up and down in a preferably pivotable manner may be used, such as sliding hinges, ball and socket hinges, a single, long hinge extending across the frame body end, pneumatic or hydraulic-assisted lift rotatable hinges, and the like. Opposite the frame body end 48 is a support lifting end 52 of the lift body 47. The support lifting end 52 has lifting surface 54. The lifting surface 54 is positioned to engage an underside 56 of a cargo container 58, which may be the cargo container assembly herein, when placed on an upper side 60 of the frame body 12 as shown, for example, in assembly FIGS. 12-18.

The lift body 12 may be configured in various ways provided it is able to carry out the functions described herein. As shown, a lift body 47 is constructed using two extending lift arms 62 extending from the frame body end 48 longitudinally toward a supporting lifting end 52 which for this lift body 47 is positioned near the vehicle-side end of the frame 16, however, multiple support arms could be provided between the two outermost extending lift arms 62 as shown. At the frame body end 48 of the lift body, each of the extending lift arms 62 is preferably pivotably mounted on the vehicle-side end 20 of the frame body 12 using hinges 50. A further support bar 64 is provided extending transversely between the extending lift arms 62. At the support lifting end 52 of the lift body (in this instance positioned on the vehicle-side end of the frame), a further transverse end support bar 66 is mounted at the end of the extending arms 62 forming an area between the traverse bar 64, the extending lift arms 62 and the transverse end support bar 66 which area is used to secure a mounting surface 68 for an inflatable air bag as described below. The mounting surface 68 may be on the bottom of a plate 70 as best shown in FIGS. 1, 2, 6 and 8.

In the embodiment as shown in FIGS. 1-8, the lifting surface 54 is positioned on top of two flanges 72 which are rotatably positioned on the transverse end support bar 66, one on each transverse end thereof. Such flanges 72 can rotate while the lift body 47 moves upwardly while laying planar with respect to an underside 56 of a cargo container 58 when contacting the lifting surface. The lifting surface 54 could alternatively extend as a single rotatable piece along the entire transverse end support bar 66, or a design could be configured wherein the transverse end support bar is molded or otherwise formed to have a transversely extending lifting surface. Preferably, the lifting surface 54 is attached to the support lifting end 52 of the lift body shown near the vehicle-side end of the frame or generally on the side of the lift body opposite that which is moveably positioned with respect to the frame body.

The lift body 47 and associated parts are preferably formed of a metal or metal alloy or reinforced composite having sufficient strength to withstand a maximum cargo container load for which the frame is intended to hold in use. Locking hooks, lift surfaces and other structural support parts are preferably formed of stainless steel which may be galvanized. Materials should be selected based on load requirements and applicable vehicle government and industry requirements. The lifting surface 54, such as flanges 72 may be formed of similar materials but are preferably include a material having wear resistance and some impact capability and a suitable physical properties to resist wear and impact damage from repeated use and loading.

The lift mechanism 46 also includes an inflatable air bag 74 having an upper side 76 and a lower side 78. The inflatable air bag 74 is mounted on its lower side 78 to a platform 80 positioned on the frame 16, preferably on the base frame 18, beneath the lift body 47. The inflatable air bag 74 may be formed from a flexible material of sufficient strength to hold air pressure and support the cargo container load applied to the air bag. Reinforced or high strength elastomers or flexible composites may be used to form the air bag. As shown, the air bag is compressed in at least one area 82 in a bellows-like manner to assist in compression when deflated.

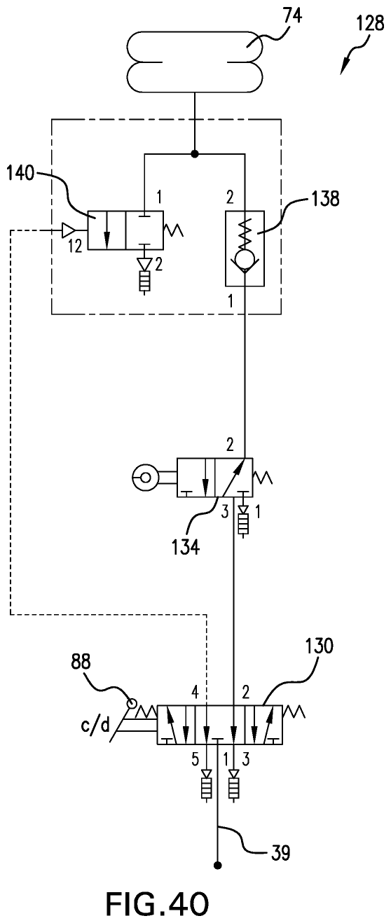

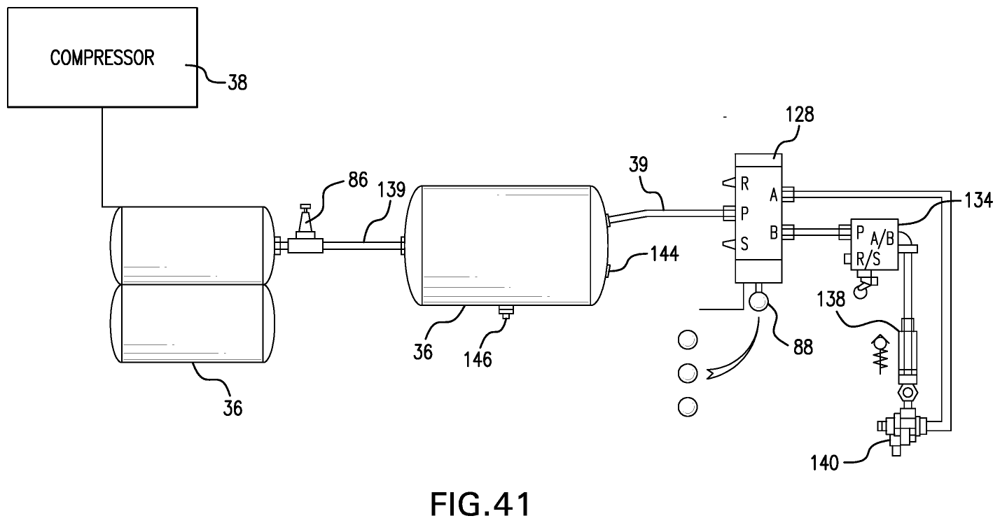

The platform 80 is preferably also formed of materials of similar strength to that used in the lift body 47. The upper side 76 of the air bag 74 as noted above is connected to a mounting surface 68 on a plate 70 attached to the lift body 47. The air bag 74 is inflatable through an air inlet 84 in fluid communication between the air bag 74 and an air compressor 38 having an air source 36. Any suitable compressor may be used or other apparatus for delivery of compressed air under pressure and standard air system configuration employed to provide pressure-controlled air to the air bag 74 through the inlet 84 on a lower side 85 of the platform 80. The air compressor 38 and air source 36 together act as a source of compressed (pressurized) air 39 for use in the lift frame. The compressor 38 preferably delivers pressurized air through conduit arranged as in FIGS. 40-41 and using a pressure gauge 86 to monitor the pressure which is controlled using pressure regulated check valves as shown in FIGS. 10 and 40-41. At least one on/off toggle switch 88 is provided further to control system box 42 for use in engaging the inflation and deflation control system discussed below for inflating and deflating the air bag 74 shown in FIGS. 1-8 on the vehicle-side end of the lift frame. An additional switch can be provided on the exterior of the frame as well for operating the air suspension as described further below. Note that while toggle switches are shown, other control switches, buttons or other activation mechanisms may be used.

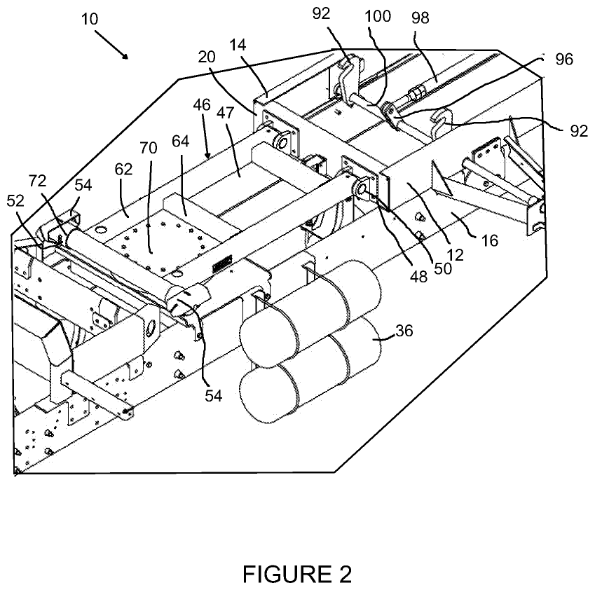

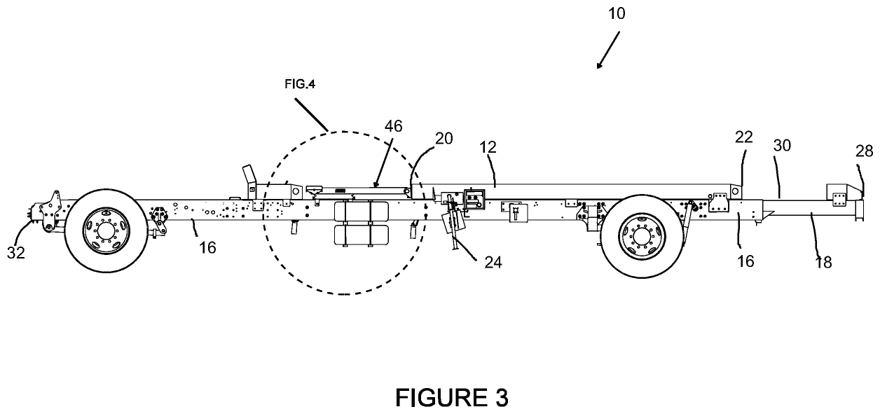

The locking mechanism 24 for the lift frame 10 is preferably located on the frame body 12. As shown, it has a plurality of locking hooks 92 which are rotatably operable so as to move up into a locking position and down into an unlocked position. In the locking position, the locking hooks 92 may engage a base, such as a base frame, 94 of a cargo container assembly 58. On an underside 56 of the cargo container 58, frame structures (not shown) or other suitable structures such as bars may be provided for receiving the locking hooks 92. FIGS. 1-2 show the locking hooks 92 upright and in a locked position while the air bag(s) 74 are deflated. The locking lever 44 is pulled up in a locked position (see FIGS. 1-2 and 18). In this position, the lift frame locking device is engaged, and the air bag is deflated. Typically, this is when a cargo container assembly is positioned on the lift frame and locked to the lift frame. FIGS. 3-10 and 11-17 show the locking hooks 92 in a downward position and the locking lever in the downward position so as not to engage the underside 56 of a cargo container assembly. In such an unlocked position, and the air bag 74 may be inflated and/or the frame height raised using the air suspension height adjustment valve. This is the position the lift frame would be in when the cargo container is unlocked from the lift frame and fully suspended allowing for a driver to either stow or remove support legs while loading or unloading the cargo container as discussed further below.

In the embodiment shown, the locking mechanism 24 also includes pivot hinges 96 on either end of a longitudinally extending central beam 98 extending between and interconnecting two transversely extending beams 100 on which locking hooks 92 are moveably engaged. The locking hooks are thus rotatably operable on the extending beams 98 and can rotate up and down for locking and unlocking respectively. Two hooks 92 are shown on each beam 100, however, one skilled in the art would understand based on this disclosure that multiple hooks may be provided along each beam as well for additional points of locking and/or that other additional transverse beams may be used.

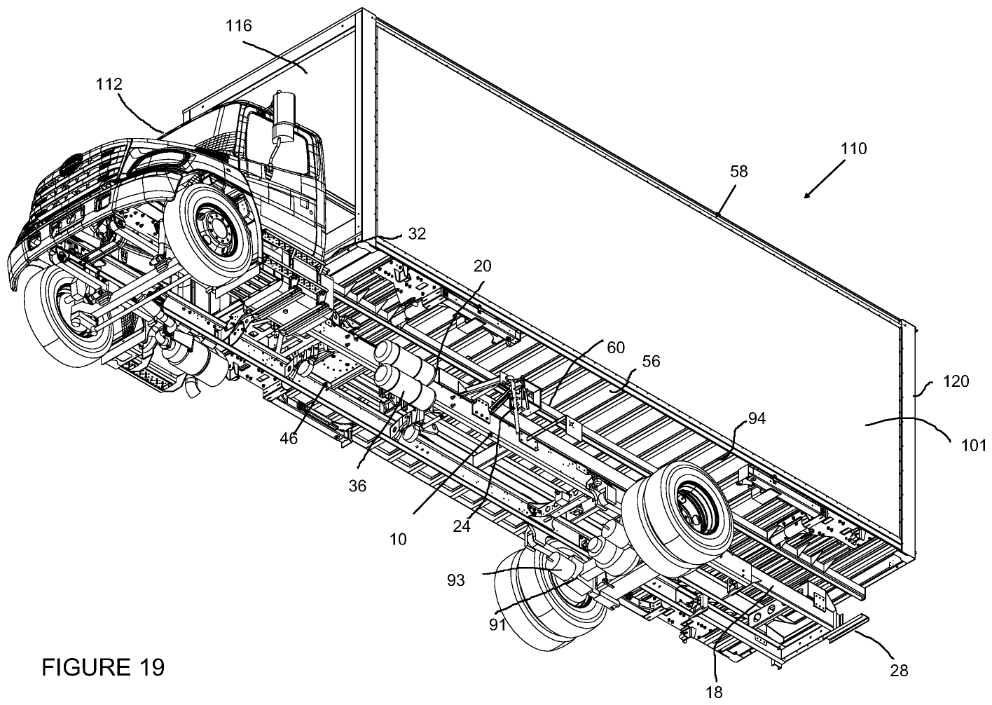

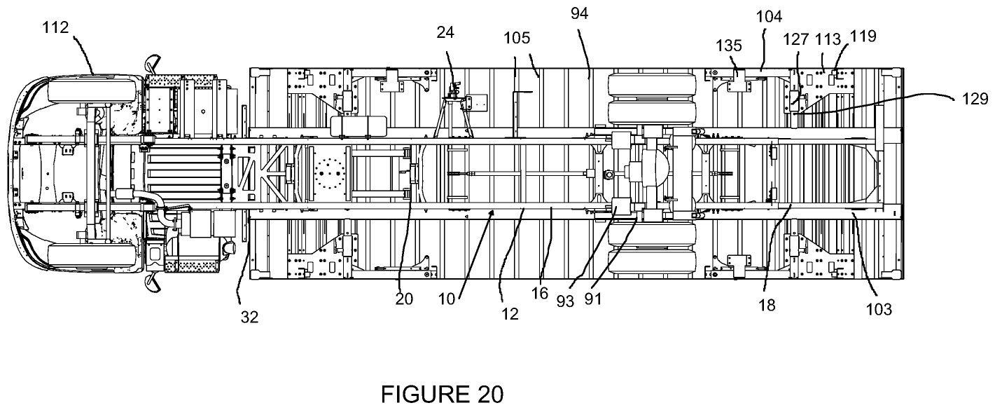

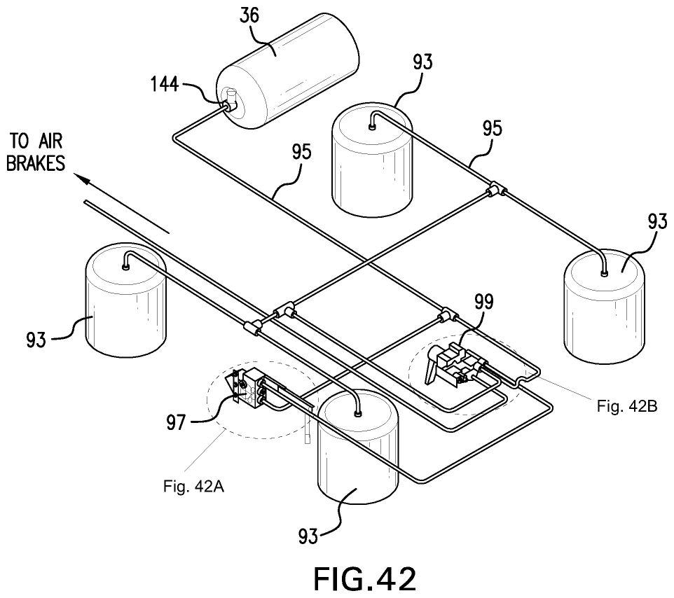

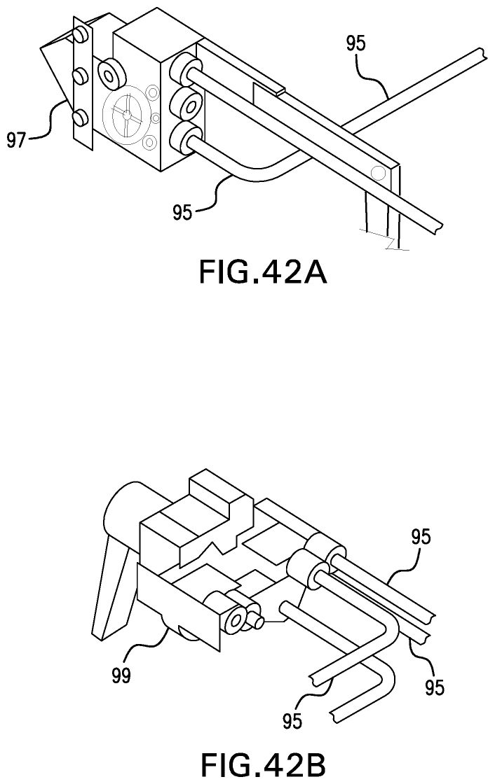

As noted above, the vehicle frame having mounted tires and wheelbase may be equipped with an air suspension. Air suspensions systems are known for use in tractor trailer and similar vehicles and can be added or retrofit into an existing suspension system. In accordance with the invention herein, an air suspension system is shown in FIG. 42 as an example of a preferred air suspension system 90 for use in the assemblies herein. System 90 includes a plurality of inflatable air suspension springs 93 that are generally positioned along with the suspension in an area 91 near a vehicle tire in a manner known in the art. As shown in FIG. 42, four such air springs 93 are provided in pairs in one standard arrangement, with each air spring in a pair of air springs transversely spaced apart from each other with one on each side of the vehicle frame in the area 91 near a vehicle tire as best shown in FIGS. 19-20 and FIG. 42.

Such systems include conduit 95 in communication with an air supply source such as air supply tank(s) 36, which as noted elsewhere herein with respect to the air supply source for the air bag for the lift mechanism, preferably includes a pressure relief valve 142 as described further below. The same or a different air supply tank that is in use for any lift mechanism air bag, can be used for inflating the air springs. Such air suspension systems such as system 90 typically include an air suspension height control valve (HCV) that regulates the vehicle height to keep the ride smooth and balanced while in transit. In operation, the HCV is responsive to vehicle movement and the HCV adjusts in response to the movement of the suspension system when the HCV is operable. The air suspension system 90 herein preferably includes an HCV 97.

In order to raise or lower a vehicle frame for various reasons, some air suspension systems are lowered and raised by inclusion of a height adjustment valve. Such a height adjustment valve can be bypassed when the height adjustment valve handle is in the drive position such as during vehicle driving operations. When the handle of the height adjustment valve is in the stop position, the HCV is then isolated and the height adjustment valve can be manually operated (or by electronic control if available) by moving the handle to actuate a flow of air to inflate the air springs in one direction or to deflate the air springs in the opposite direction. Suitable HCV valves and height adjustment valves are commercially available. One such commercially available valve suitable for such operation is available from Haldex®. A suitable HCV may be secured from Haldex® with or without an air dumping feature. A height adjustment (or raise/lower valve) is available from Haldex® as the Colas® valve. Other suitable valves and air suspension system components for use herein are also available from Hendrickson® International and from WABCO® Vehicle Control Systems.

In the system herein a Haldex® system may be employed as shown in FIGS. 42 and 42A having HCV valve 97 and height adjustment valve 99. The conduit 95 is configured to provide fluid communication for air flow between the air supply 36 and the air springs 93 when the height adjustment valve 99 is in the drive position by passing through and being controlled by the HCV in the driving mode such that the height adjustment valve is effectively a pass through or bypassed. In such a position, the HCV valve maintains the drive height as intended. When the HCV is in the stop position, the conduit 95 is configured to provide fluid communication for air flow between the air supply 36 to the air springs 93 through the height adjustment valve with the HCV isolated enabling the height adjustment valve to adjust the height of the vehicle frame upwardly or downwardly by raising or lowering the air springs 93.

When the lift frame assembly 10 herein is employed in loading and unloading a cargo container assembly 58, in addition to the lift mechanism 46 with inflatable air bag, the height of the vehicle frame can also be raised and lowered by use of the vehicle air suspension system 90 preferably only in the rear of the frame using a pair of rear air springs (or only a pair of front air springs, depending on the location of the lift mechanism 46 or the desired lift effect). While it is also possible to raise the entire frame, in the preferred embodiment herein, only rear air springs need be inflated to raise a height on the rear of the frame. Preferably the air springs 93 that are inflated for raising and lowering the lift frame assembly base frame 18 are positioned on a rear end (or a vehicle side portion of the lift frame assembly) that is opposite the lift mechanism 46. For example, in the preferred embodiment herein, the lift mechanism 46 is positioned towards the vehicle end 32 of the lift assembly base frame 18 for raising and lowering a front or vehicle end 116 of a cargo container assembly 58 for storing or deploying support legs. In the preferred embodiment, the air suspension system 90 is preferably positioned so as to engage, at least, the pair of air springs 93 that are preferably located towards the rear end 28 of the lift assembly base frame 18 for raising and lowering a rear end 120 of a cargo container assembly 58 for storing or deploying support legs.

While not the preferred embodiment, it is within the scope of the invention to position the air suspension system such that there are at least two pairs of air springs 93 and the height adjustment valve is capable of adjusting a first pair of air springs independently of the second pair of air springs or inflating all air springs. In addition, it is possible to position the lift mechanism 46 on an area near the rear of the base frame and at least one of the pair of air springs located so as to be operable for raising and lowering the height of the base frame on a vehicle or front end of the base frame.

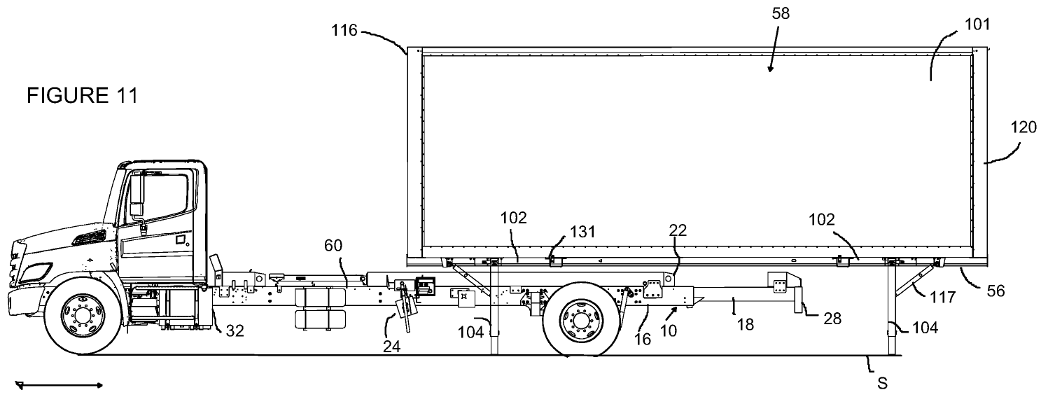

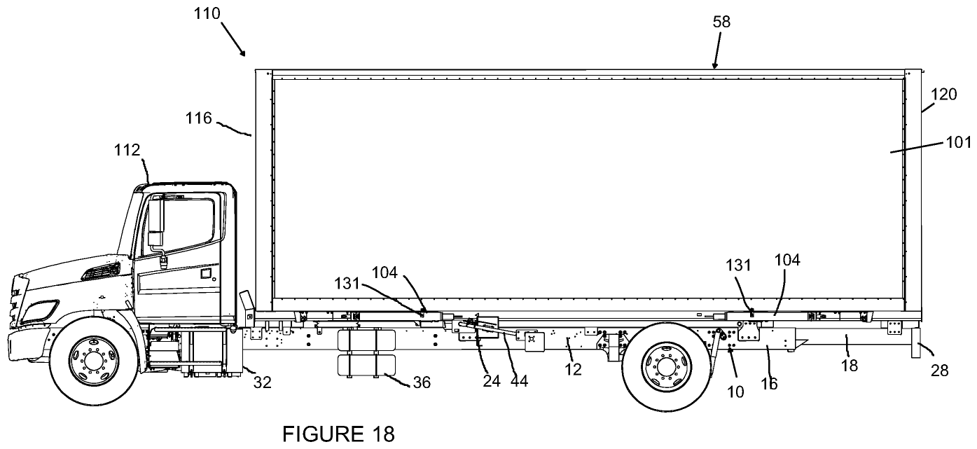

The lift frame assembly 10 herein described above may be combined with a cargo container assembly 58 herein to form a vehicle cargo container and lift frame assembly 110 for use with vehicles such as hauling trucks and other vehicles noted herein. The assembly 110 is shown in a locked form in FIG. 18 and in fully unlocked and detached form in FIG. 11. The lift frame assembly 10 and cargo container assembly 58 shown to illustrate the invention herein may be varied in the manner noted above. The cargo container assembly 58 may be used with a different lift frame assembly and the lift frame assembly 10 herein may also be used with a different cargo container assembly. However, for purposes of illustrating the benefit of both the lift frame assembly 10 and the cargo container assembly 58 herein, the two preferred assemblies are combined to form a cargo container and lift frame assembly 110 as shown.

The cargo container assembly 58 is preferably configured to be removably seated on the frame 16 so as to cover the frame body 12. The cargo container assembly preferably includes a cargo container body 101 and a container base frame 94. The container base frame 94 herein is designed to incorporate preferred features, including frame or bar elements that are preferably positioned to engage and receive the locking hooks described above.

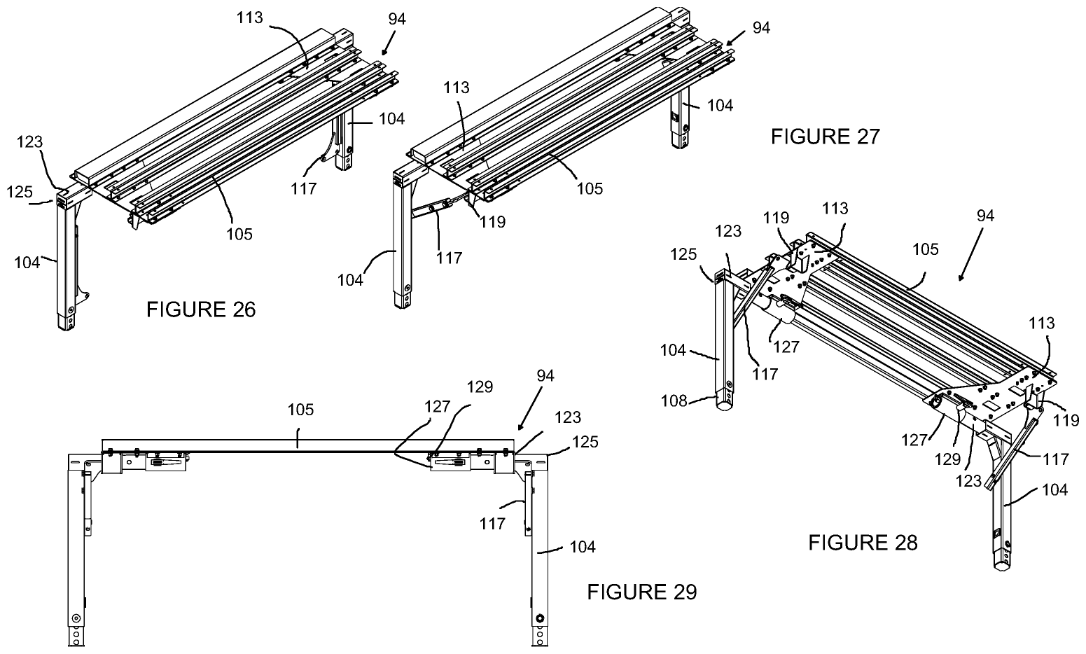

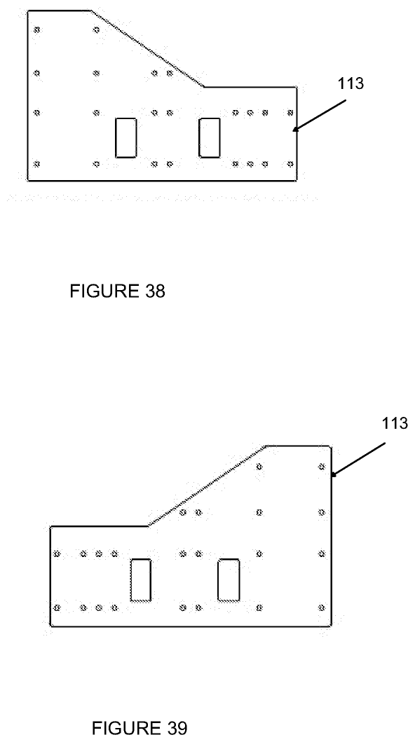

The preferred container base frame 94 is described herein. As shown in FIGS. 19-39, various elements and components of the container base frame are shown. The container body 101 is positioned on top of the container base frame 94 which is configured to be removably seated on the lift frame assembly 10 as described herein.

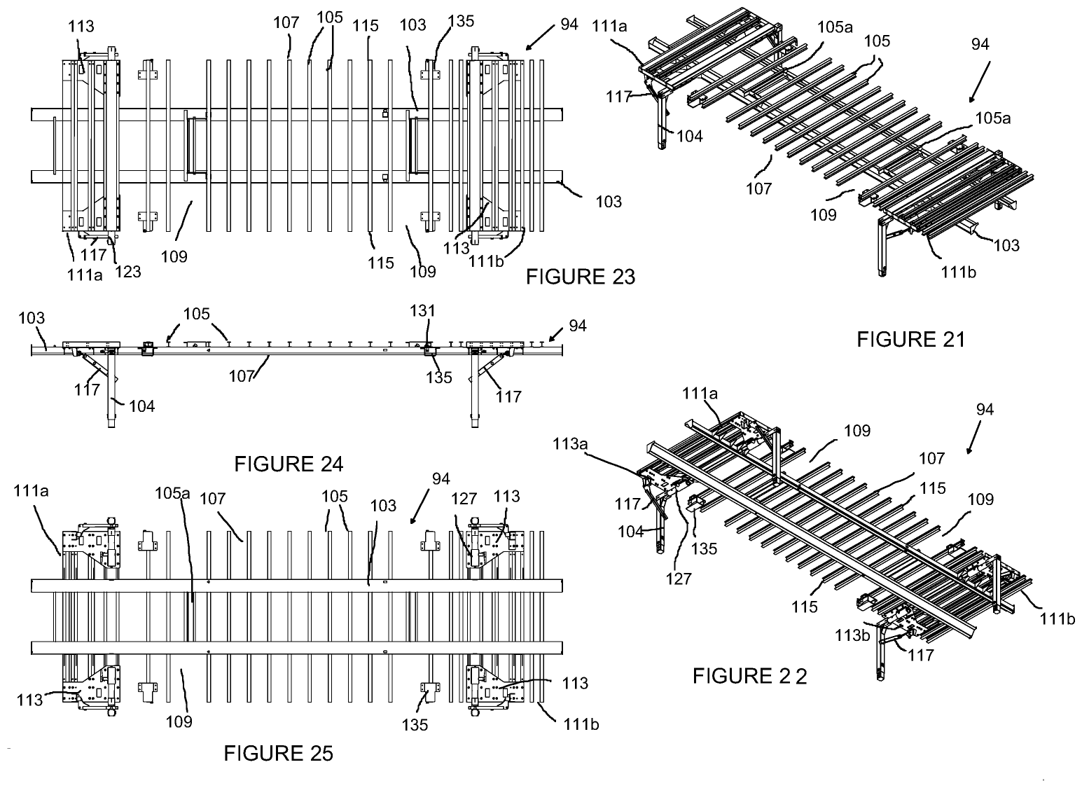

The cargo container base frame 94 includes at least one longitudinally extending rail 103 and a series of cross members 105 that are longitudinally spaced apart and either overlie or are positioned beneath the rail(s). As shown, so as to engage the lift frame assembly 10 as preferred herein, two rails 103 are positioned beneath crossmembers 105. With reference to FIGS. 21-25, certain of the cross members 105 are spaced in one manner in the central area 107 of the frame leaving a larger space 109 between the central area 107 cross members 105 and the cross members 105 on end portions 111a,b of the frame 94. This space 109 allows for some accommodation of hardware and for support components for storing the support legs. In end portions 111a,b of the container base frame 94 the cross members 105 are spaced apart somewhat more closely and can be modified provided that they are arranged in a manner capable of accommodating and being connected to a plurality of leg mounting plates 113 for support legs 104. As shown in the vehicle facing end 111a of the cargo base frame there are several closely spaced members to accommodate support as well as allowing installation of support legs 104. The rear facing end 111b also has more closely spaced cross members, but there are further cross-members provided. In addition, internal shorter length cross members 105a are provided in locations which are useful for engaging feature of a lift frame assembly frame body for securing the container base frame 94 to the lift frame assembly 10. If a different lift frame is used in combination with the cargo container assembly 58, the spacing of the cross members may be modified and the location of modified cross members, if any, altered to engage a different lift frame.

Preferably, for mounting the support legs 104, a pair of the leg mounting plates 113 are situated on opposite sides 115 of the container base frame 94. While a plurality of pairs of support legs may be provided, depending on the support needed or desired, in the embodiment shown, two such pairs of mounting legs are provided. As shown, a pair of leg mounting plates 113 are situated in a portion of the front (vehicle facing) end 111a of the container base frame 94 and a pair of leg mounting plates 113 are situated in a portion of the rear end 111b of the container base frame 94.

In the container base frame herein, the rail(s) 103 and cross members 105 may be connected by various methods, such as welding, riveting, and/or through use of a bracketing system as described in preferred frames described in applicant's co-pending Non-Provisional application Ser. No. 16/436,855. In addition, reinforcing members or spacers may be provided below the frame if desired.

As designed, the base frame 94, when positioned on the bottom of the cargo container body 101 is configured by positioning of the cross members with respect to the mounting plates so as to define recesses 102 for receiving support legs 104. Support legs 104 are shown herein as stowable within the recesses 102 within the cargo container base frame 94. Preferred support legs 104 for use herein include those known as pivoting support legs. One preferred embodiment is shown that is known in the art and is available commercially from Jost® World. Such support legs are known for use in swap body vehicles in Europe, and provide benefits in that they do not pivot transversely outwardly from the cargo container in storage and instead pivot longitudinally. Such action economizes space, but not all base frames for swap bodies are configured to accommodate such legs in an effective storage space on various lift frame assemblies. A further preferred embodiment is described further hereinbelow in which such pivoting support legs are improved by incorporation on handles thereon. For the purpose of illustrating the assembly and methods herein, support legs 104 are shown. However, it should be understood that the assemblies and methods herein may be carried out using the improved support legs 104′ described below in the same manner and in the same assemblies and methods.

In the invention herein, a mounting system is provided with the cargo container base frame 94 and cargo container assembly 58 herein that enables safe storage of such longitudinally pivotable support legs within the frame while operating the vehicle and during the loading and unloading of the cargo container. Thus, while other support legs may be used and a different support cargo container base frame may be employed in an assembly using the novel lift frame assembly noted above, such as the lift frame assembly of applicant's co-pending U.S. Non-Provisional application Ser. No. 16/045,697, and while the unique cargo container base frame may be used in other assemblies, in a preferred embodiment herein of a cargo container and lift frame assembly, the preferred cargo container base frame, the preferred lift frame assembly and the longitudinally pivoting support legs described herein, such as legs 104 and 104′, are all used together.

The cargo container may also be moveable by crane or similar lifting device to be placed on a separate frame or other container when loading and unloading. However, in the preferred embodiment herein, as shown, the support legs 104 are storable and are provided so that upon unloading, the cargo container can remain in a free standing and separate position (see FIG. 11) and need not be separately removed by crane or operators need not position free-standing support legs beneath the container. The present invention provides a single operable cargo container assembly that is free standing for use with the locking mechanism and lift frame herein, accommodates preferred longitudinally pivotable storage legs and engages successfully with the preferred lift frame assembly herein as well as other preferred lift frames such as that of applicant's co-pending application Ser. No. 16/045,697 as noted above.

As shown, there are preferably a plurality of exterior facing and longitudinally extending recessed areas 102 under the cargo container body 101 and above the lift frame assembly 10 for receiving legs 104. Four such legs 104 and associated recesses 102 are provided in the embodiment shown. Two recesses are shown in FIG. 11 on one side of the cargo container and lift frame assembly 110, but it would be understood that two additional recesses may be provided on the opposite side of the cargo container assembly 58 for additional support legs shown there. While four support legs 104 are shown, it will also be understood to one skilled in the art that further legs and recesses may be provided (for example on a longer lift frame and cargo container) for additional support of the cargo container when is a free-standing position as in FIG. 11. Further, additional embodiments of the support legs are shown and described further herein.

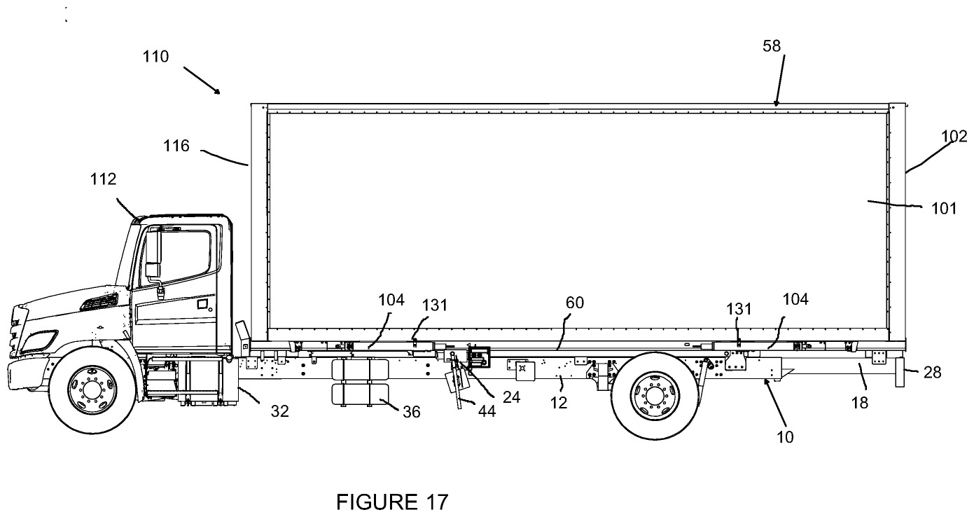

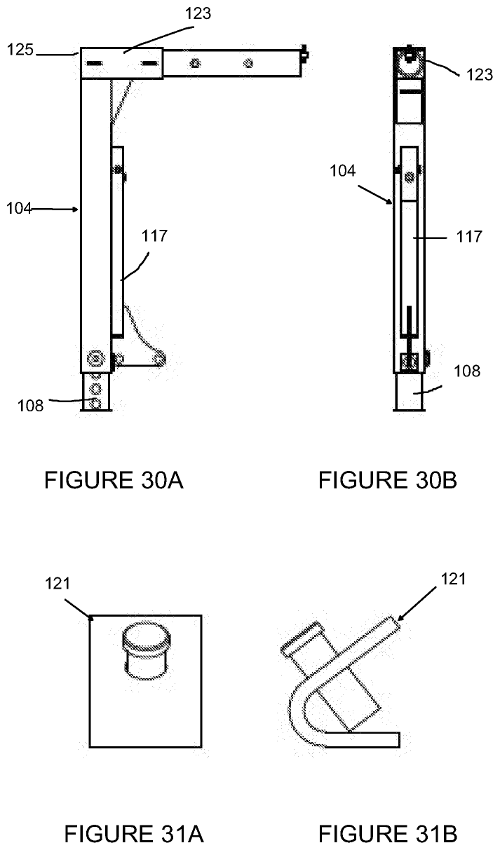

The support legs 104 as shown in embodiment 110 are each pivotally attached to a mounting plate 113 secured to and positioned on the container base frame 94 on a lower surface thereof. Such mounting plates 113 are shown in rear and front views in FIGS. 30A and 30B respectively, and are shown installed and secured in FIGS. 21-28. The support legs 104 are able to longitudinally pivot from a first standing position (see FIGS. 11-12) in which each of the plurality of support legs 104 is extending downwardly between the container base frame to a support surface S such as the ground or other platform to a second stored position as shown in FIGS. 17-20. In the stored position, each of the plurality of support legs is positioned into one of the longitudinally extending recessed areas 102 under the container body 101. The support legs 104 also preferably each include mounting moveable struts 117. In a preferred embodiment herein, a novel outer bearing bracket 119 is secured to each of the mounting plates 113 and is configured to engage an outer bearing 121 for securely engaging a mounting end 143 of the strut 117. As shown, the outer bearing 121 has a bent bearing plate 121a and a bearing shaft 121b. The shaft 121b is configured to engage a mating feature on the mounting end 143 of the strut 117. As shown, the strut 117 has an end plate 154 on its mounting end, the end plate defining an opening 156 that is configured to receive a mating feature on the bearing shaft 121b so as to flexibly secure the strut to the outer bearing. Other connectors and features that can engage the strut allowing support and flexibility may be provided within the scope of the invention.

In this embodiment, each of the support legs 104 is configured to be horizontally adjustable so as to be transversely extending from the cargo container base frame 94 when installed in the standing position and moved horizontally back into the frame mounting in a stored position. An extending arm 123 on a mounting end 125 of the leg 104 is provided to each support leg which is configured and shaped to extend within the container base frame 94 and below the mounting plate 113 to facilitate pivotal movement and is positioned within a support bearing 127 for securing the support legs to the support frame 94 and allowing for horizontal movement when not secured. Such extending arm 123 may be made to be telescoping or otherwise horizontally adjustable. As shown, the extending arm is telescoping. The support bearing is shown in an enlarged view in FIGS. 33A and 33B.

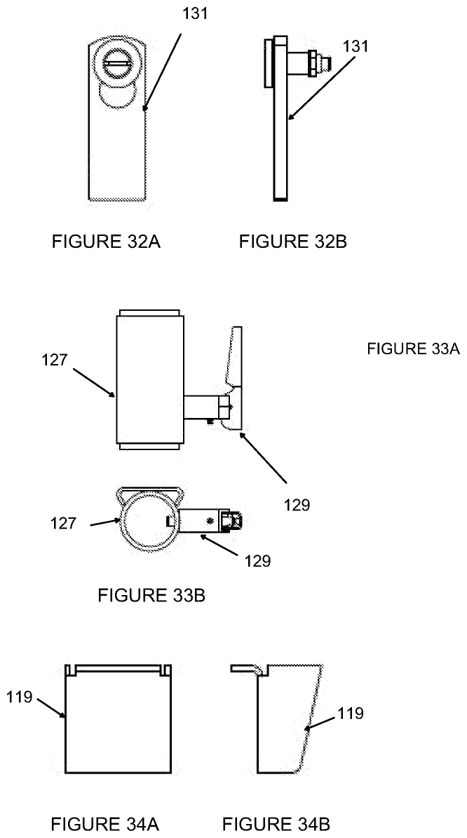

The support bearing 127 preferably comprises a locking mechanism to secure the support legs when installed. As shown, a locking spring bolt 129 as shown in FIGS. 33A and 33B is provided to the support bearing 127. Once the support leg 104 is moved to the stored position, it is preferred that a safety latch 131 is provided to secure the leg within the recess 102. Such a latch is shown in enlarged view in FIGS. 32A and 32B and may be mounted to the container base frame 94 by a suitable mounting plate or other mechanism. As shown the safety latch 131 is a moveable latch that can pivot from an open to a closed position over the leg and is mounted by a latch support plate 133 as shown in FIG. 37. As shown in FIG. 17, the latch is in the downward position to secure the stored support leg in the stored position. The latch 131 is moveable from an open position when it is moved upwardly away from the recess 102 to allow for removal of one of the support legs from the stored position to a closed position for securing the support leg in the stored position. Preferably at least one latch 131 is provided for each support leg. The support bearing 127 is also preferably securely mounted by a plate or other mechanism to the mounting plate 113. While the latch herein is provided as one manner of securing the stored support legs, other latch mechanisms, locks and the like may be used without departing from the spirit and scope of the invention.

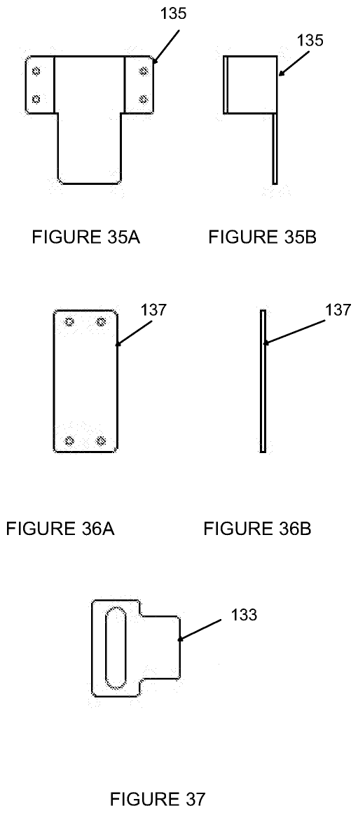

As the lift frame and cargo container are subjected to stress and movement during transport, it is also preferred in the cargo container assembly herein to provide to the cargo container base frame a support plate for further securing the support leg in position in the recess of the base frame in the stored position. A preferred support plate 135 is shown in an enlarged view in FIGS. 35A and 35B. The support plate is configured to cradle securely the extending leg 104 when stored. The support plate may be secured to the container base frame 94 by way of a support plate mounting plate 137 as shown in enlarged view in FIGS. 36A and 36B.

The support legs may also be lockably adjustable for height (see adjustable leg portion in the form of a foot 108). The recesses 102 are fully within the understructure of the cargo container base frame on the underside of the cargo container to securely hold the support legs 104 within the base frame 94 of the cargo container when not in a stored position and in a supported manner using the latch and support plate noted above.

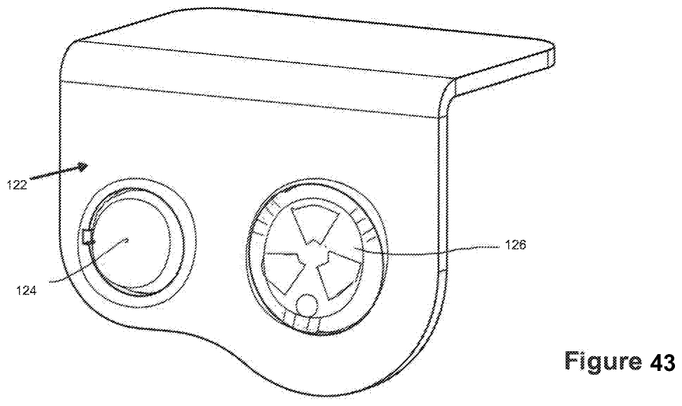

The cargo container and lift frame assembly 110, and the lift frame assembly 10, are each preferably attachable and detachable from a vehicle. As described above a variety of vehicles may incorporate an assembly of a cargo container (as defined herein) and a lift frame assembly and cargo and lift frame assembly according to the invention. In FIGS. 11-20, a truck 112 is used as a vehicle having the lift frame assembly 10 attached thereto. Such a truck 112 may incorporate standard electronic controls as are known or to be developed in the art for monitoring various functions of the truck and a semitrailer even if incorporating the lift frame assembly herein, such as for controlling warning and backup lights, tail lights, blinkers, a fifth wheel coupling, lubrication system or hydraulic lifts or air bags for interior tires/wheels, and the like. Such controls may be positioned on the truck, in or on the fifth wheel or on the lift frame. In the embodiment shown, the control feature such as a lock warning light and/or cut off switch and alarm may be provided inside the cab 114 of the truck 112 to allow the driver to know if there is an issue with the lock or other mechanisms. Such a system is to be wired into the electronic controls of the truck and in communication with the lock controls. Such electronic controls and their wiring as are known to those skilled in the art should be programmed to stop automated demounting and/or the lift system as well as to shut down the vehicle and/or provide a warning should the driver attempt to drive the vehicle when the lift frame assembly 10 is not locked to the cargo container assembly 58. Such a control panel example is shown in FIG. 43, wherein a flood light 122 and body lock alarm 124 for security purposes are in a mounting bracket 126 as shown. Such panel may be mounted on the lift frame, base frame or other area where visible near the locking mechanism 46. Preferably, the panel is dash mounted for viewing within the cab 114 of the vehicle 112. However, warning lights and alarms may be placed on the lift frame and/or in the cab. Other suitable warning mechanisms and alarms may be provided as well.

The invention also includes methods of loading a cargo container such as cargo container on a lift frame of a vehicle, for example, loading the preferred cargo container assembly 58 on the preferred lift frame assembly 10 herein, to create a vehicle cargo container and lift frame assembly, such as assembly 110 herein attached to a vehicle such as vehicle 112, and a method for unloading a cargo container from such a lift frame and vehicle cargo container and lift frame assembly so as to detach the cargo container assembly from the lift frame assembly 10. Each such method will be described below with reference to FIGS. 11-20.

In a method of loading a cargo container on a lift frame to create an assembly, in a first step a lift frame such as in lift frame assembly 10 is attached to a vehicle such as vehicle 112. This forms a structure similar to a tractor trailer, but having a lift frame assembly 10 as a trailer therein. The lift frame 10 may be as described above having the frame body 12, at least one lift mechanism 46 as described above and a source of compressed air 36 in fluid communication with the air bag(s) 74 on the respective lift mechanism(s) 46.

In addition, an air suspension system is preferably provided that includes a height adjustment valve for raising and lowering the height of the frame which height adjustment valve is in fluid communication with a source of compressed air. The height adjustment valve and air suspension system are preferably as described above, including the height adjustment valve 99, HCV 97 and air springs 93 in communication through conduit 95.

The vehicle 112 with the lift frame assembly 10 attached thereto is preferably backed under the cargo container of assembly 58 which is supported on a plurality of support legs, such as support legs 104 herein, wherein the support legs are in a standing and extended position. The cargo container preferably has two ends, a rear end and a front or vehicle-facing end. When free standing on support legs, the vehicle and attached lift frame assembly may be moved backwards or forwards as shown by directional arrows in FIG. 11. In this loading method, the vehicle 112 and lift frame 10 are moved backwards under the supported cargo container from a vehicle side end 116 of the cargo container, generally leaving cargo container access doors (not shown) for access on a rear end 120 of the cargo container body 101. When the lift frame assembly 10 is fully positioned under the cargo container assembly 58 as shown in FIG. 12, the stop preferably abuts or engages the vehicle-side end 116 of the cargo container assembly 58.

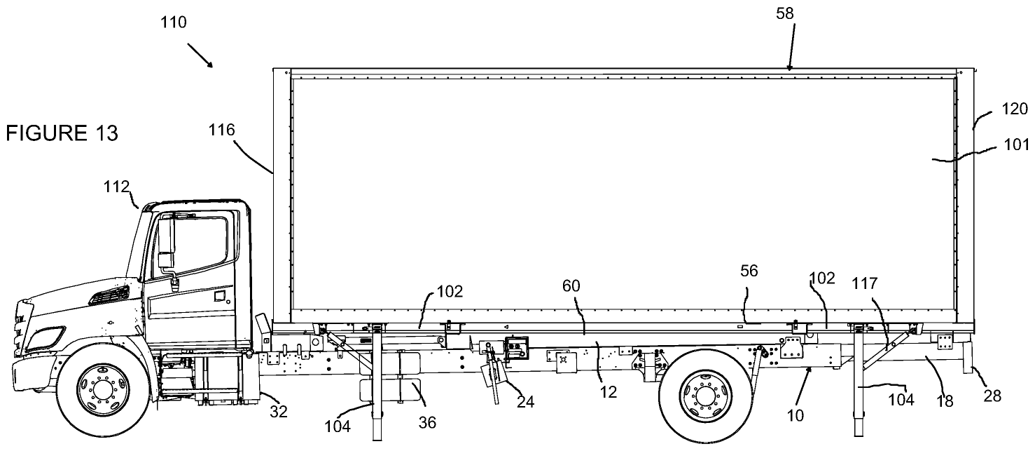

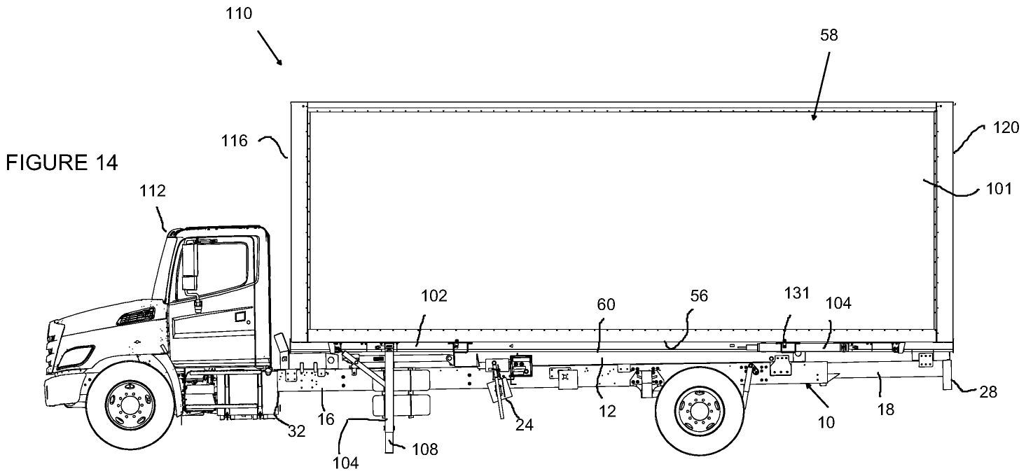

In the assembly embodiment shown, there is one lift mechanism 46, on a vehicle front side 20 of the frame body 12. The air bag is in its deflated position and the locking lever 44 is positioned downward in the unlocked position. The air suspension is likewise in a normal drive position with the height adjustment valve in drive mode. Each support leg 104 remains in place supporting the cargo container assembly 58. With reference to FIG. 13, the height adjustment valve in the air suspension system is moved to a stop position and the rear suspension adjusted to inflate and raise the air springs in the rear of the lift frame assembly near the rear end 28 of the frame 16 by inflating the air springs using the source of compressed air 36 thereby raising the rear facing portion of the cargo container assembly 58 and contacting the underside 56 of the cargo container assembly 58. Raising the frame height allows for removal of the rear support legs 104 as shown in FIG. 14. At this point, the rear support legs are pivotably moved to a stored position below the rear end of the cargo container assembly in the recesses 102 described above. The legs are preferably positioned so that the leg sits on and is secured by the leg support plate 135, and preferably the safety latch 131 is moved to the closed position. The spring bolt 129 is preferably also engaged to lock the extending arm 123 of the leg 104 in the support bearing 127. The vehicle frame height may now be again lower or maintained at the raised height. Preferably the frame height is lowered using the height adjustment valve and then the height adjustment valve is moved to the drive position to re-engage the HCV of the air suspension system.

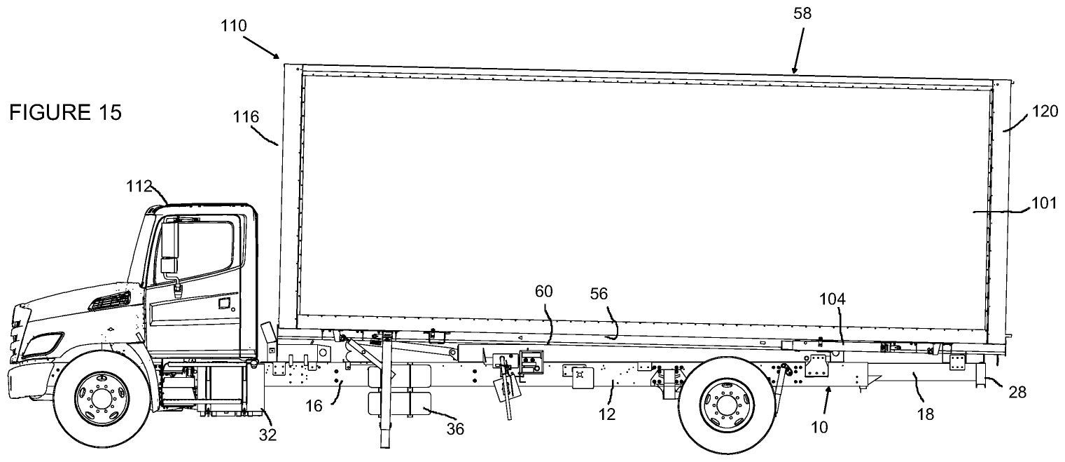

The inflatable air bag 74 of the lift mechanism 46 is then inflated as shown in FIG. 15 using the up/down control and the source of compressed air to lift the first or vehicle end 116 of the cargo container assembly such that the underside 56 of the cargo container assembly contacts the lifting surface. As shown in FIG. 15, the support legs under the front, vehicle side 32 of the frame 16 may now be pivoted into the storage recess in the same manner described above with respect to the rear support legs. Inflating the air bag allows for the adjustable support legs 104 located near the front end 116 of the cargo container to be removed by longitudinally pivoting the two front located support legs (sequentially by one operator or simultaneously by two operators) so as to pivot them upwards, preferably first by unlocking them, then once pivoted upwards, moving them into the recesses 102 located in the container base frame 94 of the cargo container assembly 58 so as to sit on the support plate 135 and are preferably also secured by the safety latch 131. The spring bolt 129 is preferably also engaged to secure the stored position support legs 104 at the extending arm 123 thereof in the support bearing 127.

While inflating of the air springs and air bag is described above sequentially to illustrate storage of the support legs in a manner preferred herein, it should be understood by one skilled in the art in view of this disclosure that the air suspension air springs 93 and the air bag 74 could have been both inflated simultaneously and then all legs lifted and stored in recesses when the cargo container is fully suspended and all legs lifted and stored also sequentially or simultaneously depending on the number of operators available to carry out the method and the speed with which the operator(s) wish to carry out the method.

Further it should be understood to one skilled in the art, that the air bag could be inflated initially and the associated legs stored, and then the air bag deflated and the air suspension engaged to raise the frame height in the rear of the lift frame without departing from the spirit or scope of the invention.

In FIG. 17, the air bag is shown as deflated, the frame height is lowered, and the height adjustment valve is in the drive position. Further, the cargo container assembly underside 56 is now supported by the lift frame and in contact with the lifting surfaces 54. As shown in FIG. 18, the locking mechanism 24 can now be engaged in the locking position as demonstrated by the locking lever 44 in the upward position.

FIGS. 18-20 illustrate the vehicle cargo container and lift frame assembly 110 in a fully assembled and locked position attached to a vehicle 112.

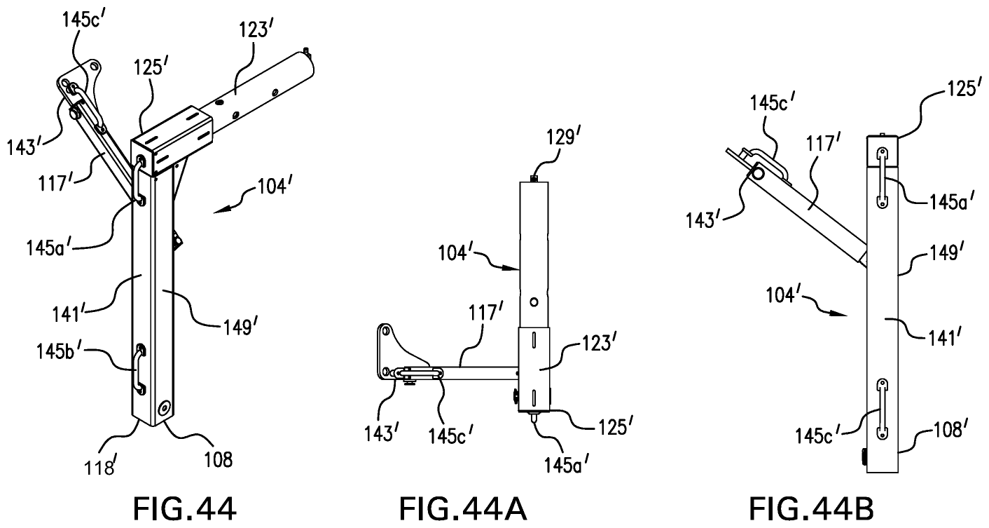

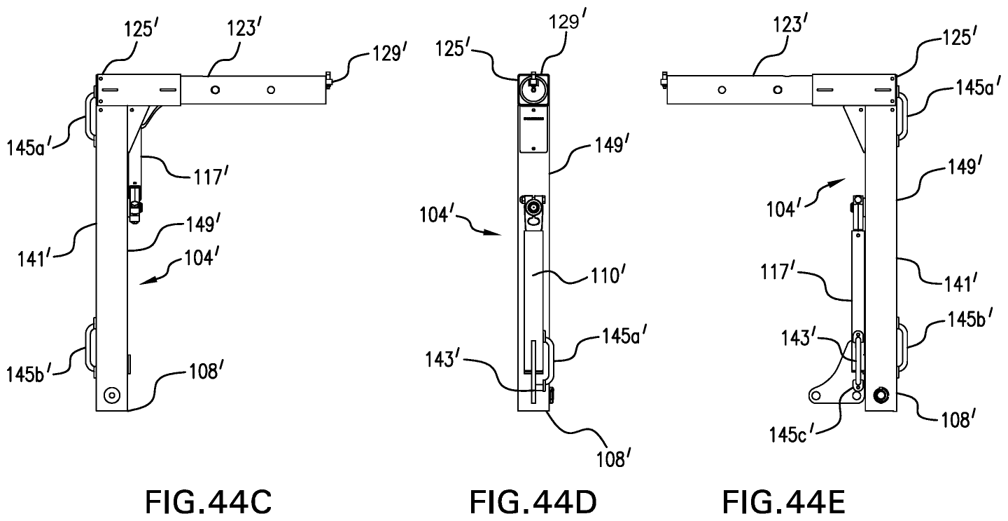

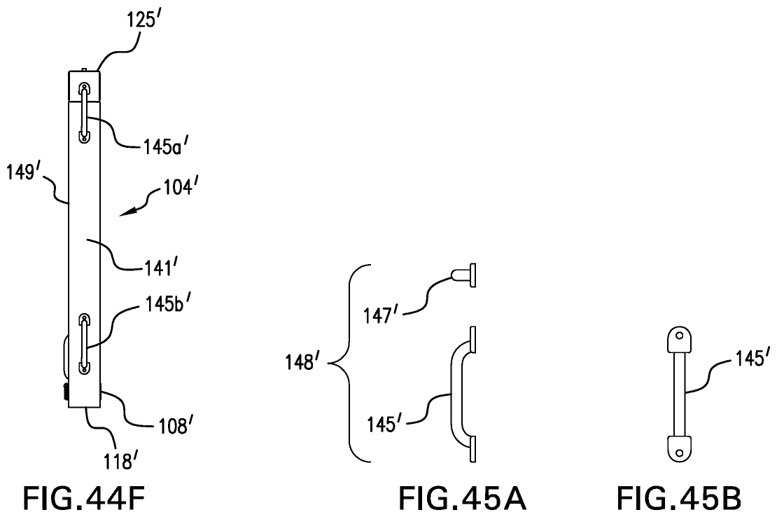

In an alternative embodiment of a lift frame 10′ and lift frame and cargo assembly 110′ herein, the same features as are noted above are incorporated herein, but the support legs are modified as best shown in FIG. 44-44F and with respect to FIGS. 45A and 45B. Support legs 104′ are provided and are based upon commercially available support legs as discussed above with respect to support legs 104, but are improved for use with assemblies herein. Such alternative support legs 104′ may be used with any cargo container frame capable of supporting a free-standing cargo container. The support legs 104′ include a longitudinally extending support leg portion 149′. The support leg portion 149′ extends from a mounting end 125′ of the support leg 104′ to a support base 118′ with an adjustable end portion 108′. The support leg 104′ further preferably includes an extending arm 123′ similar to that of support leg 104. The extending arm 123′ also extends generally horizontally from the mounting end 125′ of the support leg 149′ and is configured for pivotal mounting to a mounting plate on a cargo container base frame (such as the mounting plates and cargo container base frame described above although other mounting plates and/or base frames may be used with alternative legs 104′). The longitudinally extending support leg 149′ has an exterior-facing surface 141′ which is the surface of the leg that would be viewed by a user when looking at the truck from its side and which can be seen in both the support position and stored position of the support leg 104′.

In the alternative support leg 104′ at least one handle 145′ as shown in FIGS. 45A and 45B is provided. The handle 145′ is configured for grabbing by a user and is mounted preferably on an exterior-facing surface 141′ of the support leg. As shown, handle 145′ is extended outwardly to accommodate an average user's hand-size and is preferably for replaceable and/or removable attachment to the support leg. If it is replaceable and/or removable, it may be provided already assembled and fastened to a support leg 104′ or may be provided in a separate combination 148′ such as a kit including the handle 145′ and fastener 147′. As shown a fastener may be a screw nut, but may also be a rivet, nut and bolt, snap-fit attachment or other fastener or fastening system as are known or to be developed in the art. Similarly, as shown, the handle is a curved outwardly extending handle sized to allow a user's hand to slip under the handle for grabbing, but the handle may also be a solid extension piece, like a knob, or may be provided with finger gripping or knurled surfaces.

The handles 145′ are preferably in use painted a caution color, such as yellow, orange, or red and the like to draw attention to their use. They are provided to assist in gripping the legs for lifting and storing to avoid a user grabbing the legs improperly at a pinch point or in the event another user improperly drops or raises frame or lift frame height at the wrong time. It allows the user to maintain his or her hands outside of the assembly and represents a significant safety benefit for pivoting support legs that ride close to or within a cargo frame.

As shown in FIG. 44 with reference to FIGS. 44A-F as well, handles may be positioned at varying locations to assist with safety, but may be economized to be positioned in a position where a user should be grabbing for lifting or positioning a support leg 104′ for safety reasons and to ensure proper lifting and operation of the support legs 104′. In the Figures, a first handle 145a′ is positioned proximate the mounting end 125′ of the longitudinal extending leg 141′. The mounting end of legs 104, 104′ need not be the precise end/edge of the leg but is intended to include an area encompassing a top portion of the leg and the uppermost edge as well. Similarly, the support base 118′ may include the adjustable leg portion 108′. A first handle 145a′ may thus be positioned in the area proximate the upper mounting end 125′. A user can grab this handle 145a′ both in pushing and pulling the leg out horizontally to secure the spring bolt and in extending the preferably telescoping, extending arm 123′.

A second handle 145b′ is preferably positioned proximate the support base 118′ but above it and preferably above the adjustable leg portion 108′. The second handle being proximate the opposite end of the first allows for pivot lifting and movement up and down of the support leg.

The pivoting support leg 104′ as with leg 104 above may also include a moveable strut 117′ for securing to a mounting plate on a cargo container base frame. Such struts 117′ provide additional support and stability to the freestanding frame. Such struts, however, can also create user safety issues in moving and mounting and so in the preferred embodiment, of alternative support legs 104′, a third handle 145c′ may also be provided near a mounting end 143′ of the moveable strut 117′. While three such handles are shown in the preferred embodiment herein, one skilled in the art would understand based on this disclosure that the positioning of the handles could be varied if desired or more or less handles, which may include grips, pulls, and varying shapes could be employed within the scope of the invention to add to user safety, ease of operation and encourage preferred movement of the leg by a user.

In a preferred embodiment, as above with respect to legs 104, four such alternative support legs 104′ are used and are also configured and sized to fit within associated recesses such as recesses 102 described above.

The alternative support legs 104′ as shown are each able to be pivotally attached to a mounting plate, for example but not limited to, mounting plate 113 described above, and secured to and positioned on a container base frame such as container base frame 94 on a lower surface thereof. The alternative support legs 104′ are also able to longitudinally pivot from a first standing position such as that shown in FIGS. 11-12 for legs 104 in which each of the plurality of support legs 104′ would be extending downwardly between the container base frame to a support surface such as the ground or other platform to a second stored position as shown, e.g. illustrated by legs 104 in FIGS. 17-20. In the stored position, each of the plurality of support legs 104′ would be positioned into one of the longitudinally extending recessed areas 102 under the container body such as container body 101. If the alternative support legs 104′ also preferably each include mounting moveable struts 117′, they may be mounted to a mounting plate, such as, for example by the novel outer bearing bracket 119 described above or through another means of mounting.

Each of the support legs 104′ is also configured to be horizontally adjustable when transversely extending from a cargo container base frame, such as frame 94, when installed in the standing position and stored position using extending arm 123′ to facilitate pivotal movement. The extending arm 123′ may also be positioned, e.g., on a mounting plate by positioning it, for example, within a support bearing such as support bearing 127 for securing the support legs 104′ to a support frame such as cargo base frame 94. Such an extending arm 123′ may be made to be telescoping as with legs 104 or otherwise horizontally adjustable. As shown, the extending arm 123′ is telescoping. A locking spring bolt 129′ like bolt 129 of 104′ may also be provided as shown in FIGS. 44C and 44D. Once the alternative support leg 104′ is moved to the stored position, it is preferred that it is also secured with a safety latch such as latch 131 described above to secure the leg within a cargo container frame recess.

The support legs may also be lockably adjustable for height and have also an adjustable foot portion 108′ as do legs 104.

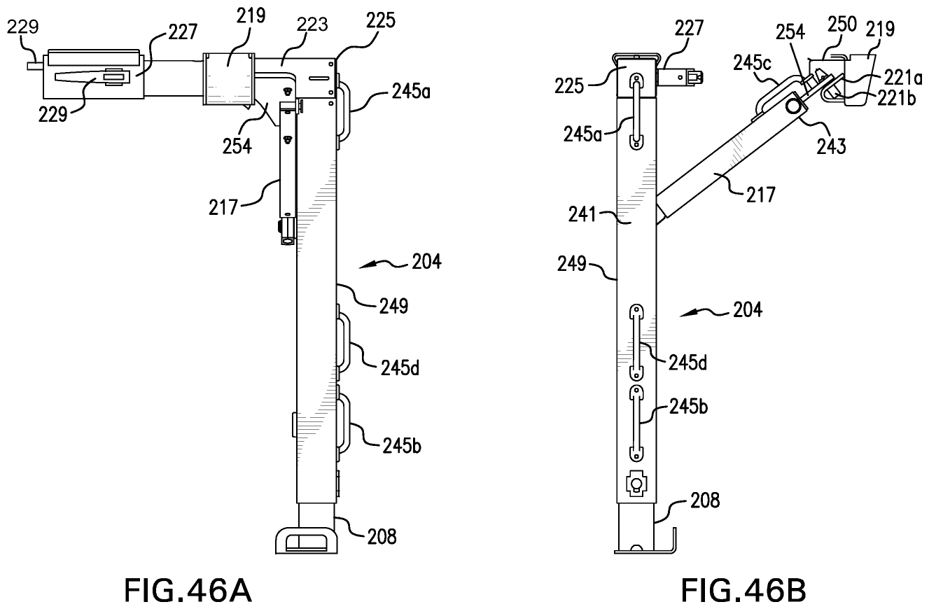

In a further alternative embodiment of a lift frame 200 and lift frame and cargo assembly 210 herein, the same features as are noted above are incorporated herein, but the support legs are modified as best shown in FIGS. 46A-46B, 48, 49 and 49A. Support legs 204 are provided and are based upon commercially available support legs as discussed above with respect to support legs 104, but are further improved for use with assemblies herein. Such alternative support legs 204 may be used with any cargo container frame capable of supporting a free-standing cargo container. The support legs 204 include a longitudinally extending support leg portion 249. The support leg portion 249 extends from a mounting end 225 of the support leg 204 to a support base 218 with an adjustable end portion 208. The support leg 204 further preferably includes an extending arm 223 similar to that of support leg 104. The extending arm 223 also extends generally horizontally from the mounting end 225 of the support leg 249 and is configured for pivotal mounting to a mounting plate on a cargo container base frame (such as the mounting plates and cargo container base frame described above although other mounting plates and/or base frames may be used with alternative legs 204). The longitudinally extending support leg 249 has an exterior-facing surface 241 which is the surface of the leg that would be viewed by a user when looking at the truck from its side and which can be seen in both the support position and stored position of the support leg 204.

In the alternative support leg 204 at least one handle 245 as shown in FIGS. 46A and 46B is provided. The handle 245 is configured for grabbing by a user and is mounted preferably on an exterior-facing surface 241 of the support leg as with leg 104′. As shown, a handle 245 is extended outwardly to accommodate an average user's hand-size and is preferably for replaceable and/or removable attachment to the support leg. If it is replaceable and/or removable, it may be provided already assembled and fastened to a support leg 204 or may be provided in a separate combination such as that shown in embodiment 10′, 110′ as kit 148′. Such as a could include the handle 245 and a fastener 247. As shown a fastener may be a screw nut, but may also be a rivet, nut and bolt, snap-fit attachment or other fastener or fastening system as are known or to be developed in the art. Similarly, as shown, the handle is a curved outwardly extending handle sized to allow a user's hand to slip under the handle for grabbing, but the handle may also be a solid extension piece, like a knob, or may be provided with finger gripping or knurled surfaces.

The handles 245 are also in use preferably painted a caution color, such as yellow, orange, or red and the like to draw attention to their use. They are provided to assist in gripping the legs for lifting and storing to avoid a user grabbing the legs improperly at a pinch point or in the event another user improperly drops or raises frame or lift frame height at the wrong time. It allows the user to maintain his or her hands outside of the assembly and represents a significant safety benefit for pivoting support legs that ride close to or within a cargo frame. In the present embodiment, it allows for dual user support or adjustable spacing support for lifting and/or can accommodate a focused lift if the legs 204 are formed of heavier materials.

As shown in FIGS. 46A and 46B, handles may be positioned at varying locations to assist with safety as with legs 104′, but may be positioned where a user should be grabbing for lifting or positioning a support leg 204 for safety reasons and in heavier lifts to ensure proper lifting and operation of the support legs 204. In the Figures, a first handle 245a is positioned proximate the mounting end 225 of the longitudinal extending leg 249 on exterior facing surface 241. The mounting end of legs 104, 104′, 204 need not be the precise end/edge of the leg but is intended to include an area encompassing a top portion of the leg and the uppermost edge as well. Similarly, the support base 218 may include the adjustable leg portion 208. A first handle 245a may thus be positioned in the area proximate the upper mounting end 225. A user can grab this handle 245a both in pushing and pulling the leg out horizontally to secure the spring bolt and in extending the preferably telescoping, extending arm 223.

A second handle 245b is preferably positioned proximate the support base 218 but above it and preferably above the adjustable leg portion 208. The second handle being proximate the opposite end of the first handle allows for pivot lifting and movement up and down of the support leg.

The pivoting support leg 204 as with legs 104, 104′ above may also include a moveable strut 217 for securing to a mounting plate on a cargo container base frame. Such struts 217 provide additional support and stability to the freestanding frame. Such struts, however, can also create user safety issues in moving and mounting and so in the preferred embodiment, of alternative support legs 204, a third handle 245c as with legs 104′ may also be provided near a mounting end 243 of the moveable strut 217.

In embodiment 210, a fourth handle 245d is provided that is positioned adjacent to the handle 245b but upwardly positioned on the side of the handle 245b furthest from the support leg base 218. The fourth handle can enable a focused lift of two hands on the support leg base 218 when lifting the leg and/or enable an easier reach lift for those requiring a closer proximity between hands when lifting. It can also enable further assistance of a second lifter if two lifting personnel are needed, e.g., for heavier legs. While four such handles are shown in the preferred embodiment 210 herein, as with assembly embodiments 10, 110 and 10′, 110′, one skilled in the art would understand based on this disclosure that the positioning of the handles could be varied if desired or more or less handles, which may include grips, pulls, and varying shapes could be employed within the scope of the invention to add to user safety, ease of operation and encourage preferred movement of the leg by a user.

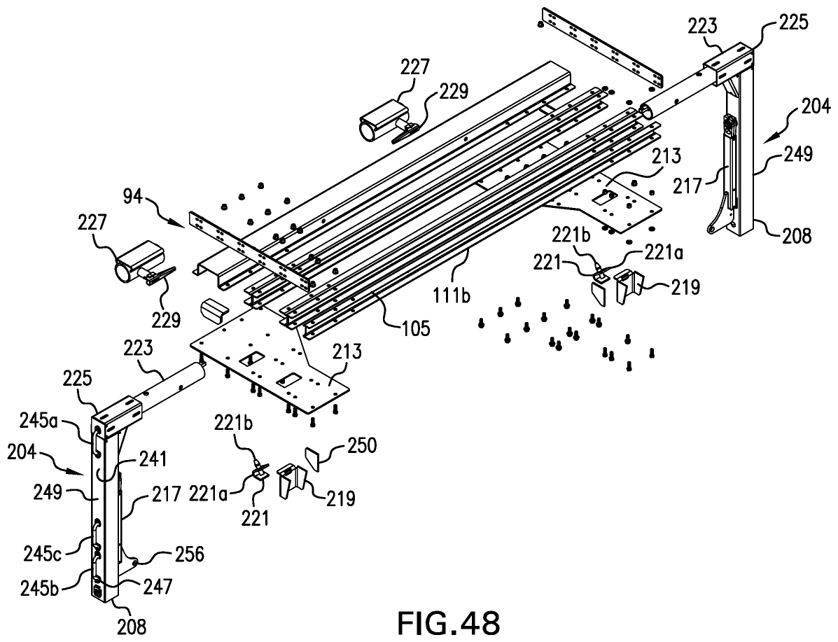

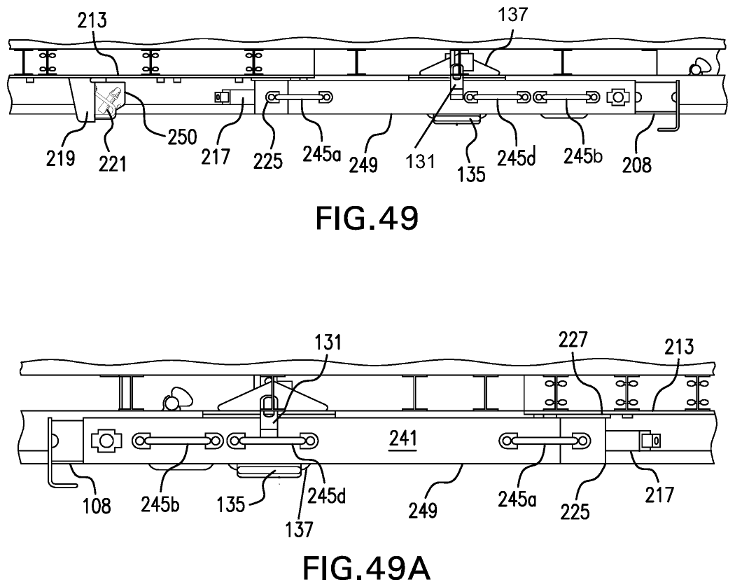

As best shown in FIGS. 48, 49 and 49A, in embodiment 210, as above with respect to legs 104, 104′, four such alternative support legs 204 are used and are also configured and sized to fit within associated recesses 202 which may be the same as recesses 102 as described above or modified for any variation in base frame design.

The alternative support legs 204 as shown are each able to be pivotally attached to a mounting plate, for example but not limited to, mounting plate 213 of FIG. 48 and as described above, and secured to and positioned on a container base frame such as container base frame 94 described above on a lower surface thereof. The alternative support legs 204 are also able to longitudinally pivot from a first standing position such as that shown in FIGS. 46A and 46B in a manner similar to that shown in FIGS. 11-12 for legs 104 in which each of the plurality of support legs 204 would be extending downwardly between the container base frame to a support surface such as the ground or other platform to a second stored position as shown, e.g. as illustrated by legs 104 in FIGS. 17-20 and in FIGS. 49 and 49A for legs 204. In the stored position, each of the plurality of support legs 204 would be positioned into one of the longitudinally extending recessed areas 202 under the container body such as container body 101. If the alternative support legs 204 also preferably each include mounting moveable struts 217 as shown, they may be mounted to a mounting plate 213 of FIG. 48, such as, for example by the novel outer bearing bracket 119 described above, through another means of mounting or as shown in embodiment 210, using a further embodiment of an outer bearing bracket shown as bracket 219.

Each of the support legs 204 is also configured to be horizontally adjustable when transversely extending from a cargo container base frame, such as frame 94, when installed in the standing position and stored position using extending arm 223 to facilitate pivotal movement. The extending arm 223 may also be positioned, e.g., on a mounting plate 213 by positioning it, for example, within a support bearing such as support bearing 227 for securing the support legs 204 to a support frame such as cargo base frame 94. Such an extending arm 223 may be made to be telescoping as with legs 204 or otherwise horizontally adjustable. As shown, the extending arm 223 is telescoping as with arm 123 noted above. A locking spring bolt 229 like bolt 129 of embodiments 104, 104′ may also be provided as shown in FIGS. 46A, 46B and FIG. 48. Once the alternative support leg 204 is moved to the stored position, it is preferred that it is also secured with a safety latch such as latch 131 described above to secure the leg 204 within a cargo container frame recess 202 as shown in FIGS. 49 and 49A.

The support legs 204 may also be lockably adjustable for height and have also an adjustable foot portion 208 as do legs 104, 104′.

Further in embodiment 210, the support legs 204 as noted above are each pivotally attached to a mounting plate 213 secured to and positioned on the container base frame 94 on a lower surface thereof as shown with respect to FIGS. 48, 49 and 49A. Such mounting plates 213 are shown in a rear view for example in FIG. 48, and are shown installed and secured in FIGS. 49, 49A. The support legs 204 are able to longitudinally pivot from a first standing position (see FIGS. 11-12, and 46A-46B) in which each of the plurality of support legs 204 is extending downwardly between the container base frame to a support surface S such as the ground or other platform to a second stored position as shown in FIGS. 49, 49A. In the stored position, each of the plurality of support legs is positioned into one of the longitudinally extending recessed areas 202 as noted above. The support legs 204 also preferably each include mounting moveable struts 217. In a preferred embodiment herein, a novel outer bearing bracket 219 is secured to each of the mounting plates 213 and is configured to engage an outer bearing 221 for securely engaging a mounting end 243 of the strut 217. As shown, the outer bearing 221 has a bent bearing plate 221a which is similar to 121a above, and a bearing shaft 221b with a tapered bearing head 221d as shown. Detents 221c or other locking mechanisms may be provided to ensure secure placement of the shaft head 221d in the plate 221a. The shaft head 221d is configured to engage a mating feature on the mounting end 243 of the strut 217. As shown, the strut 217 has an end plate 254 on its mounting end, the end plate defining an opening 256 that is configured to receive a mating feature such as shaft head 221d on the bearing shaft 121b so as to flexibly secure the strut to the outer bearing 221. Other connectors and features that can engage the strut allowing support and flexibility may be provided within the scope of the invention.

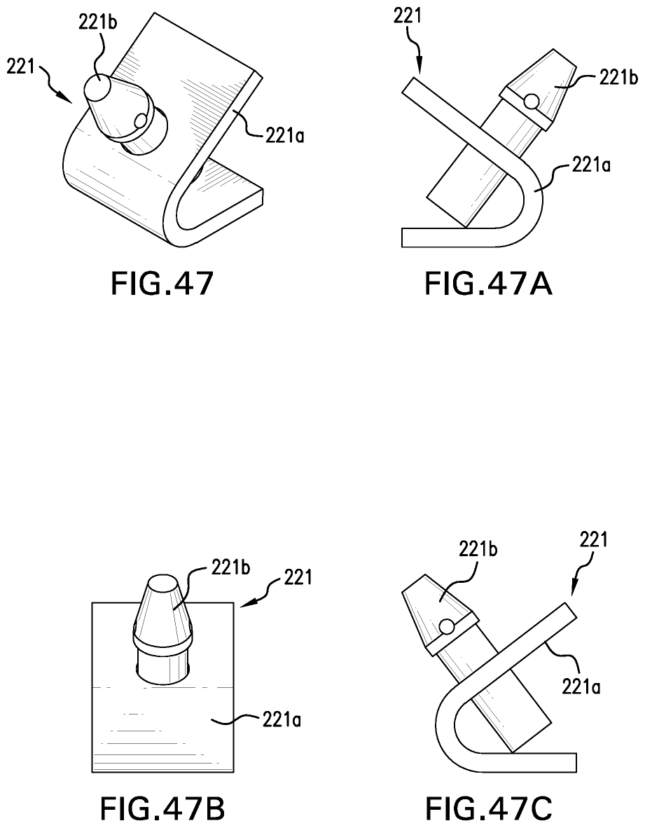

Embodiment 210 further includes a stop plate 250 as shown in FIGS. 46A, 46B, and 47 which is configured to provide additional support and mounting stability to the outer bearing 221 and outer bearing bracket 219.

In a method of unloading a cargo container from a lift frame of a vehicle cargo container and lift frame assembly so as to detach the vehicle cargo container from the lift frame of the assembly, the method will now be described also with reference to FIGS. 11-20 and with respect to support legs 104 for illustrative example purposes only, although it will be understood by one skilled in the art based on this disclosure that support legs 104′ and 200 may be used interchangeably in the following method.

Starting with FIGS. 18-20, a truck arrives with a cargo container and lift frame assembly 110 in a fully assembled and locked position. The lift frame assembly 10 is positioned on the top portion of the frame 16. The lift frame is first unlocked from the frame body 12 as shown in FIG. 17. The unlocking is done by depressing the locking lever 44 into a downward position so as to disengage the locking mechanism 24.

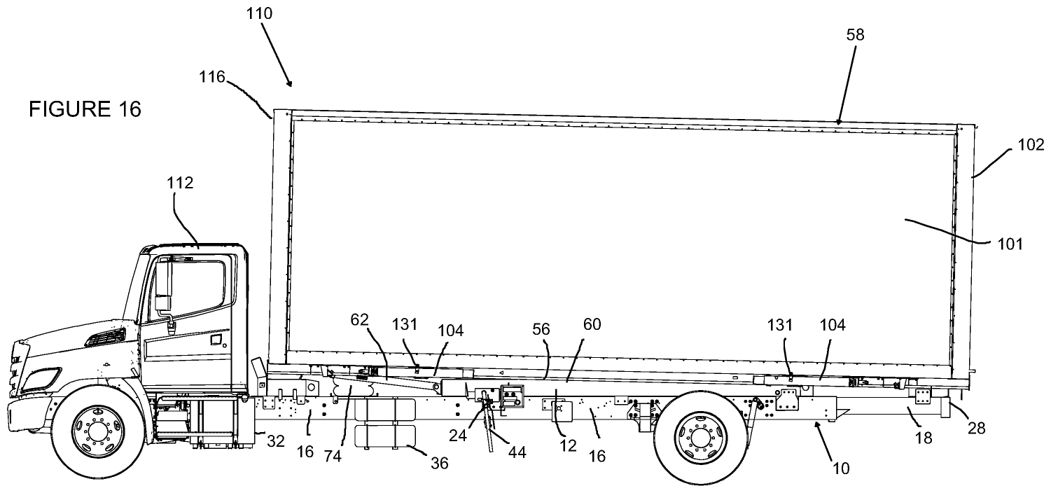

After unlocking, either the inflatable air bag 74 is inflated or the rear frame height raised using the air suspension system, or such actions may be done simultaneously. As shown in FIG. 16, the air bag 74 in the lift mechanism 46 located under the front vehicle end 116 of the cargo container assembly is inflated. With reference to FIG. 15, the support legs 104 are then positioned in a support position. To do so, any safety latch is moved to an open position, and the support legs on the front of the cargo container assembly are removed from the recesses one at a time or simultaneously and longitudinally pivoted downward to a support position, their height adjusted and locked towards their support base 118, and the extending arm adjusted.

When the support legs 104 are in place in the front end 116 of the cargo container assembly, the air bag 74 near the front end is then deflated as shown in FIG. 14. If done sequentially, after one pair of support legs is in the support position and the air bag deflated, then the other end of the cargo container may be raised by engaging the height adjustment valve of the air suspension system and moving it to the stop position to enable the operator to raise the height of the frame, preferably in the rear of the frame, by moving the handle on the valve to inflate the rear air springs as shown in FIG. 14. Once the vehicle height is raised, as shown in FIG. 13, the latch for the rear support legs may be moved to the open position and the support legs 104 under the rear end 120 of the cargo container assembly may be removed from the recesses 102 and longitudinally pivoted into a support position from a stored position, either simultaneously or one at a time. With reference to FIG. 12, the vehicle frame height may then be lowered leaving the cargo container assembly fully supported on the support legs 104. The height adjustment valve may be returned to the drive position to enable the HCV.

As shown in FIG. 11, the truck 112 with its an unlocked lift frame assembly 10 attached to the truck may drive away from the fully supported cargo container assembly which is now supported by support legs 104. Once this is achieved, the vehicle with the lift frame assembly attached is driven away from the supported cargo container assembly leaving it behind on the support legs. The vehicle is driven away with the cargo container detached in a forward direction as shown so as to pull away from the cargo container 58.

FIG. 40-42 illustrate the control systems 128 for the air compressor 38 and lift frame and for the air suspension system 90 herein. With reference to the control panel 42 as shown in FIG. 10, and using the diagram in FIGS. 40 and 41, the toggle switch 88 noted above is operably connected to the system via a valve 130, which may be a 5/3-way valve associated with a toggle 88 that lifts and lowers the air bag 74. The valve can be selected and varied so as to raise and lower the air bag by inflating and deflating. Further the valve 130 may be configured to fully inflate or deflate or to partially inflate or deflate by preference. The pressurized air 39 flows from air tanks 36 passes in conduit 139 through the selector valve in a directed flow as selected through the pressure control/limiting valve 134 to ensure that overly pressurized air does not impact operation of the selected equipment. Air flows towards the air bag 74 through an inflate/deflate control valve 140 which can be or include a spring-loaded check valve 138 or other suitable valve.

Air tanks 36 preferably incorporate a relief valve 142 to relieve excessive pressure and for safety reasons. A test connection 144 may be provided to the air tanks 36. The tanks are also preferably equipped with a drain valve 146. Other system configurations and assemblies are possible for carrying out variations in embodiments herein in accordance with control system techniques known in the art or to be developed.

With reference to FIGS. 40-41, 42, 42A and 42B, the tanks 36 as a source of pressurized air 39, pass through a conduit 139 toward the selector valve 130 for raising and lowering the air bag 74. A further conduit 95 also runs from the air tanks 36 as a source of pressurized air 39 and through a second conduit 95 for allowing air to pass into the air springs as described above. The conduit passes to and also operably connects the height adjustment valve 99 and HCV 97 so that they can be alternatively operable depending on the position of the height adjustment valve 99. While such control systems and arrangements are described, other mechanisms for providing compressed or pressurized air to an air suspension system or to inflate the air bag 74 may be used provided the same lift strength and suitable air pressure for lifting can be accommodated.

In yet a further embodiment 310 herein, the assemblies 10, 110, 10′, 110′ or 200 herein may be modified to incorporate a different support leg system. Support legs 304 are not pivotable legs, but operate through longitudinal downward extension and upward retraction at the support base, and in the case of certain of the support legs also through transverse outward extension and inward retraction at the mounting end. Such legs avoid a fully outwardly extended leg as in prior art stowable legs and also do not adopt a pivoting motion, allowing for minimal operator space in use when parked in a stowed position. As a result, the need for a longitudinal storage area along the side of the frame for receiving legs that pivot upward as described above may be omitted from the cargo frame design.

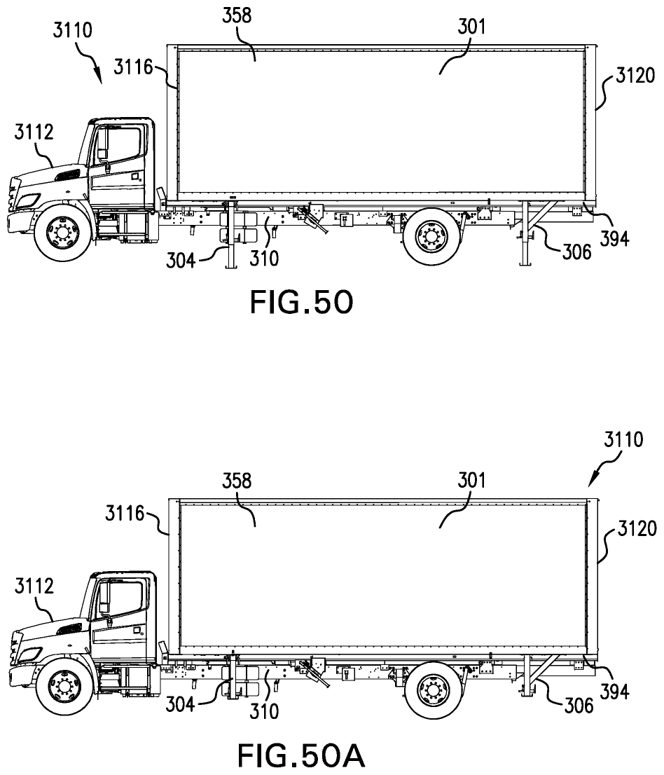

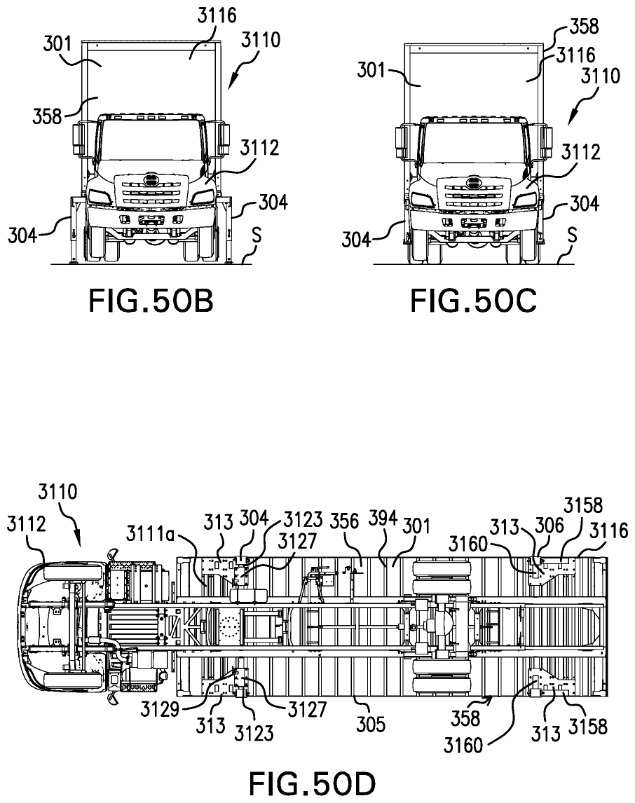

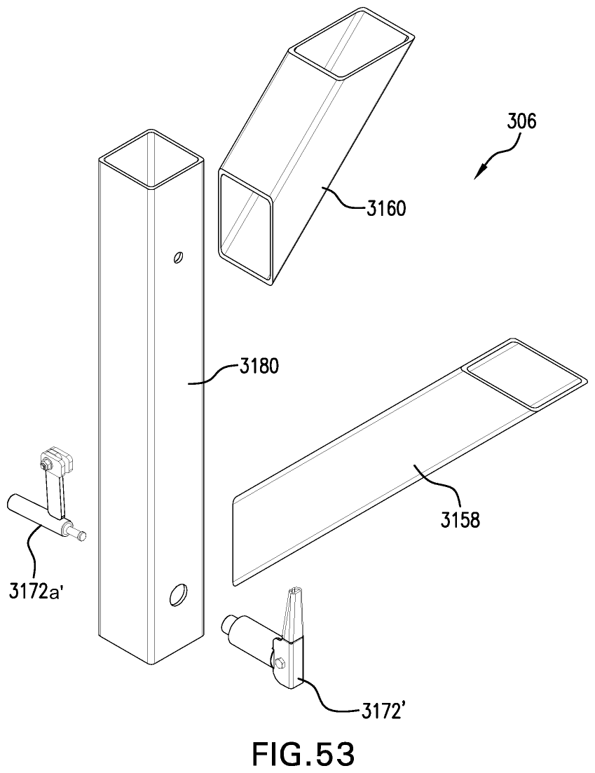

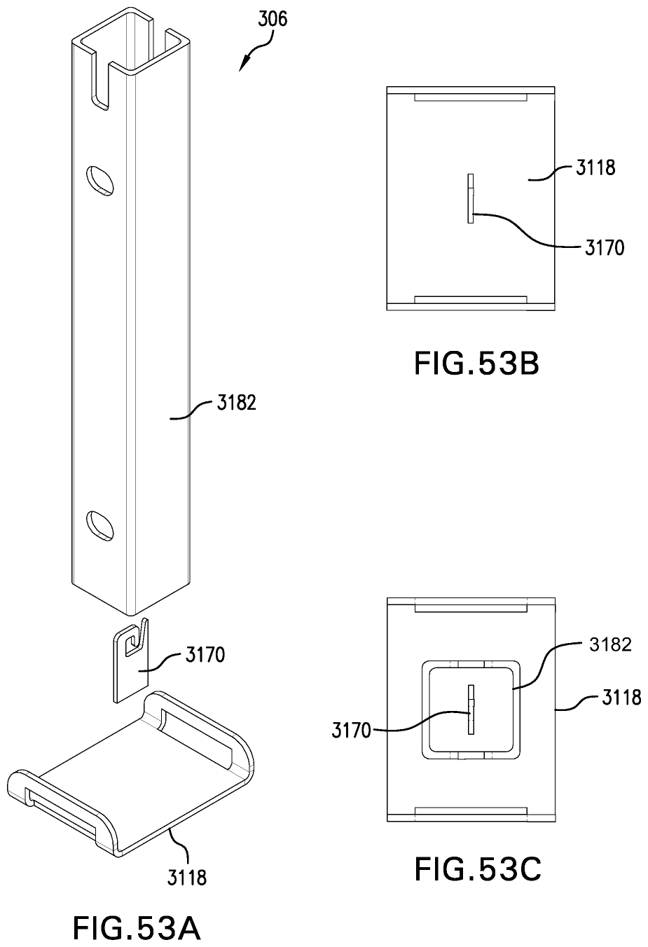

Embodiment 310 is further described herein with respect to FIGS. 50-58D. A cargo container and lift frame assembly 3110 is shown in FIGS. 50-50D having support legs 304, 306. A cargo container assembly 358 which may be the same as the cargo container assembly or cargo container 58 as described above or a modified container or container assembly, is preferably fitted with an underlying cargo container base frame 394 extending beneath the underside 356 of cargo container 358 and above the base frame 318 of the vehicle which extends from a front end 332 to a rear end 328. The base frame may be varied and can be a variety of suitable base frames, but is preferably a lift frame assembly 310 such as lift frame assembly 10 noted above with similar parts and including an air lift mechanism, lift body and other related parts as described in detail above. It may also be a lift frame as described in U.S. patent application Ser. No. 16/045,697. Further it may be modified as described herein above in lift frame assembly 10 to include a rear air suspension lift as described herein.

In embodiment 310 having non-pivoting legs, the front support legs 304 may preferably vary from those used in the rear of the vehicle shown herein as support legs 306 for reasons explained further below. However, it is within the scope of the invention to use support legs 306 in the front 3116 of the cargo container and support legs 304 in the rear 3120 of the container 358 or to use all support legs in the design of support legs 304 or all of the support legs in the design of support legs 306.

According to embodiment 310, herein, a lift frame is provided and is the same as the lift frames noted above. Thus, any of the lift frames noted above (or alternative lift frames) may be employed, with the proviso that the lift frame used should be a locking lift frame to secure a cargo container frame to the lift frame. The lift frame may also be as described in applicant's co-pending application Ser. No. 16/045,697. Locking mechanisms of varying types may be used such as those described above. The vehicle frame may also include tires, wheelbase and an air suspension as noted above, wherein the air suspension may optionally be adapted for lifting in the lift system as describe herein.

When the lift frame assembly (such as assembly 10 herein) is employed in loading and unloading a cargo container assembly such as cargo container assembly 358, in addition to use of a lift mechanism with inflatable air bag as described above, the height of the vehicle frame may also be raised and lowered by use of the vehicle air suspension system such as system 90 noted above for raising and lowering a rear end of a cargo container assembly for storing or deploying support legs.

The lift frame assembly such as the lift frame assembly described above may be combined with a cargo container assembly 358 herein to form a vehicle cargo container and lift frame assembly 3110 for use with vehicles such as hauling trucks and other vehicles noted herein. The assembly 3110 is shown in FIG. 50-50D on a vehicle. The cargo container assembly 358 as shown to illustrate the invention herein may be varied in the manner as noted above. The cargo container assembly 358 may be used with a different lift frame assembly. For the purpose of illustrating the benefit of the cargo container assembly 358, the preferred lift frame assembly and cargo assembly 358 are combined to form a preferred cargo container and lift frame assembly 3110 as shown.

The cargo container assembly 358 is preferably configured to be removably seated on a frame. The cargo container assembly preferably includes a cargo container body 301 and a container base frame 394. The container base frame 394 in this embodiment is designed to incorporate preferred features, including frame or bar elements that are preferably positioned to engage and receive the locking hooks described above.

The preferred container base frame 394 is described herein. As shown in FIGS. 50D to 58D, various elements and components of the container base frame are shown. The container body 301 is positioned on top of the container base frame 394 which is configured to be removably seated on the lift frame assembly 310, which may be the same as lift frame assembly 10 described herein.

The cargo container base frame 394 includes at least one longitudinally extending rail 303 and a series of cross members 305 that are longitudinally spaced apart and either overlie or are positioned beneath the rail(s). As shown, so as to engage the lift frame assembly 10 as preferred herein, two rails 303 are positioned beneath crossmembers 305 in the manner described above with respect to base frame 94. With reference to FIGS. 50D-58D, certain of the cross members 305 are spaced in one manner in the central area 307 of the frame than spacing between cross members 305 on end portions 3111a,b of the frame 394. This spacing allows for some accommodation of hardware for attaching the support legs. In end portions 3111a,b of the container base frame 394 the cross members 305 are spaced apart somewhat more closely and can be modified provided that they are arranged in a manner capable of accommodating and being connected to a plurality of leg mounting plates 313 for support legs 304, 306. As shown in the vehicle facing (front) end 3111a of the cargo base frame there are several closely spaced members to accommodate support as well as allowing installation of support legs 304. The rear facing end 3111b also has more closely spaced cross members. In addition, it is acceptable to include internal shorter length cross members in locations which are useful for engaging features of a lift frame assembly frame body for securing the container base frame 394 to the lift frame assembly 310 in the same manner noted above with respect to lift frame assembly 10. If a different lift frame is used in combination with the cargo container assembly 358, the spacing of the cross members may be modified and the location of modified cross members, if any, altered to engage a different lift frame.

Preferably, for mounting the support legs 304, 306 pairs of leg mounting plates 313 are situated on opposite sides 315 of the container base frame 394. While a plurality of pairs of support legs may be provided, depending on the support needed or desired, in the embodiment shown, two pairs of mounting legs 304, 306 are provided, wherein the rear mounting legs 306 are of a different design than the front mounting legs 304 in a preferred embodiment herein. As shown, a pair of leg mounting plates 313 are situated in a portion of the front (vehicle facing) end 3111a of the container base frame 394 and a pair of leg mounting plates 313 are situated in a portion of the rear end 3111b of the container base frame 394.

In the container base frame herein, the rail(s) 303 and cross members 305 may be connected by various methods, such as welding, riveting, and/or through use of a bracketing system as described in preferred frames described in applicant's co-pending Non-Provisional application Ser. No. 16/436,855. In addition, reinforcing members or spacers may be provided below the frame if desired.

Support legs 304 are shown herein as non-pivoting support legs. The support legs 304 (and 306) provide the benefit in that they do not pivot either transversely outwardly from the cargo container in storage and or longitudinally, but instead the support legs 304 may be extended horizontally outwardly from the base frame a distance similar to that of the longitudinally pivoting legs 104, but instead of pivoting, such legs are also extendible in a vertical direction, i.e., they may retract and extend in a vertical manner without pivoting raising up from the ground for traveling and down to the ground for free-standing of the cargo container and lift frame assembly. In doing so, the operator need not pivot the legs 304 at all, but may simply pull them horizontally outwardly from the area of the frame 394 below the mounting plate 313, and then use a spring lock to extend the legs downwardly or upwardly as desired. Such design even further economizes space. The support legs 306, operate similarly to legs 304 with respect to the ability to retract or extend the legs vertically when traveling or when free-standing, respectively. However, support legs 306, in a preferred embodiment shown herein, can be designed so as to be stationary and mounted directly to the mounting plate 313 as there is no need to extend the rear support legs 306 outwardly in a horizontal direction when standing. Additional support members are provided by extending arms are described herein below.

In the invention herein, a mounting system is provided with the cargo container base frame 394 and cargo container assembly 358 herein that enables secure horizontal retraction of an extending arm 3123 of the front support legs 304 into a modified support bearing 3127 when moving such extending arm 3123 back under the cargo frame 394 for operating the vehicle and for allowing outward horizontal extension of the extending arm 3123 during the loading and unloading of the cargo container. The rear support legs, if the same, may also have this feature. In the preferred embodiment herein, the rear legs have support arms 3158, 3160 that extend in a direction generally parallel to the sides 315 of the base frame 394, and in a direction generally perpendicular to the sides 315 of the base frame 394, respectively. Such support arms 3158, 3160 are fixed to the mounting plate 313 and not moveable. As shown in the bottom view of the frame 394 in FIG. 50D, the support arms are arranged so as to be orthogonally arranged with respect to each other. However, it is within the scope of this disclosure that the support arms, while providing additional support and stability, may be omitted, there may be only one or there may be more than two. Further, it is possible to angle the support arms so as to be more or less than about 90 from each other.

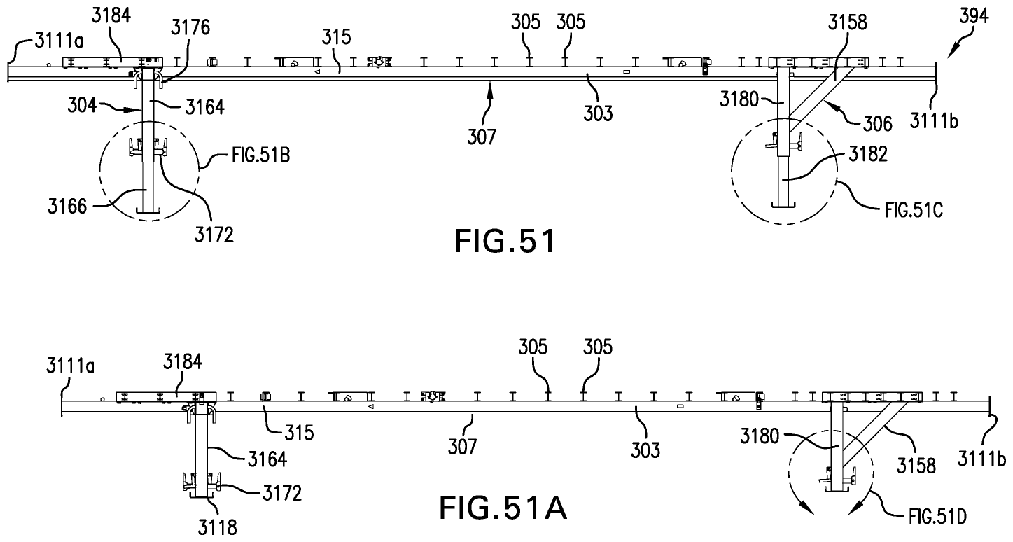

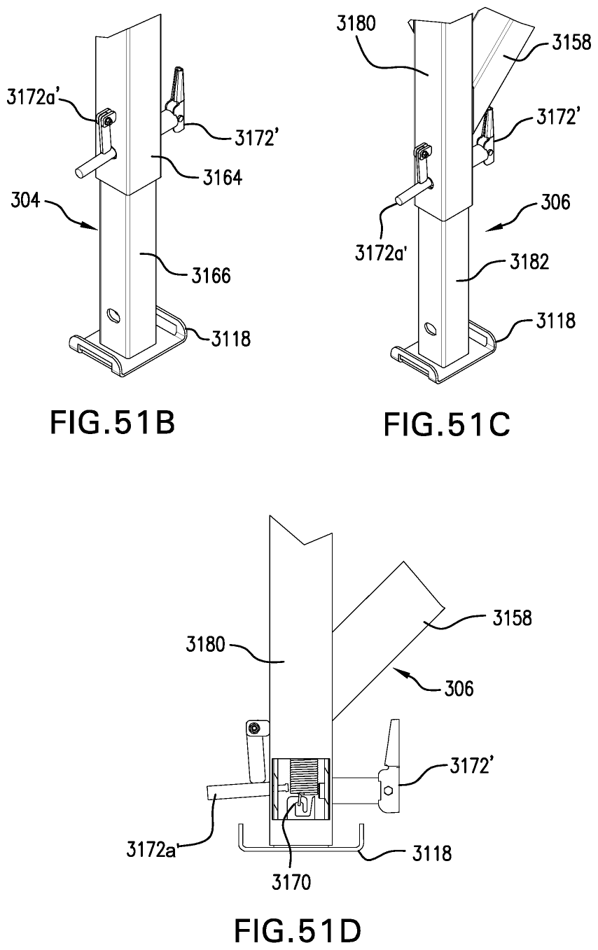

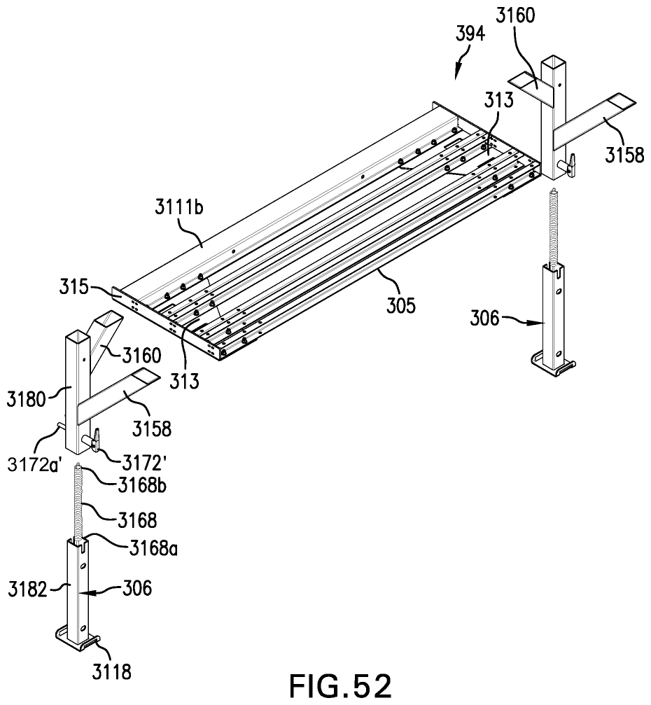

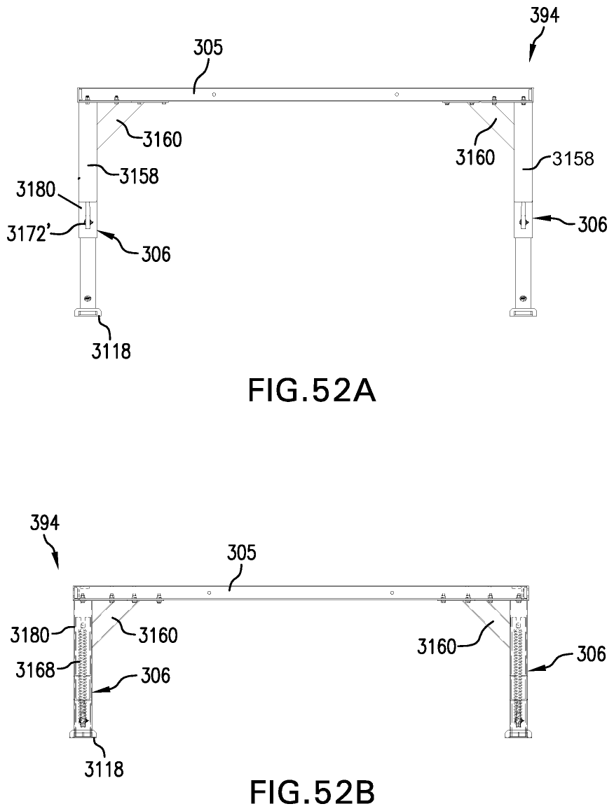

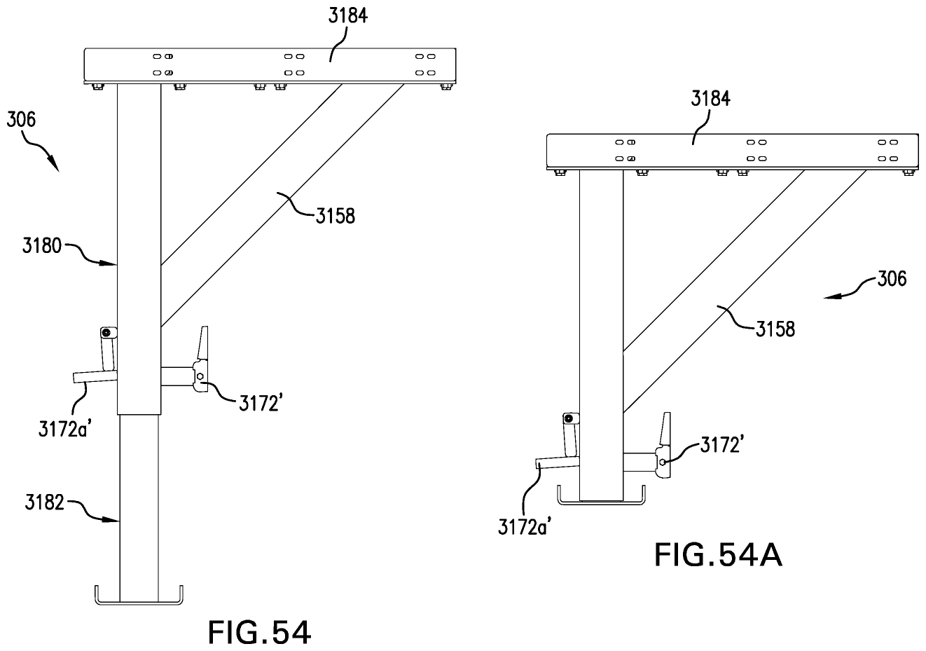

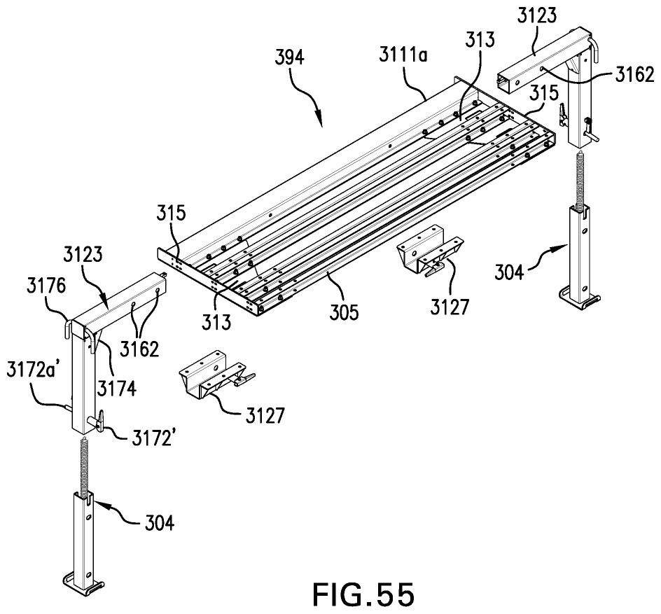

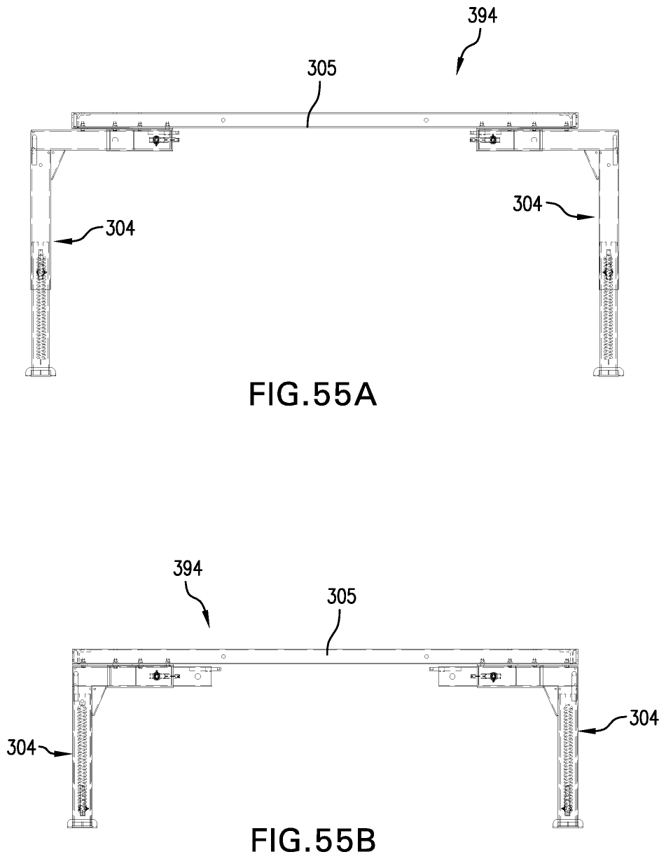

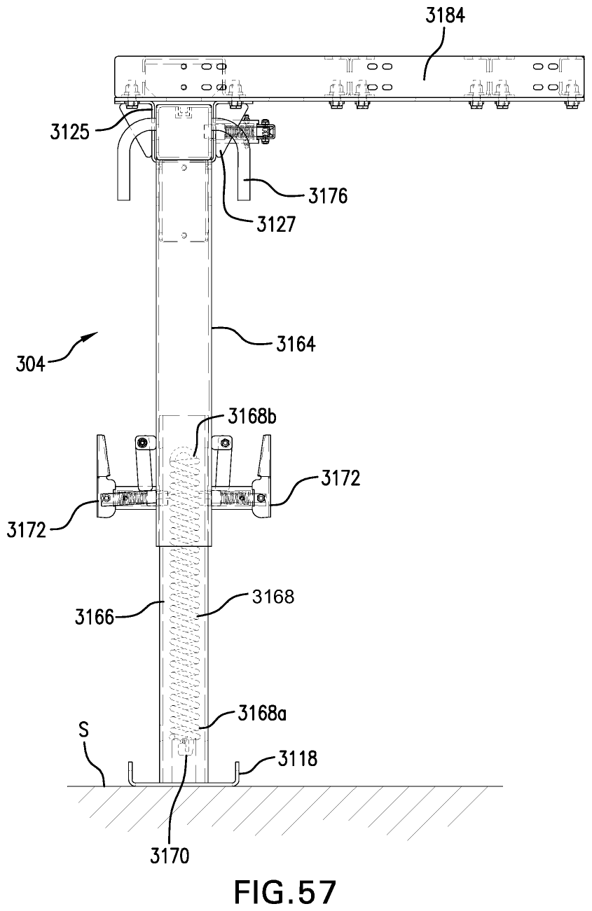

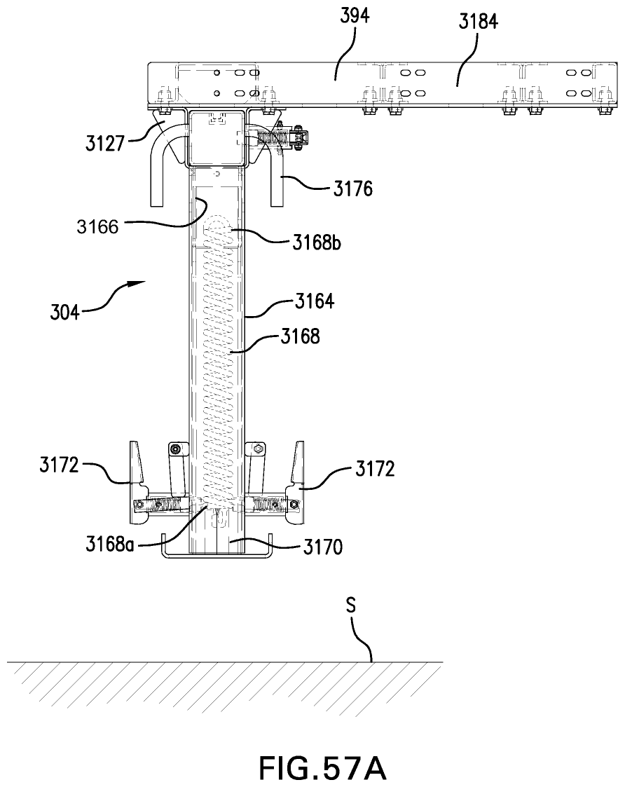

The cargo container 358 may be moveable by crane or similar lifting device to be placed on a separate frame or other container when loading and unloading. However, in the preferred embodiment herein, as shown, the support legs 304, 306 are each vertically retractable and are provided so that upon unloading, the cargo container can remain in a free standing and separate position (see FIGS. 50B, 51, and support legs 304 in FIGS. 55A, 57 and support legs 306 in FIGS. 52A, 54) and need not be separately removed by crane, and operators need not position additional free-standing support legs beneath the container. The present invention provides a single operable cargo container assembly that is free standing for use with a locking mechanism and lift frame, such as the locking mechanism and lift frame described herein, accommodates preferred vertically extendible and retractable storage legs 304, 306 and engages successfully with the preferred lift frame assembly 394 herein as well as other preferred lift frames such as that of applicant's co-pending application Ser. No. 16/045,697 as noted above. While four support legs 304, 306 total are shown, it will also be understood to one skilled in the art that further legs may be provided on the front, rear or middle portion of the frame 394 for additional support of the cargo container when is a free-standing position as in FIGS. 50B, 51.

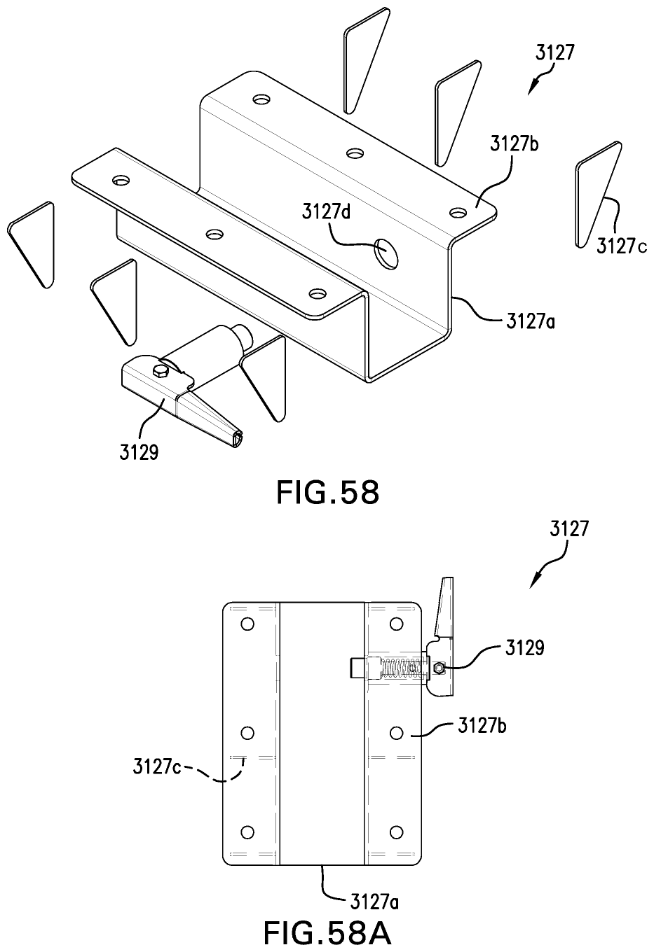

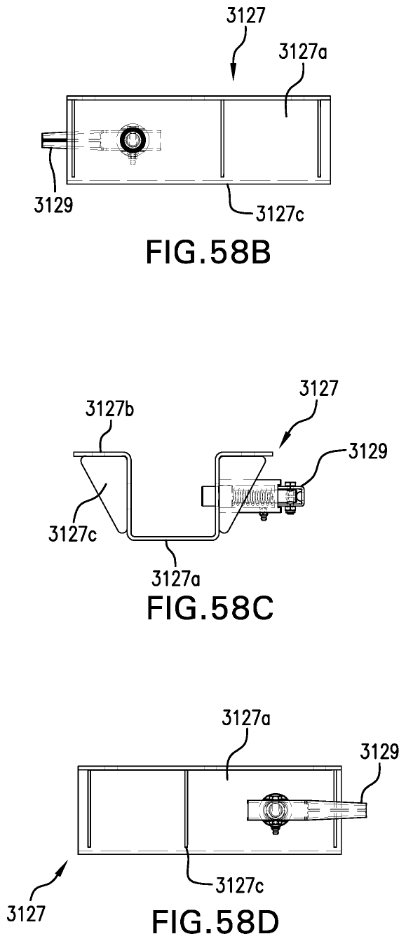

The support legs 304, 306 as shown in embodiment 3110 are each attached to a mounting plate 313 secured to and positioned on the container base frame 394 on a lower surface thereof. Such mounting plates 313 are shown in FIG. 50D installed and mounted to the base frame 395, and are similar to those shown in previous embodiments. The extending arms 3123 of support legs 304 are able to extend horizontally outwardly from within the modified support bearing 3127 and to retract horizontally inwardly similar to the manner of operation of previous embodiments. However, the extending arm need not be round or otherwise configured for rotational pivoting movement. As such it may be movable in and out of the support bearing 3127 and lockable in place when fixed in either position using a spring bolt 3129 as shown in FIG. 55, and FIGS. 58-58D.

The support bearing 3127 is configured to receive the extending arm 3123 of the support legs 304 and may be modified depending on the cross-sectional design of the extending arms 3123. As shown such arms have a square cross-section, but such arms may also be rectangular, circular, triangular, polygonal and the like. Extending flanges 3127b are shown for use in mounting the support bearing 3127 to the mounting plate 313. Fasteners, rivets, bolts or other suitable fasteners may be used for this purpose. The support bearing 3127 may also have support flanges or ribs 3127c to structurally support the side walls of the support bearing body 3127a. The spring bolt 3129 as shown in FIGS. 58-58D can be mounted in opening 3127d defined by the support bearing body 3127a. The spring bolt 3129 can thus pass into and out of mating holes 3162 defined by the extending arms 3123 which pass from the interior to the exterior of the extending arms allowing for adjustable locking in two positions when engaged within the support bearing body 3127a. Additional holes 3162 may be provided if further adjustment of the extension and retraction capability are required.

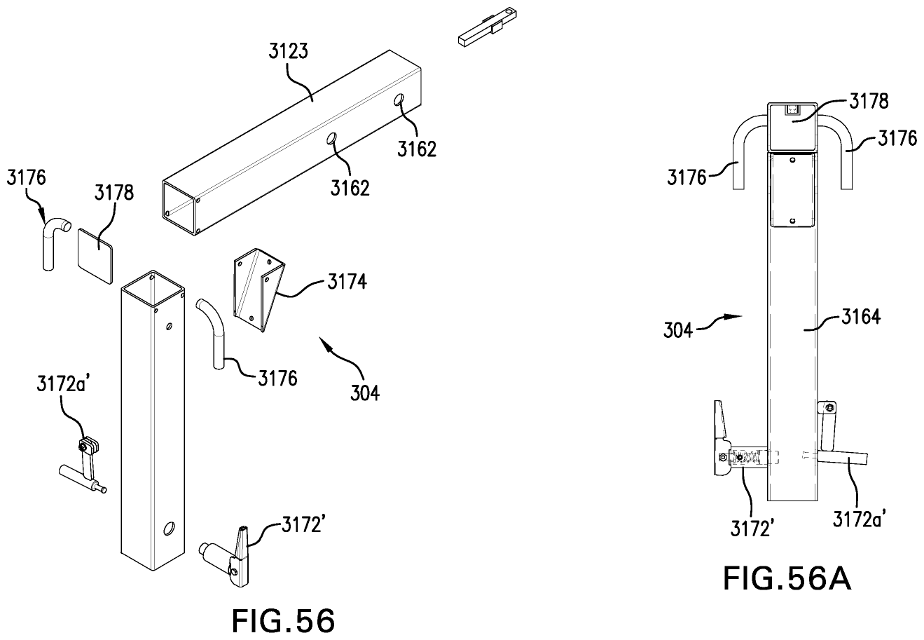

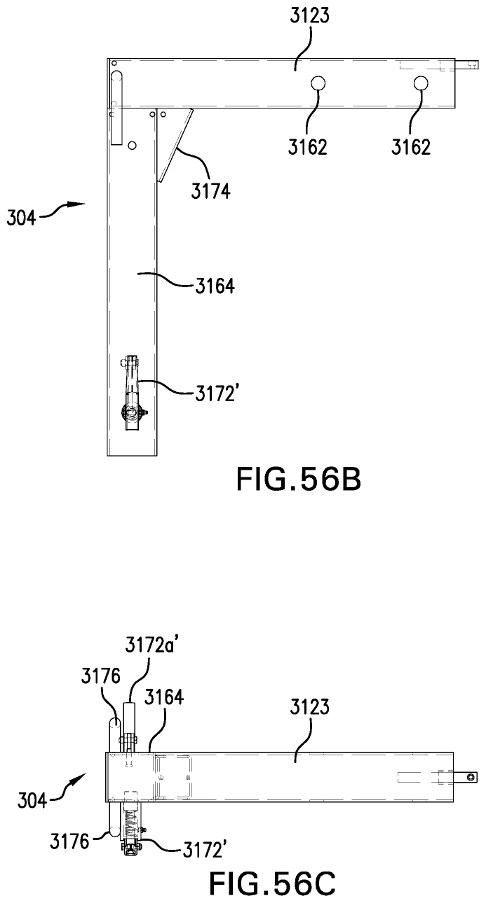

With respect to support legs 304, such legs are further vertically adjustable from a first free-standing position (see FIGS. 50B, 51, 51B, 55A and 57) in which each of the support legs 304 is extending outwardly horizontally as described above and extended downwardly vertically between the container base frame 394 to a support surface S such as the ground or other platform to a second position in which the support legs 304 are retracted horizontally tin the base frame 394 and vertically upwardly so as to be spaced from the surface S as shown in FIGS. 50C, 51A, 55B and 57A. The support legs 304 have an upper mounting portion 3164 which is preferably connected (either removably or permanently) to the extending arm 3123 on a mounting end 3125 of the support legs 304 and a lower base portion 3166 seated preferably on a support leg base 3118. The lower base portion 3166 is tensioned by a tension member such as an interior spring 3168 extending upwardly from a base end 3168a through the lower base portion 3166 by a spring mount 3170 received on the support leg base 3118. The opposite or mounting end 3168b of the interior spring 3168 may be locked in position by opposing and engageable spring bolt locks 3172, for example, as shown in FIGS. 57, 57a, or may be different as shown alternative with locking handle 3172′ and locking pin 3172a′ in FIGS. 56-56C. The spring bolts or other locking mechanisms may be the same or different and various locks are acceptable provided they can engage the interior spring and/or operate to lock the upper mounting portion 3164 to the lower base portion 3166 of the support leg 304 when extended to the first, free-standing position. Other methods of engaging the interior spring and/or of tension mounting the upper mounting portion 3164 to the lower base portion 3166 of support legs 304 may be used within the scope of the invention. The tension of the interior spring allows for upward, secure positioning of the support legs.

A further stabilizing angle support 3174 may be positioned and secured to the upper mounting portion 3164 and extending arm 3123 of the support legs 304 for stability. A closure plate 3178 may also be provided to the outwardly facing mounting end of the extending arm 3123. To assist users in extending and retracting vertically and horizontally, handles such as handles 3176 curved downwardly for gripping or other handles such as those handles noted above as demonstrated in embodiments 10′, 110′, and 210, may be incorporated in the design of embodiment 310 as well.

In the second, horizontally and vertically retracted position, each of the support legs 304 is moved from the free-standing position to a second traveling position in which the upper mounting portion 3164 of the support legs 304 is horizontally inwardly retracted and the lower base portion 3166 of the support legs 304 is upwardly vertically retracted for travel. In this position, once the user wishes to travel, the spring bolt 3172 or other locking mechanism on the support leg 304 is released and the lower support base portion 3166 of the support leg is pushed upwardly under tension to pass within the upper mounting portion 3164 of the support leg. Once done, the spring bolt 3172 or other locking mechanism, is once again engaged to lock the leg into the vertically retracted position. The spring bolt 3129 on the support bearing 3127 is also released, and the upper mounting portion 3164 of the support legs may then be pushed into the horizontally retracted position within the support bearing, and the support bearing spring bolt 3129 once again engaged, locking the support legs also in the retracted vertical position.

With respect to support legs 306, each also includes a support leg base 3118, locking mechanism such as spring bolts 3172 or alternatively a locking handle 3172′ and locking pin 3172a′ combination, an interior spring 3168, a spring mount 3170 analogous to those of the support legs 304. However, the upper mounting portion 3180 and lower base portion 3182 of the legs are not designed as shown to be horizontally retractable. Instead, the support legs 306 may remain in a fixed position and are horizontally mounted in that manner to the frame 394. The support legs 306 are vertically extendible in the free-standing position and vertically retractable in the traveling position in the same manner as the lower base portion 3166 of the support legs 304. The upper mounting portion 3180 of the support legs 306 include support arms 3158 and 3160 as described above for stabilizing the support legs 306 against the frame 394.

Each of support legs 304, 306 has an extending mounting support member 3158 that extends in a longitudinal manner along the sides 315 of the support frame 394 extending toward the respective end 3111a, 3111b nearest the mounting end 3125 of each of the upper mounting portions 3164, 3180 of the support legs 304, 306, respectively. The mounting support members 3158 enable secure fastening of the upper mounting portions 3164, 3180 to the cargo base frame 394 above the frame running on the exterior sides 315 of the frame 394.

In this embodiment, each of the support legs 304 is configured to be horizontally extendable and adjustable so as to be transversely extending and retracting from the cargo container base frame 394 when installed in the free-standing position and traveling positions, respectively. Each of the support legs 304, 306 is vertically extendable and retractable in the free-standing and traveling positions, respectively.

The cargo container and lift frame assembly 3110, and the lift frame assembly 310, are each preferably attachable and detachable from a vehicle. As described above a variety of vehicles may incorporate an assembly of a cargo container (as defined herein) and a lift frame assembly and cargo and lift frame assembly according to the invention. In FIGS. 50-50D, a truck 3112 is used as a vehicle having the lift frame assembly 310 attached thereto. Such a truck 3112 may incorporate standard electronic controls as are known or to be developed in the art for monitoring various functions of the truck and a semitrailer even if incorporating the lift frame assembly herein, such as for controlling warning and backup lights, tail lights, blinkers, a fifth wheel coupling, lubrication system or hydraulic lifts or air bags for interior tires/wheels, and the like. Such controls may be positioned on the truck, in or on the fifth wheel or on the lift frame as described above, including all of the various control mechanisms noted above.

The invention also includes a method of loading a cargo container such as cargo container on a lift frame of a vehicle, for example, loading the preferred cargo container assembly 358 on the preferred lift frame assembly 310 of the present embodiment (which is the same as lift frame 10), to create a vehicle cargo container and lift frame assembly, such an assembly 3110 herein attached to a vehicle such as vehicle 3112. The lift frame will be referred to hereinafter as lift frame assembly 310, with the understanding it is the same as lift frame assembly 10 as described above and has the same options and variations. The invention also includes a method for unloading a cargo container from such a lift frame and vehicle cargo container and lift frame assembly 3110 so as to detach the cargo container assembly 358 from the lift frame assembly 310. Each such method will be described below with reference to FIGS. 50-58D.

In a method of loading a cargo container on a lift frame to create an assembly, in a first step a lift frame such as in lift frame assembly 310 is attached to a vehicle such as vehicle 3112. This forms a structure similar to a tractor trailer, but having a lift frame assembly 310 as a trailer therein. In addition, the air suspension system described above is preferably provided that includes a height adjustment valve for raising and lowering the height of the frame which height adjustment valve is in fluid communication with a source of compressed air. The height adjustment valve and air suspension system are preferably as described above, including the height adjustment valve 99, HCV 97 and air springs 93 in communication through conduit 95.

The vehicle 3112 with the lift frame assembly 310 attached thereto is preferably backed under the cargo container of assembly 358 which is supported on a plurality of support legs, such as support legs 304, 306 herein, wherein front support legs 304 and rear support legs 306 are in a free-standing position as described above. The cargo container preferably has two ends, a rear end and a front or vehicle-facing end. When in the free-standing position on the support legs, the vehicle and attached lift frame assembly may be moved backwards or forwards as described previously. In this loading method, the vehicle 3112 and lift frame 310 are moved backwards under the supported cargo container from a vehicle side end 3116 of the cargo container, generally leaving cargo container access doors (not shown) for access on a rear end 3120 of the cargo container body 301. When the lift frame assembly 310 is fully positioned under the cargo container assembly 358 as shown in FIG. 50, the stop preferably abuts or engages the vehicle-side end 3116 of the cargo container assembly 358.

In the assembly embodiment shown, as with previous embodiments, there is one lift mechanism 46, on a vehicle front side 20 of the frame body 12. The air bag is in its deflated position and the locking lever 44 is positioned downward in the unlocked position. The air suspension is likewise in a normal drive position with the height adjustment valve in drive mode. Each support leg 304, 306 remains in place supporting the cargo container assembly 358. As with prior embodiments, the height adjustment valve in the air suspension system is moved to a stop position and the rear suspension adjusted to inflate and raise the air springs in the rear of the lift frame assembly near the rear end 28 of the frame 16 by inflating the air springs using the source of compressed air 36 thereby raising the rear facing portion of the cargo container assembly 358 and contacting the underside 356 of the cargo container assembly 358. Raising the frame height allows for retraction of the rear support legs 306 as shown in FIG. 50A.

At this point, the spring locks or other locking mechanism on the rear support legs is released so that a user may push upwardly (wherein optional handles may be provided to assist the user) to vertically retract the support legs to a traveling position with the lower base portion 3182 of the support legs 306 upwardly retracted into the upper mounting portion 3180 of the support legs 306. The locking mechanism, such as spring bolts 3172 or locking handle 3172′ and locking pin 3172a′ are re-engaged to lock the rear support legs 306 in the traveling position.

The vehicle frame height may now be again lowered or maintained at the raised height. Preferably the frame height is lowered using the height adjustment valve and then the height adjustment valve is moved to the drive position to re-engage the HCV of the air suspension system. The inflatable air bag 74 of the lift mechanism 46 is then inflated as previously described using the up/down control and the source of compressed air to lift the first or vehicle end 3116 of the cargo container assembly such that the underside 356 of the cargo container assembly 358 contacts the lifting surface. The support legs 304 under the front, vehicle side 32 of the frame 16 may now be horizontally and vertically retracted to the travel position. The lower base portion 3166 is retracted vertically upwardly as described above with respect to the support legs 306. The upper mounting section 3164 of the support legs 306 is then retracted by releasing the spring bolt 3129 in the support bearing 3127 and pushing the upper portion 3164 of the mounting legs 304 into the support bearing, optionally using handles 3176. The spring lock 3129 is then re-engaged to lock the extending arm 3123 of the upper mount portion 3164 in place. The lower locking mechanism 3172 should also be engaged. The front support legs 304 are thus in the traveling position. The inflation of the air bag allows for the adjustable support legs 304 located near the front end 3116 of the cargo container to be positioned in the traveling position.

While inflating of the air springs and air bag is described above sequentially to illustrate storage of the support legs in a manner preferred herein, it should be understood by one skilled in the art in view of this disclosure that the air suspension air springs 93 and the air bag 74 could have been both inflated simultaneously and then all legs retracted and locked in the traveling position when the cargo container is fully suspended and all legs retracted also sequentially or simultaneously depending on the number of operators available to carry out the method and the speed with which the operator(s) wish to carry out the method.

Further it should be understood to one skilled in the art, that the air bag could be inflated initially and the associated legs retracted, and then the air bag deflated and the air suspension engaged to raise the frame height in the rear of the lift frame without departing from the spirit or scope of the invention.

Once the air bag is deflated, the frame height is lowered, and the height adjustment valve is in the drive position, the cargo container assembly underside 356 is now supported by the lift frame and in contact with the lifting surfaces 54. The locking mechanism 24 can then be engaged in the locking position as demonstrated by the locking lever 44 in the upward position as described above and the vehicle ready to travel. The process may be reversed in the manner noted above with respect to previous embodiments, wherein the operation of the locking lever and lift system is the same, but instead of pivoting and storing support legs, the support legs 304, 306 are moved back from the traveling position to the free-standing position in the manner described above.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-93. (canceled)

94. A vehicle cargo container and lift frame assembly, comprising:
a lift frame assembly comprising a frame body on a top portion of a frame, the frame body extending from a first end to a second end;
a lift mechanism moveable with respect to the first end of the frame body, the lift mechanism comprising:
a lift body having a first end and a second end, a lifting surface on the first end of the lift body and the second end of the lift body being positioned so as to be movable with respect to the first end of the frame body, wherein the lifting surface is positioned to engage an underside of a base frame of a cargo container when placed on an upper side of the frame body;
an inflatable air bag having an upper side and a lower side and mounted on the lower side to a platform positioned on the frame beneath the lift body, wherein the inflatable air bag is connected on the upper side thereof to a mounting surface attached to the lift body;
a source of compressed air in fluid communication with the inflatable air bag; and
a cargo container assembly having a container body and a container base frame, wherein the container body is positioned on top of the container base frame and the container base frame is configured to be removably seated on the lift frame assembly, and the cargo container base frame comprises:
at least one longitudinally extending rail and a series of spaced-apart cross-members, wherein a portion of the cross-members are spaced apart in a manner capable of accommodating and being connected to a plurality of leg mounting plates, wherein a pair of the leg mounting plates are situated on opposite sides of the container base frame in a front portion of the container base frame and a second pair of leg mounting plates are situated on opposite sides of the container base frame in a rear portion of the container base frame; and
a plurality of support legs, each attached to one of the leg mounting plates on the container base frame, each of the support legs having an upper mounting portion and a lower base portion, wherein the base portion is releasably moveable within the upper mounting portion so that the support legs are vertically retractable from a first free-standing position, in which each of the plurality of support legs extends downwardly between the container base frame to a support surface, to a second travel position in which each of the lower base portions of the plurality of support legs is positioned within each of the upper mounting portions so that the support legs are elevated from the support surface.

95. The vehicle cargo container and lift frame assembly according to claim 94, wherein the lift body comprises at least two extending lift arms, each pivotably mounted on the second end of the lift body to the first end of the frame body.

96. The vehicle cargo container and lift frame assembly according to claim 95, wherein the lifting surface is attached to the first end of the lift body and is connected to at least two of the extending lift arms.

97. The vehicle cargo container and lift frame assembly according to claim 96, wherein the lifting surface is located on mounting flanges rotatably positioned on a bar extending between two of the at least two extending lift arms, which two extending lift arms are located on outermost sides of the lift body.

98. The vehicle cargo container and lift frame assembly according to claim 94, wherein the frame of the lift frame assembly comprises a longitudinally extending base frame positioned beneath and supporting a lower side of the frame body.

99. The vehicle cargo container and lift frame assembly according to claim 94, wherein the frame body includes a locking mechanism.

100. The vehicle cargo container and lift frame assembly according to claim 99, wherein the locking mechanism includes a plurality of locking hooks rotatably operable on at least one transversely extending beam interconnected by a longitudinally extending beam, wherein the hooks are actuated by a locking lever positioned on the frame body.

101. The vehicle cargo container and lift frame assembly according to claim 94, further comprising a second lift mechanism moveable on an end of the frame body opposite the first lift mechanism.

102. The vehicle cargo container and lift frame assembly according to claim 94, wherein the source of compressed air comprises a compressor, an electronic control panel for operating the compressor, a pressure gauge and conduit for allowing compressed air to be fed into the lower side of the inflatable air bag.

103. The vehicle cargo container and lift frame assembly according to claim 102, wherein the vehicle has an air suspension system comprising a height adjustment valve for raising and lowering a height of the longitudinally extending base frame, wherein the height adjustment valve is in communication with the source of compressed air and operates in communication with an air suspension height control valve, and wherein the height adjustment valve is operable to raise and lower the height of the longitudinally extending base frame by inflating or deflating at least a first pair of air springs, wherein each air spring in the first pair of air springs is spaced apart transversely and the first pair of air springs is positioned on a portion of the lift frame opposite the lift mechanism.

104. The vehicle cargo container and lift frame assembly according to claim 103, wherein the lift mechanism is on a front portion of the frame of the lift frame assembly and the at least one first pair of air springs is located so as to be operable for raising and lowering a height of the frame on a rear portion of the frame of the lift frame assembly.

105. The vehicle cargo container and lift frame assembly according to claim 102, wherein the source of compressed air further comprises at least one conduit for allowing compressed air to be fed into the lower side of the inflatable air bag, and at least one other conduit for allowing compressed air to be fed into the height adjustment valve for raising or lowering the first pair of air springs or into the height control valve for controlling the air suspension system when in a driving mode.

106. The vehicle cargo container and lift frame assembly according to claim 102, wherein there are at least two pair of air springs and the height adjustment valve is capable of adjusting the first pair of air springs independently of a second pair of air springs.

107. The vehicle cargo container and lift frame assembly according to claim 102, wherein the height adjustment valve has a stop position and a drive position, wherein in the stop position, the height control valve is isolated and the frame height may be adjusted upwardly or downwardly by manually turning a valve lever, and wherein in the drive position, a drive height is maintained by the height control valve.

108. The vehicle cargo container and lift frame assembly according to claim 102, wherein the lift mechanism is on the rear of the frame and the at least one first pair of air springs is located so as to be operable for raising and lowering a height of the frame on a front portion of the frame.

109. The vehicle cargo container and lift frame assembly according to claim 94, wherein in the travel and free-standing positions, the assembly further comprises at least one locking mechanism to releasably lock the upper mounting portion of the leg to the lower base portion of the leg.

110. The vehicle cargo container and lift frame assembly according to claim 94, wherein the support legs are fixed in position at an upper mounting end thereof, and the support legs further comprises at least one extending support arm for supporting the cargo container base frame.

111. The vehicle cargo container and lift frame assembly according to claim 94, wherein one or more of the plurality of support legs comprises at least one handle to assist in vertically moving the lower base portion of the support legs.

112. The vehicle cargo container and lift frame assembly according to claim 94, wherein the assembly further comprises a lock warning light for placement in a cab of a truck.

113. A vehicle cargo container assembly capable of demountable installation on a tractor trailer frame, comprising:
a cargo container having a container body and a container base frame, wherein the container body is positioned on top of the container base frame and the container base frame is configured to be removably seated on a frame of a tractor trailer, wherein the cargo container base frame comprises:
at least one longitudinally extending rail and a series of spaced-apart cross-members, wherein a portion of the cross-members are spaced apart in a manner capable of accommodating and being connected to a plurality of leg mounting plates, wherein a pair of the leg mounting plates are situated on opposite sides of the container base frame in a front portion of the container base frame and a second pair of leg mounting plates are situated on opposite sides of the container base frame in a rear portion of the container base frame; and
a plurality of support legs, each attached to one of the leg mounting plates on the container base frame, each of the support legs having an upper mounting portion and a lower base portion, wherein the base portion is releasably moveable within the upper mounting portion so that the support legs are vertically retractable from a first free-standing position, in which each of the plurality of support legs extends downwardly between the container base frame to a support surface, to a second travel position in which each of the lower base portions of the plurality of support legs is positioned within each of the upper mounting portions so that the support legs are elevated from the support surface.

114. The vehicle cargo container and lift frame assembly according to claim 113, wherein in the travel and free-standing positions, the assembly further comprises at least one locking mechanism to releasably lock the upper mounting portion of the leg to the lower base portion of the leg.

115. The vehicle cargo container and lift frame assembly according to claim 113, wherein the support legs are fixed in position at an upper mounting end thereof, and the support legs further comprises at least one extending support arm for supporting the cargo container base frame.

116. The vehicle cargo container and lift frame assembly according to claim 113, wherein one or more of the plurality of support legs comprises at least one handle to assist in vertically moving the lower base portion of the support legs.

117. A container base frame capable of supporting a container for demountable installation on a tractor trailer frame, comprising
at least one longitudinally extending rail and a series of spaced-apart cross-members, wherein a portion of the cross-members are spaced apart in a manner capable of accommodating and being connected to a plurality of leg mounting plates, wherein a pair of the leg mounting plates are situated on opposite sides of the container base frame in a front portion of the container base frame and a second pair of leg mounting plates are situated on opposite sides of the container base frame in a rear portion of the container base frame, wherein the container base frame is configured so that when situated under a container and the container is on a trailer frame; and
a plurality of support legs, each attached to one of the leg mounting plates on the container base frame, each of the support legs having an upper mounting portion and a lower base portion, wherein the base portion is releasably moveable within the upper mounting portion so that the support legs are vertically retractable from a first free-standing position, in which each of the plurality of support legs extends downwardly between the container base frame to a support surface, to a second travel position in which each of the lower base portions of the plurality of support legs is positioned within each of the upper mounting portions so that the support legs are elevated from the support surface.

118. A support leg for use with a cargo container frame capable of supporting a free-standing cargo container, comprising:
a longitudinally extending support leg having an upper mounting portion and a lower base portion, wherein the base portion is releasably movable within the upper mounting portion so that when the support legs are installed on a cargo container frame, they extend downwardly from a mounting end of the upper mounting portion to a support surface in a free-standing position, and are vertically retractable to a second travel position in which the lower base portion of the support leg is positioned within the upper mounting portion so that the support leg is elevated above the support surface.

119. The support leg for use with a cargo container according to claim 118, wherein in the travel and free-standing positions, the support leg further comprises at least one locking mechanism to releasably lock the upper mounting portion of the support leg to the lower base portion of the support leg.

120. The support leg for use with a cargo container according to claim 118, wherein at least one of the support legs comprises at least one handle to assist in vertically moving the lower base portion of the support leg.

121.-131. (canceled)
